(19) United States
(12) Patent Application Publication
(10) Pub. No.: US 2016/0191450 A1
(43) Pub. Date: Jun. 30, 2016

(54) Recommendations Engine in a Layered Social Media Webpage

(71) Applicants: Josh Lineberger, Denver, NC (US); Ward Thompson, Charlotte, NC (US); Jay Joyce, Charlotte, NC (US); Bill McCown, Charlotte, NC (US); Todd Morley, Leesberg, VA (US); Chris Provan, Leesburg, VA (US); Lewis Rudolph Gragnani, III, Waxhaw, NC (US)

(72) Inventors: Josh Lineberger, Denver, NC (US); Ward Thompson, Charlotte, NC (US); Jay Joyce, Charlotte, NC (US); Bill McCown, Charlotte, NC (US); Todd Morley, Leesberg, VA (US); Chris Provan, Leesburg, VA (US); Lewis Rudolph Gragnani, III, Waxhaw, NC (US)

(73) Assignee: Socialtopias, LLC, Charlotte, NC (US)

(21) Appl. No.: 14/986,566

(22) Filed: Dec. 31, 2015

Related U.S. Application Data
(60) Provisional application No. 62/099,127, filed on Dec. 31, 2014.

(51) Int. Cl. H04L 12/58; G06F 17/30

(52) U.S. Cl. CPC H04L 51/32; G06F 17/3097; G06F 17/30864

(57) ABSTRACT

A social media system directs content data to users according to content affinity data received from users. A server program assigns work queue pipelines on the server a processing priority in numeric order of (i) expressed affinity data, (ii) calculated affinity data, (iii) collaborative filtering affinity data, (iv) content-based affinity data, and (v) global user average affinity data. Collaborative filtering affinity data comprises item based collaborative filtering data and user based collaborative filtering data with item based data being granted a higher processing priority than user based data. The processing priority at the server determines how quickly content data at an end user device can be updated. The user devices, accessed by a user with an account on the social network described herein, displays content data received from the server in accordance with processed affinity data received by the server.

### CROSS REFERENCE TO RELATED APPLICATIONS

This application claims priority to and incorporates by reference U.S. Provisional Patent Application Ser. No. 62/099,127 filed on Dec. 31, 2014, and entitled Recommendation Engine in a Layered Social Media Webpage.

This application is related to and incorporates entirely by reference U.S. Non-Provisional patent application Ser. No. 13/836,727 as well as U.S. Non-Provisional patent application Ser. No. 14/272,798; U.S. Non-Provisional patent application Ser. No. 14/584,590; and U.S. Non-Provisional patent application Ser. No. 14/450,767.

### FIELD OF INVENTION

The present invention relates generally to software modules implemented in computerized social media systems with the purpose of recommending appropriate data content such as destinations, deals, date schedules, and advertisement content, for a social media user joining the system and displaying the appropriate data content on the user's computerized device.

### BACKGROUND OF THE INVENTION

Modern telecommunications systems have had to accommodate the abundance of social media networks that individual users and businesses join as authorized participants and communicate with each other therein. As used herein, social media includes any grouping of individuals and businesses via a common computerized platform to allow communications between and among the authorized users.

Numerous social media networks coordinate interactions between users of the social media network, whether businesses or individuals, and use modern data processing techniques to place advertisements, deals, messages, and a multitude of other data content in front of a user via a computerized device. The more sophisticated social media systems use various forms of artificial intelligence to ensure that the most useful data content possible reaches a user that will benefit the most from it. Businesses and commercial enterprises are particularly aware that it is important that commercial data, such as advertisements and other information about business entities, is available for viewing by recipients that would actually engage the commercial enterprise in a profitable way. One technique that social media networks use to determine proper recipients of online content via electronic data transmission is that of collaborative filtering. Collaborative filtering, often abbreviated “CF,” generally involves software, stored on computer readable medium and configured to impact computerized devices connected on a transmission network (e.g., a wireless or cellular telecommunications system), such that software is implemented via a host processor that collects and stores a vast collection of data points regarding a selection of users on the network. In the social media environment, these data points may include, but are not limited to, data input by the user of the social media network in the form of preferences, “likes,” search results, activity logs. “check-ins” for location services, and the like. The host processor stores all of this data regarding a community of users in databases and other storage mechanisms for intelligent processing. In this way, the host processor, typically implemented via a network entity such as a server, can process these data points, along with other known data about the user (e.g., demographic, geographic, and group identities) and predict that certain kinds of network users and social media users would have a common preference for certain kinds of data content directed to them. In this way, collaborative filtering allows for a network, such as a social media system of authorized users, and members, to gain intelligence about its users and offer ways to pair or group users having common interests, goals, and online personalities. This kind of information is incredibly valuable to not only socially active individuals, but also commercial enterprises that would like to make an impression on certain social network users and encourage profitable commercial interactions accordingly.

Other techniques are also available in the social networking platforms to gauge whether a member, or user of a social network, would be a good candidate to receive a particular kind of data content in the form of links to other users of the network, advertisements, deals, or destination recommendations. One concept used in the area of making recommendations to users of a social network, whether the recommendation is in the form of a suggested group or individual to connect, a business deal or offer, or some other form of advertisement, is that of determining whether a network user or group of users would have an “affinity” for a certain kind of data content or a certain originator of data content.

In particular, collaborative filtering can be used as one tool to test the aforementioned affinity between users of a network and respective data content. The host processor of a network can use gathered data points, stored and collected in various tables, databases, meta data, webpage content, and the like, to determine potential affinity among users of a network and data content. In this scenario, the best possible estimate of affinity occurs when an end user of a social networking system, expresses an affinity explicitly (for example by rating an item on a Liken scale presented by a web site's user interface). One may term such an affinity an expressed affinity.

Absent an expressed affinity, the best possible estimate of affinity (a computed affinity) is based on end-user (i.e., social media user) behaviors that imply interest in or preference for the item. Expressed and computed affinities together are empirical affinities. Absent an empirical affinity, a collaborative filtering algorithm may be used to compute an inferred affinity.

Collaborative filtering as discussed below includes item-based collaborative filtering in which certain tangible items have database entries on the host system related to how well that item is liked or possibly how many users of a certain quantifiable identity have been positive about that item (i.e., by rating the item or even purchasing the item). The item-based collaborative filtering extends the usual collaborative model by including domain-specific (content) variables describing an item, in the distance metric used to compute item similarity. Item based collaborative filtering should be used where sufficient empirical-affinity evidence exists to support it.

Otherwise, user-based collaborative filtering may be used. User based collaborative filtering makes recommendations based on the fact that similar traits of certain users may imply that those similar users would favorably receive certain data content.

A final kind of collaborative filtering is based on global averages (averages of all available empirical affinities, a degenerate case of user-based collaborative filtering).

Another kind of tool used to determine affinity between a user is that of basic similarity in web based content on the social media network. Content similarity may be compared by simple word searches in data that a network user (i.e., social media user) has input into certain areas of a social network or even other web content that a social media user has enacted to express preferences.

A need exists in the art of web based social media, transmitted across electronic networks to end user computerized telecommunications devices to make the best possible use of the enormous volumes of data stored, tracked, togged, and recorded in both real time and from a historical perspective. This data can be mined and computerized intelligence gained so that users receive the most relevant content on the end user devices, with the decisions of how to direct certain content being made in automatic and even real time fashion by a machine (i.e., a computer running programmed software instructions) instead of a human attendant.

### SUMMARY OF THE INVENTION

In one embodiment, the social media system disclosed herein processes user data in assigned pipelines of data processing work queues with the work queues having respective priorities.

In another embodiment, the social media system disclosed herein sets data processing pipeline priority on the basis of whether the data under consideration updates at least one user's empirical affinities for content data or inferred affinities for content data.

In another embodiment, data processing pipelines enabling a social media system include priorities for updating a user's content based on inferred affinities for certain content data identified for each user via collaborative filtering, including item-based inferred filtering, user-based inferred filtering, content based filtering, or a global average inferred filtering of content data.

In another embodiment, for data processing pipelines enabling a social media system, the system includes computer programs stored on a sever that prioritizes the processing of the pipelines based on whether the pipeline includes an expressed affinity for data content or a computed affinity for data content.

In another embodiment, the social media system of this disclosure utilizes a weighting system to determine whether (i) content based data searches and similarities or (ii) collaboratively filtered affinities should be used as the predominant data processing technique for making recommendations to a user or a group of users.

In yet another embodiment, the social media system of this disclosure uses artificial intelligence to set the weighting preferences for collaborative filtering or content based searching in a social media system utilizing a data content recommendations engine via software.

In another embodiment, the social media system of this disclosure allows a system attendant, or manager of a host procession network, to set the weighting preferences for collaborative filtering or content based searching in a social media system utilizing a data content recommendations engine via software.

In yet another embodiment, the social, media system of this disclosure allows an end user of a social networking or social media network to set the weighting preferences for collaborative filtering or content based searching in a social media system by entering a weighting preference via a data entry device connected to the end user computer.

In another embodiment, the system described herein provides a way for an end user to express a preference regarding the relative importance of each kind of search of social network data records.

In another embodiment, the system described herein provides users with recommendations in the form of advertisement, or deals, based on their teal time, current social state of mind and interests.

### BRIEF DESCRIPTION OF THE FIGURE

FIG. 1A is an overview network diagram of a social media system disclosed herein.

FIG. 1B is a block diagram of the social media system of FIG. 1A indicating the layered software protocol providing social media system participants various levels of data content.

FIG. 2 is a flow chart of a user experience when the social media system user interacts via a computerized device with the layered data content of FIG. 1B.

FIG. 3A is a schematic diagram of a main layer of web page image and data content by which a social media user accesses the social media network.

FIG. 3B is a schematic diagram of FIG. 3A and illustrates that the layered software protocol may be activated to provide overlays of image and data content in the social media network.

FIG. 4 is a flowchart indicating a software function implemented in the social network of this disclosure and providing options for social media user communications.

FIG. 5 is a flowchart indicating a software function implemented in the social network of this disclosure and providing options for a user to edit image and data content displayed to the user.

FIG. 6 is a flowchart indicating a software function implemented in the social network of this disclosure and providing options for the system to receive user status updates for data processing and user connection purposes.

FIG. 7 is a flowchart indicating a software function implemented in the social network of this disclosure and providing options for a user to invite groups of users to a location or event.

FIG. 8 is a flowchart indicating a software function implemented in the social network of this disclosure and providing options for users and business entities to engage in commercial transactions.

FIG. 9 is a flowchart indicating a software function implemented in the social network of this disclosure and providing options for users and business entities to engage in commercial transactions directed to user interests.

FIG. 10 is a flowchart indicating a software function implemented in the social network of this disclosure and providing software mechanisms for tracking user participation and activity on a social network and scoring that user as a valid social media participant.

FIG. 11 is a flowchart indicating a software function implemented in the social network of this disclosure and providing a mechanism for the user to be scored based on options for users and business entities to engage in commercial transactions.

FIG. 12 is a flowchart indicating a software function implemented in the social network of this disclosure and providing options for users and business entities to engage in calendar features of the social media network.

FIG. 13 is a flowchart indicating a software function implemented in the social network of this disclosure and providing options for users and business entities to engage in commercial transactions and to communicate with other users with similar schedules.

### DETAILED DESCRIPTION

In an overall embodiment, the social media system 108 disclosed and claimed herein utilizes both empirical affinities and inferred affinities to direct appropriate image and data content to a social media network user. The empirical affinities include expressed affinities, such as a direct entry of a “social state of mind” data point, and computed affinities, such as actually counting how many times a user views or likes certain content on the system. The inferred affinities, on the other band, include using global averaging kinds of selections, applying content-based search tools (i.e., keyword searches) to collected data, and employing collaborative filtering-based data processing techniques via the system architecture. These empirical and inferred affinity techniques allow the social media system 108 to make intelligent automatic selections in regard to the most efficient transmission of relevant data content across the network to appropriate users. In other words, the social networking system 108 of this disclosure (also described in the above nosed documents incorporated by reference herein) uses expressed affinities, computed affinities, and inferred affinities to decide which users would be most receptive to certain online content data, such as content recommendations that can be automatically implemented via the social network.

The terms used for this disclosure are selected for ease of understanding and incorporate their broadest plain language meanings unless otherwise noted. For example, the social media system 108 could be referred to as a social network or a social networking system with the same meaning attributed to the terms. Individuals and businesses utilizing the social media system 108 are often referred to as users, but could equally be called members or participants with the same idea conveyed.

The hardware used to implement the social media system 108 may typically include individuals and business users of the system accessing the social media system on computerized devices that may generally be referred to as a computer. A computer that provides access to the social media system typically, and without limitation, connects to a network infrastructure to transmit and receive content data that includes image data and other kinds of transmitted data enabling the social network described herein. Often the data transmission occurs via gateways and other standard network components allowing a user to access a content server (or groups of servers) that enables the social media system functionality. Of course all of the user computers, network hardware, and social media system servers incorporate sufficient memory and processors to actively engage input and output data.

In one aspect the social media system 108 described herein directs data to and from system data processing resources (e.g., computational servers) via numerous input and output devices. The server system implementing the social media system 108, therefore, must employ computerized instructions for prioritizing server processing resources and allocating the server processors in a way that best attends the needs of the social media system users. In one embodiment, the social media system described herein is configured to divide data processing work queues into pipelines of work for the system resources. In this way, the system allows an administrator running the overall social network to ensure that updata content data reaches the users in the most efficient manner. Prioritizing the pipelines of work queues on the basis of the effect a certain pipeline of data may have on a user's data content is a significant advancement described herein.

This disclosure also explains how weighting data processing techniques, including but not limited to, empirical affinity data processing, inferred affinity data processing, use of global averaging, content based data searching and collaborative filtering affinity approaches allow a social media system to make efficient use of content recommendations for members of the social networking. Different kinds of affinity prediction techniques such as expressed affinities, computed affinities, collaborative filtering and content searching are more or less appropriate to different kinds of users at different times for different purposes. The embodiments of the system disclosed herein allow for weighting the data processing and statistical manipulation algorithms at use in a social media system for optimal performance. A recommendations software module, connected to a host processing system running a social media networking system via a network, is most effective when the kinds of data processing techniques are allowed to vary according to pre-programmed conditions or according to user preferences input into the system via an ad hoc basis.

In brief, this disclosure describes and illustrates that a social media networking system may incorporate software modules, or engines, that allow the system to intelligently recommend certain data content to users. The recommendations engine (“RE”) may be based in part on numerous data processing and statistical analysis techniques, including but not limited to text based content searches or affinity based collaborative filtering of user data collected via the transmission network. In one general sense, the recommendations engines described herein take advantage of combining the techniques of expressed affinities, content searches and collaborative filtering in a hybrid system that uses both for content recommendations. One feature of this specification, however, is that the weighting of the search factors, whether expressed affinities, calculated affinities, global averages, content text based searching or collaborative filtering, can be varied to fit the task at hand. The varying Weighting factor, denoted as the variable “w” below may be changed by a data entry device in which a user, and administrator, or the system's own artificial intelligence enters the preferred Weight of each kind of data manipulation (e.g., the Weighting of the expressed affinities, calculated affinities, content searches, global averages, and the Weighting of the collaborative filtering results). In other embodiments, the variable “w” used below may be automatically varied by the software making the recommendations so that the kind of processing with the best data available is Weighted heavier in providing recommendation results to a user. In this scenario, when a user of the social network has a sufficient level or threshold quantity of historical data tracked in the system, the Weight given to collaborative filtering increases in a controlled fashion over the Weight of the content searching. Other embodiments may have pre-programmed levels for the Weights that are iteratively changed upon selected variables. In the context of the system described below, the Weighting factor “w” can be varied in the computerized methods and system so that the recommendation results are more appropriate.

The configuration changes the model's output without requiring different primary inputs—in other words, it's how the system can reduce the error rate without requiring more observed primary inputs.

At any given time, there is presumably a sweet-spot of optimal configuration values (a Pareto set in configuration space which minimizes the error across all users.) These configuration values control the performance (worth) of the algorithm, so having a way to find/set appropriate values is as important as being able to run the algorithm itself. Ideally, but not exclusively, the values should be set centrally by administrators. End-users might not be expected to properly set these values, since they do not have the necessary data or resources for running experimental tests.

There are several means possible for changing the model configuration:

Values may be set at compile-time (“hard-coding”)

Values may be set after compilation:

Locally, using a plain-text file (configuration file.)

Remotely, using web service calls or remote procedure calls.

Each option has certain trade-offs.

Simplest Option

Hard-coding is the simplest option, but it's also the worst for solving the ultimate goal (reducing error by changing configuration values.) The problem is that code would have to be recompiled when changing a configuration value, making it difficult to find better configuration settings by statistical experimentation.

Most Complicated Option

With sufficient data, the Pareto set of optimal configuration parameters can be estimated which minimizes the error (simulated by cross-validation, or reported by user feedback, etc.) The trade-off here is that each additional parameter requires more data and time when considered mathematically.

Suggested Option

Hard-code default configuration values, which are optionally overridden.

The overrides can be done through a plain-text file (which might be read prior to each calculation, or when the engine starts, etc.) The overrides may additionally be set using secure, remote administrative endpoints.

This remote endpoint may be a dashboard/console, which may summarize statistical information about model performance (as a way to suggest which values should be adjusted.)

High-Level

The item-based module

The item-based is the least expensive to run, so it is attempted first.

This module performs well above a certain number of user-item records (meaning any information which indicates preference towards some items but not others.)

If the systems know a user's history of affinities, the item-based module can give them recommendations—even if the user has no known user-user interactions or content-based profile information.

The exact threshold depends on how many records are needed before the accuracy of the item-based module is expected to overtake the accuracy of the general average module. This must can/should be determined experimentally.

The User-Based Module

The user-based module is more expensive to compute than the item-based module, so it is attempted for a user when the user does not meet the thresholds of the item-based module.

The user-based module should be run if for users having a certain amount of user-user records (meaning any information which lets us compare content-based user similarity.)

The exact threshold depends on how many records are needed before the expected accuracy of the user-based module overtakes the expected accuracy of the general average module. This can/should be determined experimentally.

The General Average Module

This module is the fallback when there is absolutely no information known about a user. No thresholds are required to use this module, and the results only need to be run once (they do not vary between users.)

### Examples

Suppose Oliver, Nathan, Nancy, and Mindy all join today. They are all new users—but once they log in, they each endeavor towards a different use case.

Oliver

Oliver focuses on searching and viewing destination profiles. He does not fill out his user profile, or interact with other users. This is fine—the item-based module does not care about how Oliver relates to other users, so Oliver will eventually provide enough records to make the module worthwhile.

The exact value for this configuration is the # user-item interactions required before the item-based module's accuracy is expected to overtake the general average module's accuracy.

If Oliver doesn't meet this threshold, next we check if he meets either of the following two (user-based module) thresholds.

Nathan

The first thing Nathan does is make a profile.

With this, we determine Nathan's profile is similar to (active user) Amy's profile. This similarity lets the user-based module suggest to Nathan recommendations based on Amy's known affinities. These recommendations are theoretically knowable the instant Nathan completes his profile.

This is a case where the cold-start problem does not matter—Nathan only needs to be similar to users to get recommendations, he does not actually need a history of items. Amy gets nothing from Nathan in this situation, but she also does not need anything from him—Amy is an established user already.

The threshold involved is the % of profile completion for Nathan. The exact value must be determined experimentally, by comparing the accuracy of the user-based module vs. the general average model.

If Nathan does not meet this threshold, we check the threshold described for Nancy.

Nancy

Nancy skips filling out a detailed profile—she is more interested in the social features of the application, and spends her time interacting with other users. She contacts her friends, meets new people, and so on.

This user-user activity can be used to provide a user similarity for the user-based module (even without Nancy having a profile.)

The exact value for this configuration is a threshold # user-user interactions where the user-based module's accuracy overtakes the accuracy of the general average module.

If Nancy does not meet the threshold, she defaults to whatever is recommended by the general average module.

Mindy

Mindy downloads the app, but does not ever do anything else.

We have no option but using the general average module, which effectively suggests the most-recommended recommendations shared between users. There is no threshold to be met—this is the default case for any user.

The present invention will be described more fully hereinafter with more particular details set forth. The invention may be embodied in other forms and should not be construed as limited to the embodiments herein. Like numbers refer to like elements throughout. Example embodiments will now be described more fully hereinafter with reference to the accompanying drawings, in which some, but not all, embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention. Reference numbers used herein may refer to drawings incorporated by reference from earlier filed applications listed above.

According to some example embodiments, a social media system 108, or social networking platform, includes a method, apparatus and computer program product, as described herein, configured to receive content data regarding various kinds of interests from a user and, as a result, place similarly interested users and corresponding entities (e.g., without limitation, sports bars in the area) on notice of that interest. Users may select a current state (e.g., an online status referred to as a “social state of mind”) that provides an indication of the current status of the social media user. These states, or social states of mind, include, but are not limited to “Looking To,” “Going,” “On the Way,” and “I'm Here.” These states are updated as a user makes a particular status post with their current “social state of mind.” The states and an accompanying user credibility score, (described in detail in companion U.S. patent application Ser. No. 14/584,590, incorporated by reference herein) are configured to funnel users into selecting a location in the physical world, and to interact with other people based on a shared social state of mind and interest and then to encourage the user to actually arrive or otherwise activate at a location in the physical world

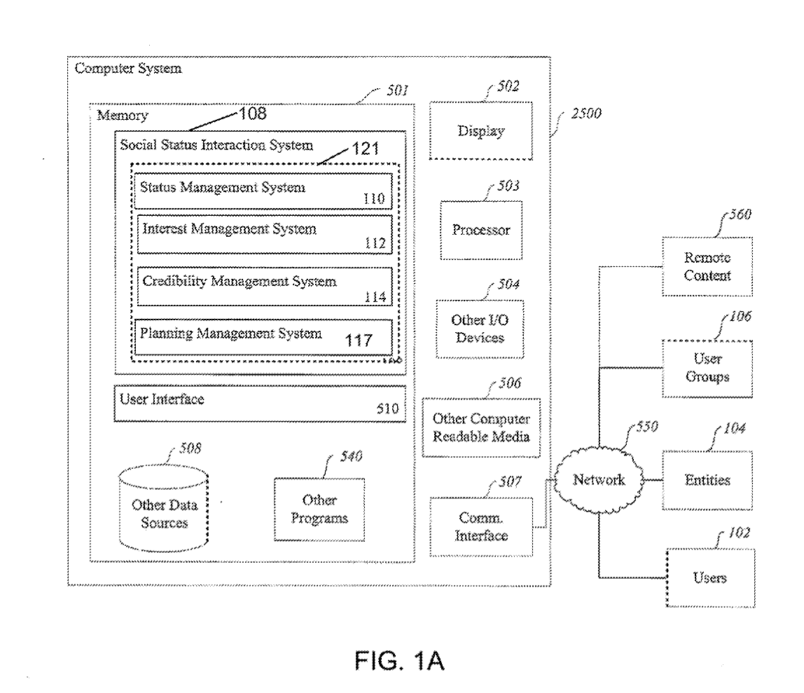

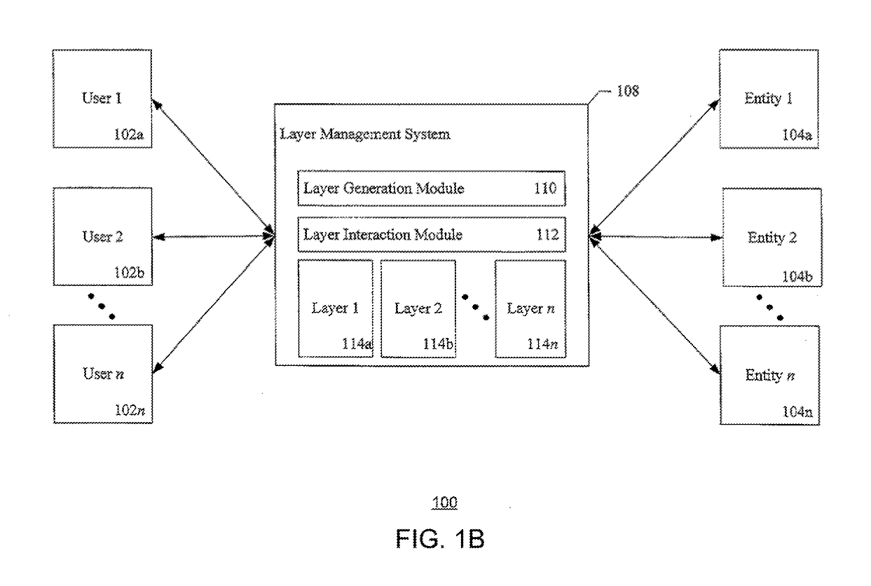

FIG. 1 of this disclosure illustrates an overall computer system that implements a social media network 108. FIG. 1 is an example block diagram of example components of an example social media environment 100 that includes the social media system 108 and its connected users (102, 104). In some example embodiments, the social media environment 100 comprises one or more users 102a-102n, one or more entities (e.g., establishments, businesses, destinations, entertainers, promoters, etc.) 104a-104n, one or more user groups (e.g., event entourages) 106a-106n, and/or a social media system 108. The social media system 108 may take the form of, for example, a code module, a component, circuitry and/or the like. The components of the example social media environment 100 are configured to provide various logic (e.g., code, instructions, functions, routines and/or the like) and/or services related to the social media system 108 and its components.

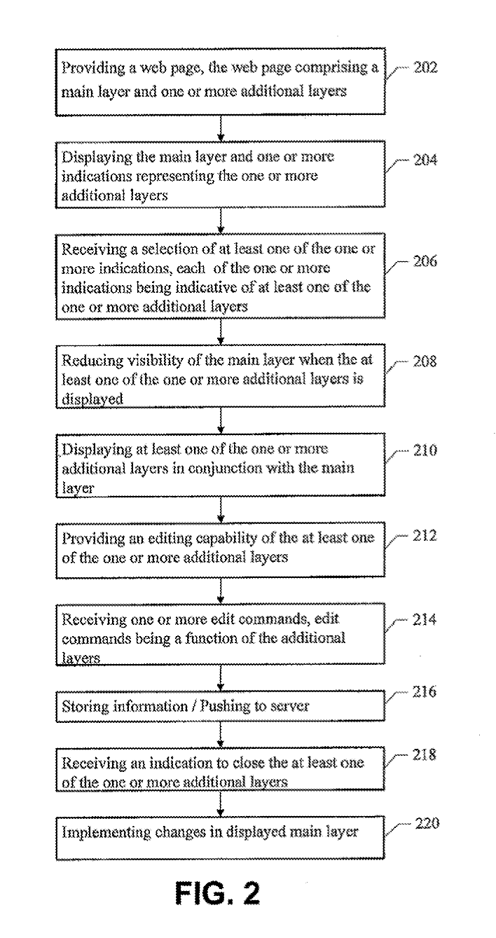

The social media system 108 may further comprise a status management system 110, an interest management system 112 and/or a credibility management system 114. The status management system 110 is configured to receive and/or otherwise determine a current state of one or more users 102a-102n and one or more user groups 106a-106n. Additionally or alternatively, the status management system 110 may be configured to receive and/or otherwise determine a future state of one or more users 102a-102n and one or more user groups 106a-106n using, for example, a calendar functionality or any functionality for displaying and/or managing at least one future time. In some examples, the status management system 110 may be further configured to share status information between the one or more users 102a-102n, one or more entities 104a-104n and/or one or more user groups 106a-106n. For example, the status management system 110 may share the current and/or future state of user 1 102a with user 2 102b and/or with entity 1 104a. Sharing of states is further described with reference to FIG. 2.

FIGS. 1A and 1B may also be described as an example block diagram of an example computing device for practicing embodiments of a social media system. In particular, FIG. 1A shows a computing system that may be utilized to implement a social media environment 100 having a social media system 108 including, in some examples, a status management system 110, an interest management system 112, a credibility management system 114, planning management system 117, and/or a user interface 510. One or more computing systems/devices may be used to implement the social media system 108 and/or the user interface 510. In addition, the computing system 117 may comprise one or more distinct computing systems/devices and may span distributed locations. In some example embodiments, the social media system 108 may be configured to operate remotely via the network 550, such that one or more client devices may access the social media system 108 via an application, Webpage or the like. In other example embodiments, a pre-processing module or other module that requires heavy computational load may be configured to perform that computational load and thus may be on a remote device or server. For example, the status management system 110, the interest management system 112, the credibility management system 114, and/or planning management system 117 may be accessed remotely. In other example embodiments, a user device may be configured to operate or otherwise access the social media system 108. Furthermore, each block shown may represent one or more such blocks as appropriate to a specific example embodiment. In some cases one or more of the blocks may be combined with other blocks. Also, the social media system 108 may be implemented in software, hardware, firmware, or in some combination to achieve the capabilities described herein. With regard to FIGS. 1A and 1B, and throughout the attached drawings, similar or same reference numerals show similar, equivalent or same components, and the description is not repeated.

The social media system 108 may further comprise a planning manage rent system 117. The planning management system 117 is configured to provide functionality enabling one or more users 102a-102n and one or more user groups 106a-106n to convey their intent to attend a destination or event. Additionally or alternatively, the planning management system 117 may be configured to receive and/or otherwise determine the intent of one or more users 102a-102n and one or more user groups 106a-106n to attend a destination or event. In some examples, the planning management system 117 may be further configured to provide one or more users 102a-102n and one or more user groups 106a-106a functionality to make a plan and prepopulate plan making functionality based on a social networking service feature utilized in enabling the plan making functionality.

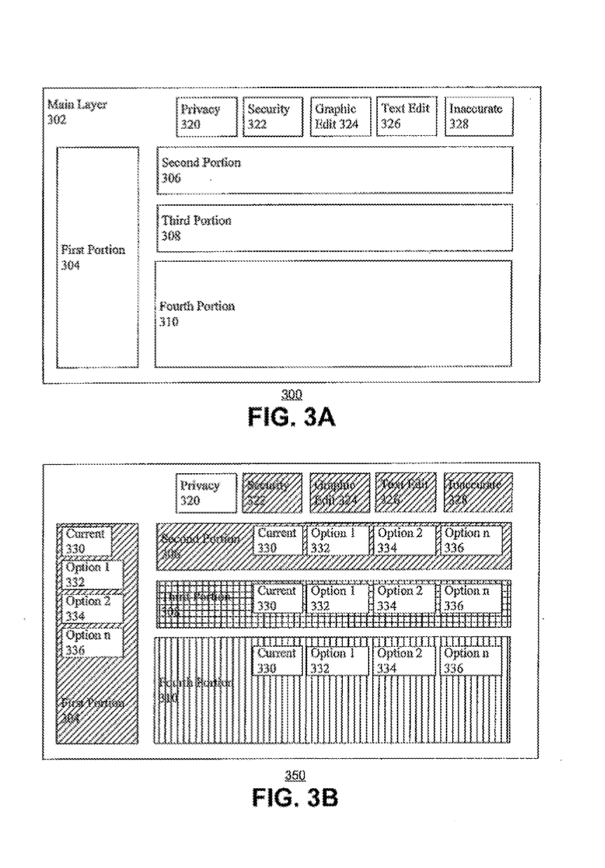

FIG. 2 illustrates an example flowchart that may be performed by, for example, the social media system 108 or more generally, by any computing apparatus or system, in accordance with some example embodiments of the present invention. Generally, a web page may be provided, wherein additional functionality is accessible through the use of layers of displayed image data. A layer of displayed image data may alter a current interface of a Webpage or computerized display to a different interface of the page or display, which may not be accessible without the use of the initial layer. Any layer of image data content may be configured to allow the user to alter, edit, add, view information, or the like on the current Webpage without having to navigate away from the current Webpage. In other examples, a layer may be presented in the foreground while demoting other image data content to the background. A number of exemplary additional layers will discussed below with regard to FIGS. 3A-3B.

Additional layers may include, but are not limited to, for example, privacy or security functionality may be accessed or edited in one or more additional layers, a pinning or text functionality allowing the reporting or messaging of information may be provided in another one or more additional layers. A user content modification functionality may be provided in another one or more additional layers, and layer providing additional information may be provided. Indeed, in some examples, additional content may be provided in an additional layer:

FIG. 3A will be described with reference to example displays 300 and 350 shown in FIGS. 3A and 3B, respectively. FIGS. 3A and 3B show example displays 300 and 350 that may be presented by one or more display screens of one or more devices, such as those used by a first user, second user, an entity or the like (i.e., any social media user). Again, while the example displays 300 and 350 are configured to be shown on a computer display, mobile device, wearable device, “tablet computer” or other device having similar dimensions, similar interfaces may be utilized with other types of devices discussed herein and modified accordingly (e.g., for screen size, input device compatibly, ease of use, etc.). And again, in some embodiments, any physical device may be configured to perform the functionalities described herein.

Turning back to FIG. 2, as shown in block 202 of FIG. 2, an apparatus, such as layer management system 108, may be configured for providing a web page. For example, a consumer may open a web browser software application running on their home computer, tablet, wearable, or mobile phone (e.g., client device) and direct the browser to a Webpage associated with a social networking site or the like. In other embodiments, a consumer may execute a mobile device application associated with the social networking system on their tablet computer or mobile phone (e.g., client device). Other mobile device applications or apps may also benefit from the methods, apparatus and computer program product disclosed herein.

As shown in block 204 of FIG. 2, an apparatus, such as layer management system 108, may be configured for displaying the main layer and one or more indications representing the one or more additional layers. For example, display 300 of FIG. 3A shows a display screen that may be displayed by a device. Display 300 may be configured to display at least a main layer, and in some embodiments, one or more indications or icons 320-328 representing one or more additional layers. For example, as shown in display 300, a privacy 320 indication, a security 322 indication, a graphic edit 324 indication, a text edit 326 indication, and an inaccurate information 328 indication are shown. In other embodiments, one or more of the indications shown may not be shown and one or more additional indications not shown here may be shown. For example, indications related to pin placement, text box placement, additional information, bug reporting, status point allocation, data point allocation, user tutorials, etc. may be shown, each indicative of an additional layer.

The main layer may be a default layer. For example, when a page is loaded, the initial view is of the main layer. In some example embodiments, the main layer is the layer currently being viewed or displayed, such as a currently active Webpage. In other words, in some embodiments, a main layer may be displayed. With the main layer, one or more indications representing one or more additional layers may be displayed. Once at least one of the one or more indications is selected and an additional layer is being displayed, for the purposes of the discussion herewith, that layer may be considered the main layer relative to one or more additional layers that may be accessible from the main layer.

In some embodiments, indications representing the one or more additional layer may be displayed at the top, along the side, in a pull down menu in the main layer. As shown in block 206 of FIG. 2, an apparatus, such as layer management system 108, may be configured for receiving a selection of at least one of the one or more indications. For example, a user may click on (e.g., when using a mouse), tap (e.g., when using a touchscreen), or the like.

As shown in block 208 of FIG. 2, an apparatus, such as layer management system 108, may be configured for reducing visibility of the main layer when the at least one of the one or more additional layers is displayed. For example, the main layer may be modified such that one or more portions are displayed in a different color (e.g., faded, grey, or the color may be indicative of some information), overlapped (non-visible), moved, sized up or down, added to, subtracted from, or the like. Additionally or alternatively, in some embodiments, additional buttons, additional information or the like may be displayed with all or some portion of the information present on the main layer. For example, in a privacy embodiment, which is described in more detail below, each of or some portion of a plurality of portions of the main layer may continue to be displayed and may include one or more additional buttons related to a privacy setting. Additionally or alternatively, in some embodiments, each of or some portion of a plurality of portions of the main layer may continue to be displayed in a color associated with a current privacy setting.

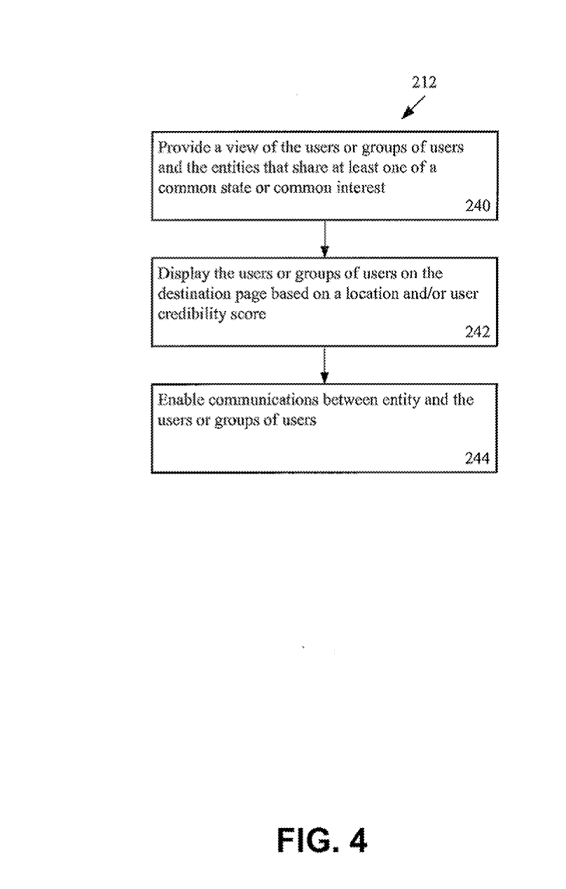

As shown in block 210 of FIG. 2, an apparatus, such as layer management system 108, may be configured for displaying at least one of the one or more additional layers, the at least one of the one or more indications being indicative of the at least one of the one or more additional layers. And as shown in block 212 of FIG. 2, an apparatus, such as layer management system 108, may be configured for providing an editing interface of the at least one of the one or more additional layers. Block 212 is further described with reference to FIG. 4-7. For example, when an additional layer is selected, an interface may be displayed. The specifics of the interface are dependent on which layer was selected. Accordingly. FIGS. 4-7 detail four example functionalities provided in the editing interface of a selected additional layer.

For example, display 350 of FIG. 3A shows a display screen that may be displayed by a device. Display 350 may be configured to display one or more additional layers. Here, for example, a user may have selected a privacy layer. Display 350 may now be configured to display the privacy layer. Additionally or alternatively, display 350 may be configured to provide an editing interface for the privacy layer. Display 350 may be configured to show, in some exemplary embodiments, an indication of a current privacy setting. Here, a current setting 320 may be displayed as well as shading indicative of the current setting 320. Although both an editing interface and an indication of a current privacy setting are shown in display 350, both need not be shown. Other example embodiments may provide for one or more different indications of a current setting, such as a different color or the like.

As shown in block 214 of FIG. 2, an apparatus, such as layer management system 108, may be configured for receiving edit commands. Here, the edit commands are again dependent on the selected additional layer and are further described below. For example, selection of a privacy layer may provide the user with an interface comprising one or more privacy related choices as described in relation to block 212 and, as such, one or more received edit commands will be dependent on the provided interface. For example, continuing the privacy layer discussion related to FIGS. 3A and 3B, an edit command may be configured to change to the accessibility of one or more portions of a profile page from being able to be viewed by everyone to being able to be viewed by “friends”, family, or the like. In an exemplary embodiment, display 350 of FIG. 3B shows a display screen that may be displayed by a first device. Display 350 may be configured to display “option 1”, “option 2” and “option n” (e.g., indicating that any number of options may be provided). Option 1 in a privacy layer may be, as discussed above related to “friends”, option 2 to “family” and so on, in other embodiments, one or more different additional layers may be provided, and as such, the edit commands may be different, displayed differently, or the like.

As shown in block 216 of FIG. 2, an apparatus, such as layer management system 108, may be configured for storing information and/or pushing the information to a server that, for example, stores the editing information. In a social media context, a server may be utilized to store information that may be used to construct a users profile page, as well as privacy information indicative of what information particular users may view. For example, in display 350, the second portion 306, the third portion 308, and the fourth portion 310 each provide for different accessibility, and as such, in the social media context, a server may store the content of each portion and the privacy information such that each portion is only provided to the particular users indicated by that privacy information.

As shown in block 218 of FIG. 2, an apparatus, such as layer management system 108, may be configured for receiving an indication to close the at least one of the one or more additional layers and as shown in block 220 of FIG. 2, an apparatus, such as layer management system 108, may be configured for implementing changes in displayed main layer. For example, in some embodiments, the main layer may be re-displayed if, for example, content was deleted, added, or modified. In some embodiments, implementation may be invisible to the user, where for example, privacy or security settings were changed, but implementation may result in one or more other user's views of the page to be changed (e.g., where access is changed from, for example, all to “friends” or where access is removed for one or more specific persons). Again, using display 350, in an exemplary embodiment, where a user may change accessibility of one or more portions, the implementation may be invisible to the user, but particular users whose accessibility is changed, the implementation may result in them no longer seeing some content and/or now being able to view some content.

In some example embodiments, the social media environment 100 comprises one or more users 102a-102a, one or more entities (e.g., establishments, businesses, destinations, entertainers, promoters, etc.) 104a-104n, one or more user groups (e.g., event entourages) 106a-106n, and/or a social media system 108. The social media system 108 may take the form of, for example, a code module, a component, circuitry and/or the like. The components of the example social media environment 100 are configured to provide various logic (e.g., code, instructions, functions, routines and/or the like) and/or services related to the social media system 108 and its components. The social media environment might take advantage of electronics utilizing transmission and storage of non-transitory computer readable media to implement the method, products, and systems disclosed herein.

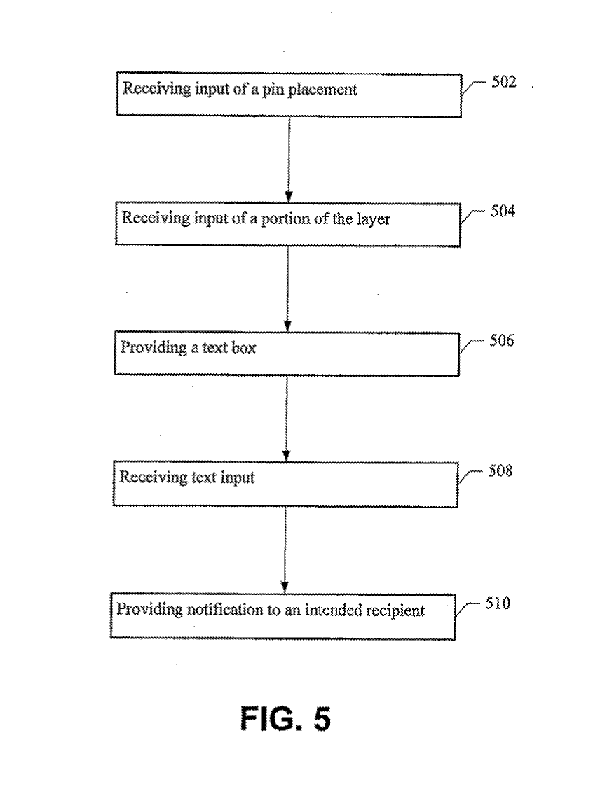

In some example embodiments, the credibility management system 114 is configured to assign a user credibility score, credits or other social capital based on the behavior of the one or more users 102a-102n, one or more entities 104a-104n and/or one or more user groups 106a-106n. For example, the more a user participates with the social media environment 100, the more points or credits will be awarded. Importantly and in some examples, the greatest number of points will be awarded when a user activates in a physical location and/or otherwise verifies an interaction in the physical world. Points may be subtracted in instances in which a user does not participate or does not follow through after being “committed”, to a particular location. As will be Anther described herein, the user credibility score may also be used to provide offers, rank users or entities, provide social capital among friends and/or the like. The credibility management system 114 is further described with reference to FIGS. 4 and 5.

The status management system 110, the interest management system 112 or the like may display the users or groups of users and/or the entities via the user interface based on a user credibility score. For example, users with a high user credibility score may be ranked at the top of a list and, as such, may be more aggressively targeted (e.g., may receive better offers) by entities. Similarly, users or groups of users may target those entities with higher user credibility scores. In some embodiments, the status management system 110, the interest management system 112 or the like may display the users or groups of users and/or the entities via the user interface, the user interface displaying, for example, an information feed display, of one or more users or groups of users by relevance. In some examples, relevance is a function of one or more of a location, an interest, or a social status score At block 244, the status management system 110, the interest management system 112 or the like may enable communications between entities and the users or groups of users. For example, entities may provide offers directly to the users or groups of users.

The social media system and social status interaction system 108 may be implemented via a host server or other computer hardware via computer storage media, processors, circuits and requisite electronics programmed and configured to operate sub-systems disclosed in the above noted prior patent applications incorporated herein by reference. These sub-systems including but not limited to a status management system and an interest management system managing databases and information storage or retrieval regarding members and authorized uses of the social media system disclosed herein.

The social media system that is the subject of this disclosure may be embodied on an apparatus, such as computing system 500, and may include means, such as a user status management system 110, a user interest management system 112, a processor 503, or the like, for causing a user status to be updated. For example, a user status may be set to “Looking to” through such a selection that social state. Furthermore, a user may engage in commercial activities via the social networking system, such as purchasing a deal from a local business, or the user may provide an indication to the status management system 110 that the user is currently “Looking to” be social with an interest in sports bars. Other indications may include, but are not limited to, a GPS indication, an indication by a user and/or the like. Alternatively or additionally, “Looking to” may represent an intent to do a particular kind of social activity. For example, “looking to” may include an instance in which the user is interested in and/or otherwise go out for live music in a certain area of a city. As such, a local bar may have access to information about the user or other groups of users based on the user or groups of user being in the “looking to” state and may interact with the user(s) to provide incentives and advertisements for their particular business. Alternatively, the recommendation engine system as described herein, may be used to provide recommended advertisements, deals and local businesses that match the user, or group of user's current social state of mind and interests. As is shown in operation 612, an apparatus, such as computing system 500, may include means, such as the status management system 110, the interest management system 112, the processor 503, or the like, for receiving an indication that a user has activated at an entity. A user may activate by taking a physical act at the entity, such as, but not limited to scanning a QR code, an exchange of a signal (e.g., Bluetooth, RFID, NFC and/or the like), barcode scan, check-in feature, GPS and/or the like.

In accomplishing a commercial activity via the social network, the user of the network may utilize an apparatus, such as computing system 500, may include means, such as the status management system 110, the interest management system 112, the processor 503, or the like, for providing information related to the group of users and the event to one or more destinations. As is shown in operation 806, an apparatus, such as computing system 500, may include means, such as the status management system 110, the interest management system 112, the processor 503, or the like, for facilitating new offers, advertisements and recommendations from one or more other entities to the group of users based on the users in the group. For example, another entity may try to “beat” or otherwise compete with an existing offer, an apparatus, such as computing system 500, may include means, such as the status management system 110, the interest management system 112, the processor 503, or the like, for receiving a selection from the building user of at least one social state of mind of the group, or a desired location selected from the one or more interests for the group of users. Similarly to the defining of interests, the building user may act as a leader and select the location or entity that the group will attend or may leave it up to the group to decide based on a vote, discussion or the like. In further examples, a social state of mind and multiple interests can be defined by a group and, as such, multiple entities may be selected by the group, for example, dinner and a movie, a basketball game and a club and/or the like.

In the example embodiment shown, computing system 500 comprises a computer memory (“memory”) 501, a display 502, one or more processors 503, input/output devices 504 (e.g., keyboard, mouse, CRT or LCD display, touch screen, gesture sensing device and/or the like), other computer-readable media 506, and communications interface 507. The processor 503 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application-specific integrated circuit (ASIC) or field-programmable gate array (FPGA), or some combination thereof. Accordingly, although illustrated in FIG. 1 as a single processor, in some embodiments the processor 503 comprises a plurality of processors. The plurality of processors may be in operative communication with each other and may be collectively configured to perform one or more functionalities of the social media system as described herein.

The social media system 108 is shown residing in memory 501. The memory 501 may comprise, for example, transitory and/or non-transitory memory, such as volatile memory, non-volatile memory, or some combination thereof. Although illustrated in FIG. 5 as a single memory, the memory 501 may comprise a plurality of memories. The plurality of memories may be embodied on a single computing device or may be distributed across a plurality of computing devices collectively configured to function as the social media system. In various example embodiments, the memory 501 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some examples, the social media system 108 may be stored remotely, such that it resides in a “cloud.”

In other embodiments, some portion of the contents, some or all of the components of the social media system 108 may be stored on and/or transmitted over the other computer-readable media 506. The components of the social media system 108 preferably execute on one or more processors 503 and are configured to enable operation of a social media system, as described herein.

Alternatively or additionally, other code or programs 540 (e.g. an administrative interface, one or more application programming interface, a web server, and the like) and potentially other data repositories, such as other data sources 508, also reside in the memory 501, and preferably execute on one or more processors 503. Of note, one or more of the components in FIG. 1 may not be present in any specific implementation. For example, some embodiments may not provide other computer readable media 506 or a display 502.

The social media system 108 is further configured to provide functions such as those described with reference to FIG. 1. The social media system 108 may interact with the network 550, via the communications interface 507, with remote content 560, such as third-party content providers, and one or more client devices operated by users 102, entities 104 and/or user groups 106. The network 550 may be any combination of media (e.g., twisted pair, coaxial, fiber optic, radio frequency), hardware (e.g., routers, switches, repeaters transceivers), and protocols (e.g., TCP/IP, UDP, Ethernet, Wi-Fi, WiMAX, Bluetooth) that facilitate communication between remotely situated humans and/or devices. In some instances, the network 550 may take the form of the internet or may be embodied by a cellular network such as an LTE based network. In this regard, the communications interface 507 may be capable of operating with one or more air interface standards, communication protocols, modulation types, access types, and/or the like. Client devices include, but are not limited to, desktop computing systems, notebook computers, mobile phones, smart phones, personal digital assistants, tablets and/or the like. In some example embodiments, a client device may embody some or all of computing system 500.

In an example embodiment, components/modules of the social media system 108 are implemented using standard programming techniques. For example, the social media system 108 may be implemented as a “native” executable running on the processor 503, along with one or more static or dynamic libraries. In other embodiments, the social media system 108 may be implemented as instructions processed by a virtual machine that executes as one of the other programs 540. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use synchronous or asynchronous client-server computing techniques. Also, the various components may be implemented using more monolithic programming techniques, for example, as an executable running on a single processor computer system, or alternatively decomposed using a variety of structuring techniques, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the social media system 108, such as by using one or more application programming interfaces can be made available by mechanisms such as through application programming interfaces (API) (e.g., C, C++, C#, and Java); libraries for accessing files, databases, or other data repositories; through scripting languages such as XML; or through web servers, FTP servers, or other types of servers providing access to stored data. The data sources 508 may be implemented as one or more database systems, file systems, or any other technique for storing such information, or any combination of the above, including implementations using distributed computing techniques and may provide relevant data to the status management system 110, the interest management system 112, and/or the credibility management system 114. Alternatively or additionally, the status management system 110, the interest management system 112, and/or the credibility management system 114 may have access to local data stores but may also be configured to access data from one or more remote data sources.

FIG. 4 is a flowchart that illustrates an interaction between users or groups of users and entities that share a common interest as is shown with reference to block 212 of FIG. 2. In an instance in which the interest of the user or group of uses matches an entity, then at block 240, the status management system 110, the interest management system 112 or the like may provide a view of or otherwise display via the user interface the users or groups of users sharing at least one of a common interest with an entity on least one of a map, information feed or the like. In one example, the users or groups of users may be provided, such as via the user interface, a visual of each entity that matches the current interest. Such visual may be presented in a map page or via another visual display presented to a user. The users or groups of users may then be able to navigate to a destination page for the entity to purchase admission, entry, a ticket, and/or reserve a table and/or otherwise interact with the entity.

Alternatively or additionally, the entity may be provided, via the user interface, a destination page or the like, the users or groups of users that are interested in the entity. For example, a sports bar may be able to see all of the users that are interested in attending a sports bar that particular evening. As such, the entity may provide offers, specials or otherwise try to interact with users. In some embodiments, the entity may be able to provide real time deals and/or ads. In some embodiments, an entity (e.g., a sports bar) may use a calendar information feed to identify groups and/or single users and subsequently provide future deals and ads. For example, providing future deals may include selecting one or more users or groups of users and providing a deal prior to (e.g., at a current time) that is good for use at a future time.

At block 242, the status management system 110, the interest management system 112 or the like may display the users or groups of users and/or the entities via the user interface based on a user credibility score. For example, users with a high user credibility score may be ranked at the top of a list and, as such, may be more aggressively targeted (e.g., may receive better offers) by entities. Similarly, users or groups of users may target those entities with higher user credibility scores. In some embodiments, the status management system 110, the interest management system 112 or the like may display the users or groups of users and/or the entities via the user interface, the user interface displaying, for example, an information feed display, of one or more users or groups of users by relevance. In some examples, relevance is a function of one or more of a location, an interest, or a social status score At block 244, the status management system 110, the interest management system 112 or the like may enable communications between entities and the users or groups of users. For example, entities may provide offers directly to the users or groups of users.

FIG. 5 shows an example embodiment of the use of one or more of the additional layers. Here, in order to, for example, report bugs, functionality related issues, inaccurate information, or otherwise transmit or post a private message, the editing interface of the at least one of the one or more additional layers may be configured to provide a reporting functionality. Additionally or alternatively, in some embodiments, the editing interface may configured to provide at least one of a pinning functionality or a text box functionality for at least one portion of the at least one of the one or more additional layers. In other words, once this layer is selected, a user may select one or more (or in some embodiments, any) portions of the display (e.g., a photo, a photo album, a wall post or the like) and either leave a notification “pin” or text information in a text box. In some embodiments, once a portion is selected, a text box or the like may be displayed, allowing the user to leave note. The layer may allow the user to address the note to a particular person, for a particular purpose, with a particular urgency, or the like. In some embodiments, where a pin or note is directed to user, an indication of which may be messaged by any electronic medium (e.g., emailed) or an indication may appear one either the main layer of the page when they view the page or in the pin placement layer of the page when they view the pin placement layer in examples, where the indication is transmitted to the user, the location of the pin (e.g., the portion of the page of interest) is indicated in the transmission.

In the social media context, the layer described with respect to FIG. 5 may allow a user to report functionality errors or inaccurate information. This layer may additionally or alternatively allow users to make private comments or messages about anything particular on a page. For example, when viewing the profile page of a friend, a user may make private comments regarding a picture, a group of pictures, status updates, personal information or the like.

As such, as shown in block 502 of FIG. 5, an apparatus, such as layer management system 108, may be configured for receiving input of a pin placement. Additionally or alternatively, as shown in block 504 of FIG. 5, an apparatus, such as layer management system 108, may be configured for receiving input of a portion of the layer. In some embodiments, once pin placement or a portions selection is received, as shown in block 506 of FIG. 5, an apparatus, such as layer management system 108, may be configured for providing a text box. And as shown in block 508 of FIG. 5, an apparatus, such as layer management system 108, may be configured for receiving text input. Once the user places a pin or enters text, the placement may be saved and any particular people to which the pin or message may be directed may be notified. As such, as shown in block 510 of FIG. 5, an apparatus, such as layer management system 108, may be configured for providing notification to an intended recipient. For example, in some embodiments, a “pin” may appear on the page in or within a predefined distance from the location where it was made. In some examples, such pin is viewable to an intended recipient, such as a default recipient who may be designated by the author or the page, the writer, and/or the recipient/page owner. The pin may be viewable as such until the page owner/recipient receives notification and permits the pin placement, for example, such as to facilitate accuracy of website information and/or in some cases, to enable communication between website owners/operators and one or more users.

Other exemplary embodiments, may allow a user to, for example, during beta testing, to select the pin placement layer for functionality or bug reporting in order to give the website valuable information about a functionality issue specific to a particular portion of a certain page or a particular page. Another exemplary embodiment may allow a user to select a second user's “high school information” and make a text message pin saying “my goodness, the glory days!”. The second user may then be notified of this. In some embodiments, the main layer or the pin placement layer may allow the second user to respond, add text, delete, modify or make viewable to one or more other people (e.g., a third user, a group of friends, the public) by, for example, an indication on the main layer or pin placement layer of a third person. In another exemplary embodiment, if a user sees a restaurant is representing itself as “fine dining”, but the user knows the restaurant is a casual diner or the like, the user may select the portion showing the inaccurate information, select a high urgency option, and pin text stating that the restaurant is really a casual dining restaurant. The website and/or the restaurant may be notified of the pin or message.

Additionally or alternatively, in some embodiments, users may be awarded, accumulate, or otherwise receive additional points when they participate. For example, points may be awarded or distributed based on accuracy of the information which is provided. For example, where a user provides information notifying a website owner that, for example, an address, phone number, description or the like is inaccurate and/or provides the correct information, points may be awarded. In some examples, points may be added at the discretion of the website owner and/or the system.

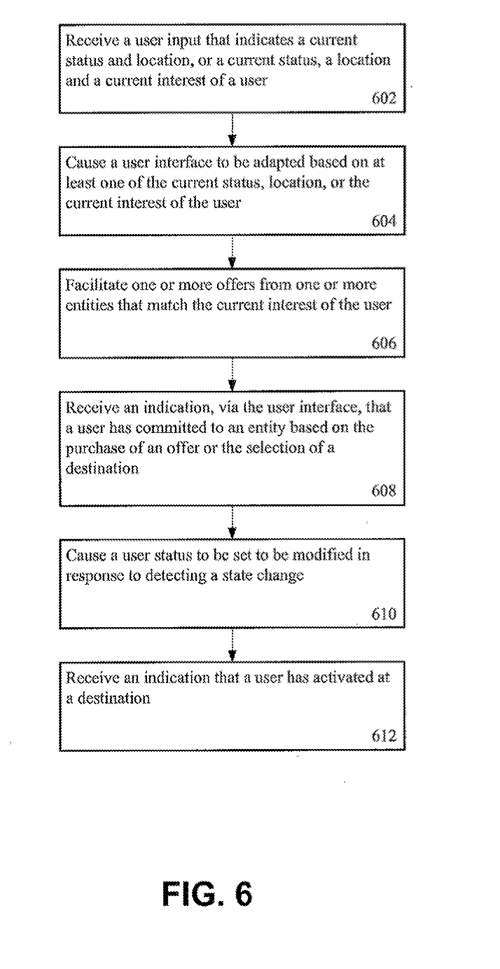

FIG. 6 is a flowchart illustrating an example interaction of a single user with the social status interaction system in accordance with some example embodiments described herein. As is shown in operation 602, an apparatus, such as computing system 500, may include means, such as the status management system 110, the interest management system 112, the processor 503, or the like, for receiving a user input that indicates a current status and a current interest of a user. For example, a user may set his/her status to active with an interest to “sports bars.” As is shown in operation 604, an apparatus, such as computing system 500, may include means, such as the status management system 110, the interest management system 112, the processor 503, or the like, for causing the user interface to be adapted based on the current status and the current interest. For example, a map or other view may be displayed that shows entities which have selected or have otherwise identified themselves as sports bars and/or those entities that have been considered by others to be sports bars, and an information news feed displaying other users active with an interest of sports bars. This interface allows, in some examples, the user to see those entities that match the stated interest so that a selection can be made. This interface may also enable a user to identify or otherwise be paired with users who share a similar interest for the evening.

As is shown in operation 606, an apparatus, such as computing system 500, may include means, such as the status management system 110, the interest management system 112, the processor 503, or the like, for facilitating one or more offers from one or more entities for the user based on the current status and the current interest. In some examples, the user may select an entity to visit (e.g., sports bar A) and then may purchase a pre-existing deal from that entity (e.g., coupon for free wings at sports bar A, admission ticket, cover charge or the like) within the user interface. In other examples, an entity may solicit business from active, and/or interested users by sending offers (e.g., an offer for free wings and a drink at sports bar B) or notifications to those users.

As is shown in operation 608, an apparatus, such as computing system 500, may include means, such as the status management system 110, the interest management system 112, the processor 503, or the like, for receiving an indication, via a user interface, that a user has selected an entity based on the purchase of an offer, selection of an entity or the like. In some examples, the current status of the user may be adjusted to committed state. For example, a user may commit to an activity either by an act, (e.g., purchasing an admission ticket or other offer) or by indicating commitment via the user interface. A selection of “commit” via the user interface, may cause or otherwise result in the display of a search bar or other input/output mechanism where the user searches for an entity, destination, event or the like, which is near the user's current or future location. Once a user is committed to a particular entity, such social state of “committed to entity”, may be posted to the news feed of other users who have been given permission to view this users social activity and who have added the user to their news feed view list.

As is shown in operation 610, an apparatus, such as computing system 500, may include means, such as the status management system 110, the interest management system 112, the processor 503, or the like, for causing a user status to change based on a detected state change or user action taken within the system. For example, a user status may be set to transporting in response to an indication that a user is traveling to the selected entity. For example, a user may order a taxi via the user interface or provide an indication to the status management system 110 that the user is currently riding in a taxi to sports bar A. Other indications may include, but are not limited to, a GPS indication, an indication by a user and/or the like. Alternatively or additionally, transporting may represent an intent to transport or otherwise travel by the user. For example, transporting may include an instance in which the user is interested in and/or otherwise ready to travel to a location but has not yet begun the trip. As such, a transport company may have access to information about the user or other groups of users based on the user or groups of user being in the transporting state and may interact with the transporting user to provide transport services. As is shown in operation 612, an apparatus, such as computing system 500, may include means, such as the status management system 110, the interest management system 112, the processor 503, or the like, for receiving an indication that a user has activated at an entity. A user may activate by taking a physical act at the entity, such as, but not limited to scanning a QR code, an exchange of a signal (e.g., Bluetooth, RFID, NFC and/or the like), barcode scan, check-in feature, GPS and/or the like. In some embodiments, one or more “state” changes may posted to the news feeds or information feeds of all users who have been given permission to view this users social activity, who have added the user to their news feed view list and/or the like. For example, a user who has been given permission by a second user to see second users social activity may see in the user's information feed that the second user is committed to an entity. In some embodiments, in an instance in which a second user is not added to the users news feed view list, one or more state changes may not be seen in the user's information feed. In some embodiments, all state changes may be shown, whereas in other embodiments, one or more predefined state changes may be shown.

In one exemplary embodiment, “connections” may be the users or groups of users that a particular user has permitted to view or otherwise be notified of that particular user's social activity. For example, a particular user may provide an indication that the particular user gives permission to another user to view their social activity. Once such permission has been granted, the other user may choose to add the particular user to their news feed view list. Such an action may result in the social activity of the particular user being displayed in the user's “my scene” news feed, via a visual display, or the like. In some embodiments, a second particular users social activity may not displayed in a user's news feed in an instance in which, for example, the second user has not been added to user's community at all, the second user has been added to user's community, and has been given permission by second user to view second user's social activity, but user has not chosen to add the second user to user's “my scene” news feed view list, or user has been added to second user's community, but second user did not give permission user's permission to view second user's social activity)

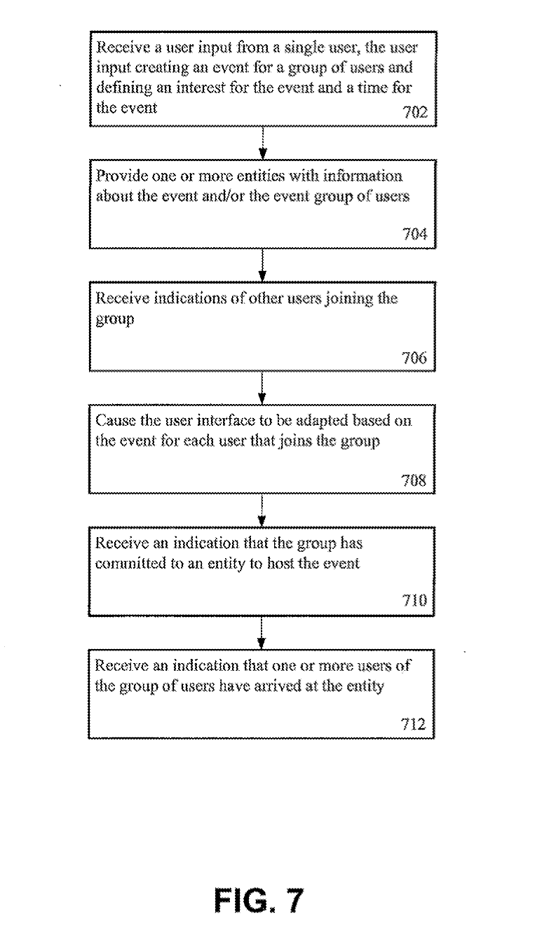

FIG. 7 is a flowchart illustrating an example interaction of a single user that is creating an event for a group with the social status interaction system in accordance with some example embodiments described herein. As is shown in operation 702, an apparatus, such as computing system 500, may include means, such as the status management system 110, the interest management system 112, the processor 503, or the like, for receiving a user input creating an event for a group of users and defining an interest, location and a time of the event. In some examples and in an instance in which a group is formed for the purposes of attending an event together, the group state may be set to building. For example, a user may identify an event of a birthday and an interest of a steakhouse and, as such, the group may build (e.g., add new members) based on those parameters. Alternatively or additionally, an event may be an event in the future and may involve travel to a new geographical location for the purposes of the event. For example, a bachelor party in Las Vegas, or a golf weekend in South Carolina may be the event setup at operation 702. In some embodiments, in either real-time or at a future time, entities may be enabled to locate one or more users or groups of users via, for example, a “user finder page” and, may further be enabled to provide real-time deals and/or future deals using, for example, a calendar news feed. In some examples, the entities may communicate with the users or groups of users.

As is shown in operation 704, an apparatus, such as computing system 500, may include means, such as the status management system 110, the interest management system 112, the processor 503, or the like, for providing one or more entities with information about the event group of users. Generally, the event will be in the future, as such, an entity may be interested in soliciting the group based on size of the group and the date of the event, and, in some embodiments, a credibility score of the group or the users in the group. The entities, in some examples, may view information about the event group via a destination page or other calendaring “user finder” interface, and then may respond with targeted deals, specials and/or the like for the group.

As is shown in operation 706, an apparatus, such as computing system 500, may include means, such as the status management system 110, the interest management system 112, the processor 503, or the like, for receiving indications of other users joining the group. As is shown in operation 708, an apparatus, such as computing system 500, may include means, such as the status management system 110, the interest management system 112, the processor 503, or the like, for causing the user interface to be adapted based on the event for each user that joins the group. In some embodiments, the apparatus may include means for causing the user interface to be adapted for each user that joins the group. For example, entities matching the interest and location of the event may be shown via the user interface once a user joins the group. In some embodiments, a status may post to a news feed of one, more than one, or all connections and/or a view of others groups who have matching or similar location and interests may be provided.

As is shown in operation 710, an apparatus, such as computing system 500, may include means, such a the status management system 110, the interest management system 112, the processor 503, or the like, for receiving an indication of at least one entity to host the event that has been identified by the group. As is shown in operation 712, an apparatus, such as computing system 500, may include means, such as the status management system 110, the interest management system 112, the processor 503, or the like, for receiving an indication that one or more users of the group of users have arrived at the entity based on those users activating at the location. In some embodiments, one or more users or groups of users may “attend” or “follow” to an event and/or entity. When a user or group of users is set to “attend” an event, “attend” may indicate that the users or groups of users plan on attending and, furthermore, the users or groups of users may receive updates regarding to and may post about the event on, for example, a news feed. When a user or group of users is set to “follow” to an event, “follow” may indicate that the users or groups of users have an interest in attending the event, and, furthermore, the users or groups of user may, additionally or alternatively, receive updates of event on each users “my scene” news feed. Either selection (e.g., attend or follow) relating to an event may result in information about the event being added to a user's “my scene” news feed. In some embodiments, users may use the calendar news feed to view future dates. In some embodiments, all (or some portion of) users who have are “following” or “attending” selections may be displayed on the calendar news feed dates in the future, and the event Web page, so a user or group of users may identify who is going to what event in the future.

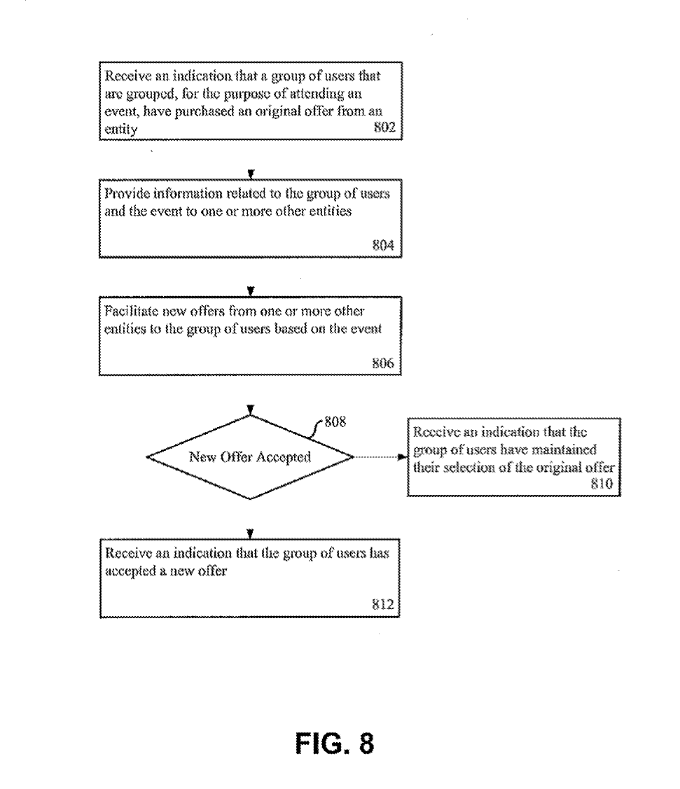

FIG. 8 is a flowchart illustrating an example interaction of a group with the social status interaction system in accordance with some example embodiments described herein. As is shown in operation 802, an apparatus, such as computing system 500, may include means, such as the status management system 110, the interest management system 112, the processor 503, or the like, for receiving an indication that a group of users that are grouped for the purpose of attending an event have purchased an original offer from an entity. For example, the event may be a birthday party and the group may have paid for admission (e.g., cover) and reserved a table at the bar. In some examples, a group may purchase offers from multiple entities, because a user and/or group may visit multiple entities within one evening or during one event that spans multiple days.

As is shown in operation 804, an apparatus, such as computing system 500, may include means, such as the status management system 110, the interest management system 112, the processor 503, or the like, for providing information related to the group of users and, optionally, in some embodiments, the event group to one or more destinations. As is shown in operation 806, an apparatus, such as computing system 500, may include means, such as the status management system 110, the interest management system 112, the processor 503, or the like, for facilitating new offers from one or more other entities to the group of users based on the event group interest, location, and credibility rating of group members. For example, another entity may try to “beat” or otherwise compete with an existing offer by sending real time, near real time or future offers to users groups that they seek to do business with.

As is shown in decision operation 808, an apparatus, such as computing system 500, may include means, such as the status management system 110, the interest management system 112, the processor 503, or the like, for determining whether a new or updated offer has been accepted. In an instance in which the new offer is not accepted, then, as is shown in operation 810, an apparatus, such as computing system 500, may include means, such as the status management system 110, the interest management system 112, the processor 503, or the like, for receiving an indication that group of users have maintained their selection of the original offer. However, in an instance in which a new offer is accepted, as is shown in operation 812, an apparatus, such as computing system 500, may include means, such as the status management system 110, the interest management system 112, the processor 503, or the like, for receiving an indication that the group of users has accepted a new offer. In some example embodiments, the status management system 110, the interest management system 112, the processor 503, or the like, may cause a refund of the original offer and may facilitate the purchase of the new offer.

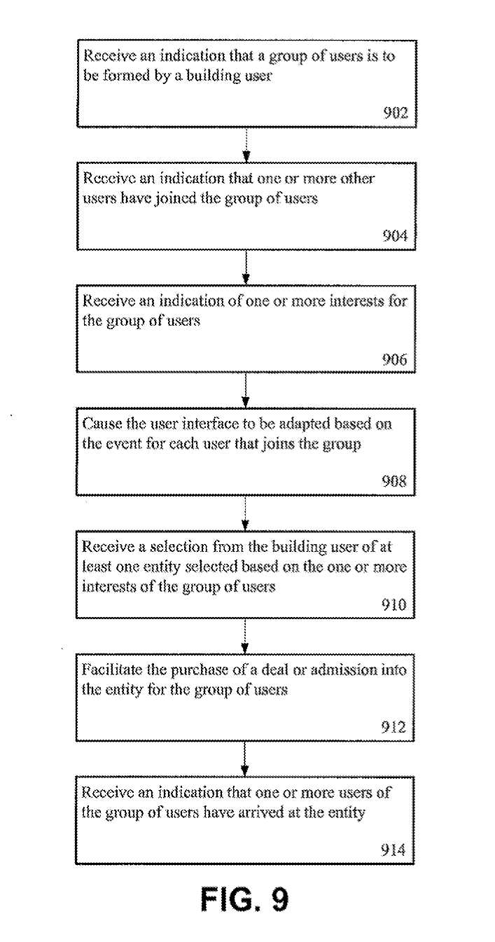

FIG. 9 is a flowchart illustrating an example interaction of a group planning for a current evening or future date with the social status interaction system in accordance with some example embodiments described herein. As is shown in operation 902, an apparatus, such as computing system 500, may include means, such as the status management system 110, the interest management system 112, the processor 503, or the like, for receiving user input indicating that a group of users is to be formed by a building user. For example, a building user may indicate, via a user interface, an interest in building a group to attend a sporting event that evening and/or go to a club. In some embodiments, a building user may indicate, via a user interface, an interest in building a group and may be provided, by the apparatus, a means for searching and/or selecting particular destinations. In some embodiments, the apparatus may include means for allowing, for example, the building user (or user given managing authority) to select one or more particular destinations and place each of one or more particular destinations in a list, queue or the like, and, allow other users to vote for one or more of the particular destinations. In some embodiments, that apparatus may include means for allowing the group to be placed on a destination user finder page. In some embodiments, due to the voting designation or the like, the apparatus may provide the group an indication of being more relevant.

In some embodiments, the apparatus may include means or facilitating formation of a group the group comprised of the user and the one or more users, one or more of the other users able to be selected by the building user based on being provided a list of other users having matching or relevant future statuses, locations, ad/or interests. In some embodiments, the system may display to “building” users, all other users (in, for example, their custom named connections group) who are “active”, “committed”, and/or “exploring” the same general location. Additionally, in some embodiments, the system may display users as most relevant whose optionally selected interest/focus matches that of the group. The system may also provide a “building” user the ability to invite such users to the user group. The system may also provide group members with a chat function to facilitate social conversation and, in some embodiments, to help determine their desired social activity. Subsequently, a builder (or authorized manager member) may invite other users to join the group. When a user joins a group, the system may then post that the user has joined the group onto the “My Scene” news feed, to another visual display or the like of all other users who have the user in their “custom named connections group”. As is shown in operation 904, an apparatus, such as computing system 500, may include means, such as the status management system 110, the interest management system 112, the processor 503, or the like, for receiving an indication that one or more other users have joined the group of users.

As is shown in operation 906, an apparatus, such as computing system 500, may include means, such as the status management system 110, the interest management system 112, the processor 503, or the like, for receiving an indication of one or more interests for the group of users. In some examples, a building user may define the interests of a group, however in other cases a vote or other discussion may occur to determine the interests of the group. In some embodiments, when a group sets an interest or focus, the interest and/or focus may be posted to the “my scene” news feed of other users who have a member of the group in their “custom named connections group” subject to privacy settings. Further, the system may provide a builder (or authorized manager member with the ability to “commit” the group to a particular location, via a destination/event search bar. When a group selects a particular destination/event and “commits” to this particular destination/event, the system may post this group as “committed” to the particular destination/event. The system may post this status update to the “my scene” news feed of other user(s) (i.e., users outside the group) if the other users have added any member of the group to their “custom named connections group”. As is shown in operation 908, an apparatus, such as computing system 500, may include means, such as the status management system 110, the interest management system 112, the processor 503, or the like, for causing the user interface to be adapted based on the event for each user that joins the group.

As is shown in operation 910, an apparatus, such as computing system 500, may include means, such as the status management system 110, the interest management system 112, the processor 503, or the like, for receiving a selection from the building user of at least one desired location selected from the one or more interests for the group of users. Similarly to the defining of interests, the building user may act as a leader and select the location or entity that they group will attend or may leave it up to the group to decide based on a vote, discussion or the like. In further examples, multiple interests can be defined by a group and, as such, multiple entities may be selected by the group. For example, dinner and a movie, a basketball game and a club and/or the like.

As is shown in operation 912, an apparatus, such as computing system 500, may include means, such as the status management system 110, the interest management system 112, the processor 503, or the like, for facilitating the purchase of any entry fees into the at least one desired location. For example, the group can purchase entry fees, tickets, coupons or the like as a group or each user can be prompted to purchase individually. As is shown in operation 914, an apparatus, such as computing system 500, may include means, such as the status management system 110, the interest management system 112, the processor 503, or the like, for receiving an indication that one or more users of the group have arrived at the desired location.

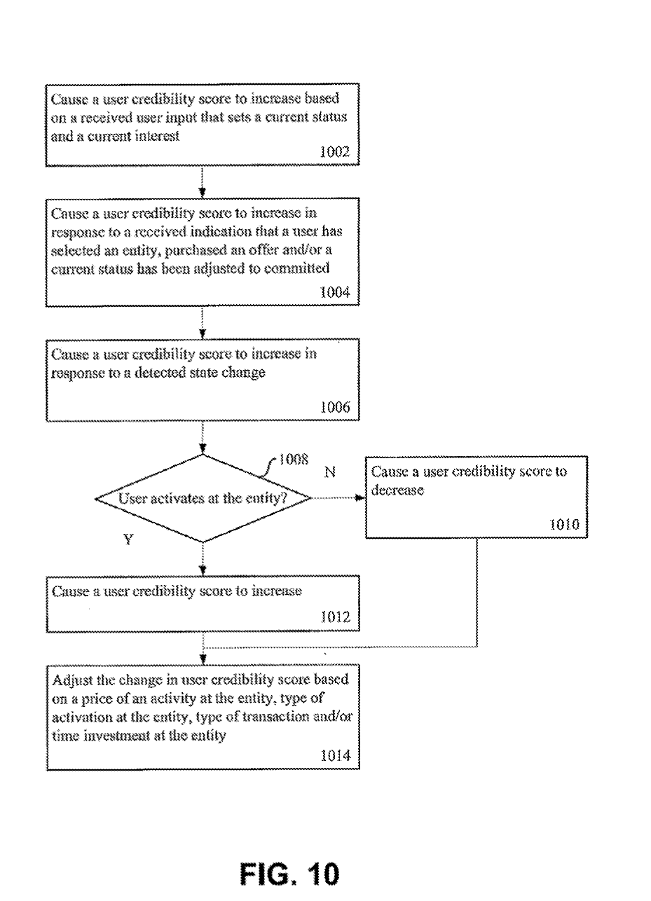

FIG. 10 is a flowchart illustrating example user credibility scoring of a single user interacting with the social media system in accordance with some example embodiments described herein. As is shown in operation 1002, an apparatus, such as computing system 500, may include means, such as the social media system 108, the credibility management system 114, the processor 503, or the like, for causing a user credibility score to increase based on a received user input that sets a current status and a current interest. In some examples, any user interaction may result in an increase in the user credibility score, whereas any time a user fails to perform has indicated a user credibility score may be decreased. As such, the user credibility score may function as an incentive for a user to follow through with commitments made in the digital world (e.g., the social media system) and to continually funnel a user to an interaction in the physical world (e.g., an interaction at an entity or other users). In some example embodiments, entities may also be assigned a credibility score based on user experiences, reviews, participation, the creation of deals/offers, and/or the like.

As is shown in operation 1004, an apparatus, such as computing system 500, may include means, such as the social media system 108, the credibility management system 114, the processor 503, or the like, for causing a user credibility score to increase in response to a received indication that a user has selected a desired location, purchased an offer and/or a current status has otherwise been adjusted to committed. In some examples, the closer that a user gets to a physical interaction, the greater the increase in the user credibility score. In other cases, a purchase transaction may be worth a larger increase in user credibility score over a simple indication of commitment because of a higher level of commitment that may be attributed to the fact that the user spent money. For example, it is more likely a user will visit the sports bar if he/she has already purchased an offer.

As is shown in operation 1006, an apparatus, such as computing system 500, may include means, such as the social media system 108, the credibility management system 114, the processor 503, or the like, for causing a user credibility score to increase in response to a detected state change. For example, in an instance in which a current status is set to transporting, committed, or the like. In some examples, the user credibility score may be increased in an instance in which a user activates (e.g., scans a QR code, passes an RFID reader or the like) at a mode of transportation, such as a taxi, train, bus or the like. Alternatively or additionally. OPS indications, activating a parking lot, a user indication or entry and/or the like may also provide an indication that a user is transporting to a location and, as such, may result in the user receiving an increase in user credibility score.

As is shown in decision operation 1008, an apparatus, such as computing system 500, may include means, such as the social media system 108, the credibility management system 114, the processor 503, or the like, may be configured to determine whether a user has activated or has otherwise checked in at a desired location. In an instance in which a user has activated at a desired location, then, as is shown in operation 1012, an apparatus, such as computing system 500, may include means, such as the social media system 108, the credibility management system 114, the processor 503, or the like, for causing a user credibility to rise. As is shown in operation 1014, an apparatus, such as computing system 500, may include means, such as the social media system 108, the credibility management system 114, the processor 503, or the like, for adjusting the change in user credibility score based on a price of an activity at the desired location, type of transaction and/or a time investment at a desired location. For example, a two hour movie may result in a larger increase to a user credibility score than a fifteen minute visit to a sports bar.

Alternatively or additionally, a credibility score of an entity may rise in an instance in which a user activates. Similarly, an employee of an entity may also receive an increase in credibility if he/she is able to recruit a user or group of users to activate at a desired location.

In an instance in which a user has not activated at a desired location (e.g., the location of the entity to which the user committed), then, as is shown in operation 1010, an apparatus, such as computing system 500, may include means, such as the social media system 108, the credibility management system 114, the processor 503, or the like, for causing a user credibility score to decrease.

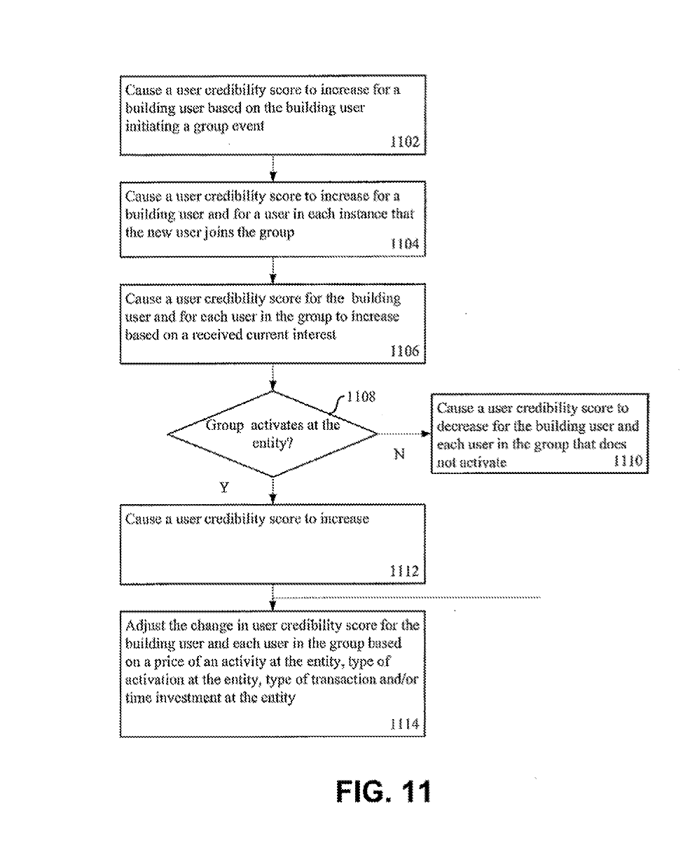

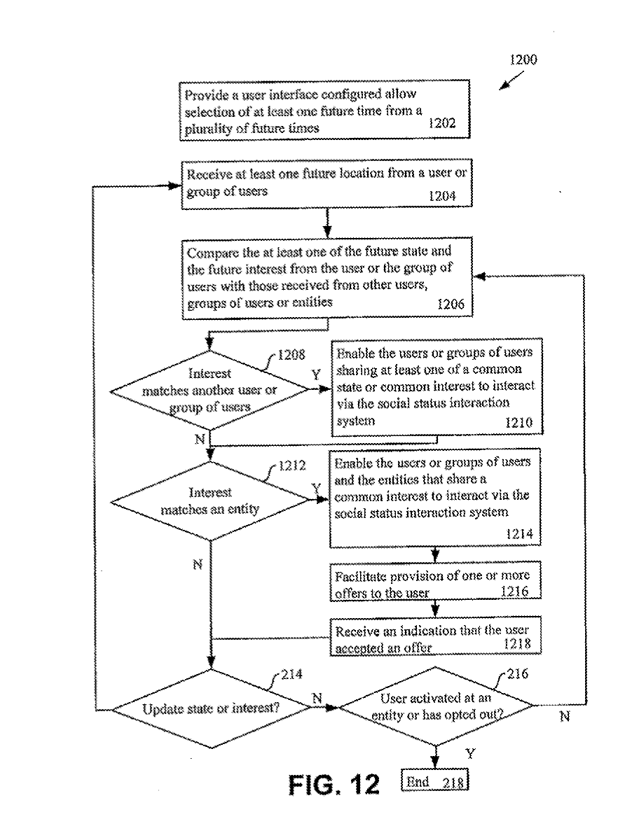

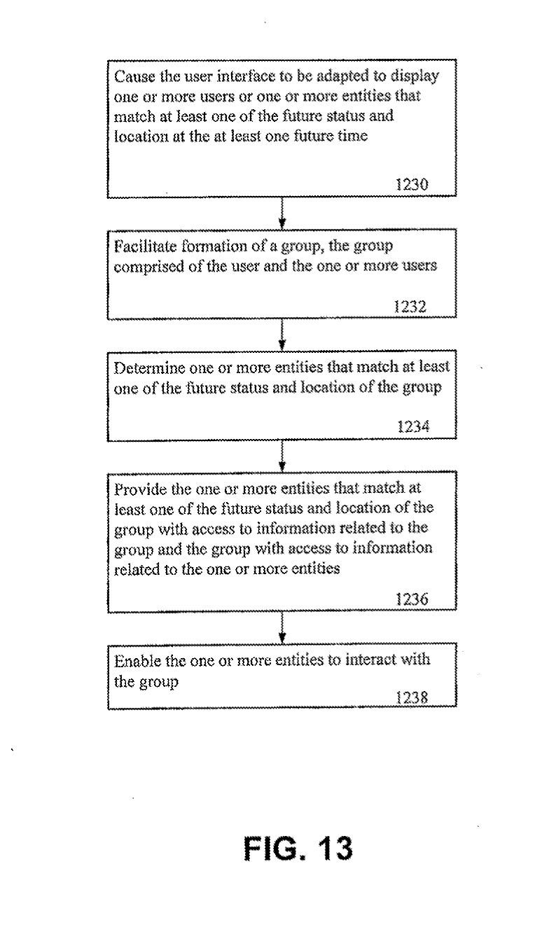

FIG. 11 is a flowchart illustrating example user credibility scoring of a group of users interacting with the social media system in accordance with some example embodiments described herein. As is shown in operation 1102, an apparatus, such as computing system 500, may include means, such as the social media system 108, the credibility management system 114, the processor 503, or the like, for causing a user credibility to increase for a building user based on the building user initiating a group event. As is described above, any interaction with the social media system 108 may result in an increase in user credibility score, however a user who builds a group of users, and, therefore, motivates a larger group to participate in the physical world may receive an additional increase in user credibility score.

As is shown in operation 1104, an apparatus, such as computing system 500, may include means, such as the social media system 108, the credibility management system 114, the processor 503, or the like, for causing a user credibility score to increase for a building user and for a user in each instance that a new user joins a group. For example, each time a user joins the group, that user and the building user will receive an increase in user credibility score. As is shown in operation 1106, an apparatus, such as computing system 500, may include means, such as the social media system 108, the credibility management system 114, the processor 503, or the like, for causing a user credibility score for the building user and for each user in the group to increase based on a received current interest.

As is shown in decision operation 1108, an apparatus, such as computing system 500, may include means, such as the social media system 108, the credibility management system 114, the processor 503, or the like, may determine whether the users of the group activate at a location. In an instance in which the group activates at a location, then, as is shown in operation 1112, an apparatus, such as computing system 500, may include means, such as the social media system 108, the credibility management system 114, the processor 503, or the like, for causing a user credibility score to increase. As is shown in operation 1114, an apparatus, such as computing system 500, may include means, such as the social media system 108, the credibility management system 114, the processor 503, or the like, for adjusting the change in user credibility score for the building user and each user in the group based on a price of an activity at the desired location, type of activation at the desired location, type of transaction and/or time investment at the desired location.

In an instance in which the group does not activate at a location, then, as is shown in operation 1110, an apparatus, such as computing system 500, may include means, such as the social media system 108, the credibility management system 114, the processor 503, or the like, for causing a user credibility score to decrease for the building user, authorized group manager or managers. In some examples, a user credibility score is decreased in an instance in which the group had committed, in some examples the entire group may also have a credibility score reduced. In some examples, the building user or authorized group manager or managers may receive a larger decrease in user credibility score.

In some embodiments, the computer-executable program code instructions further comprise program code instructions for facilitating the one or more entities to provide one or more offers, advertisements and recommendations to the user based on one of the social status, interest, and location of the user. In some embodiments, the computer-executable program code instructions further comprise program code instructions for facilitating the one or more entities to provide one or more offers to the user based on one of the status, location, and interest of the user.

Alternatively or additionally, the status management system 110 may define multiple states for the one or more entities 104a-104n. In some example embodiments, states and/or “tags” for the one or more entities 104a-104n may be selected, defined and/or otherwise determined at a time in which the one or more entities 104a-104n sign up or create their pages (e.g., destination page). For example, a restaurant may select or otherwise set its “state” as “brunch” from 9 am-2 pm on Friday-Sunday. Other states may be selected by the one or more entities 104a-104n to reflect the desired business position of the entity. For example, a restaurant may set its status to “happy hour” or “specials” to highlight attractive discounts to the one or more users 102a-102n and the one or more user groups 106a-106. In some examples, the state change may also cause a change in the destination page for that entity. For example, a restaurant that has set “brunch” as its state from 9 am-2 pm may have its state automatically changed at 9 am on Friday and, as such, may have its destination page change to include a brunch menu or other information related to its current state. Further at the time of the state change, the restaurant may then be able to see or otherwise have access to the one or more users 102a-102n and the one or more user groups 106a-106a that have set their interest to match the state of entity, for example, “brunch.” Additional entity interests, focuses and/or tags may include but are not limited to live music, dance party, sporting event, outdoor activities, indoor activities, brunch, happy hour, sports bar, diner, fine dining, casual dining, each of which, in some embodiments, may be included in the tag cloud engine. In some embodiments, a tag cloud engine may contain a plurality of states, interests, focuses, tap or the like that may be displayed visually, contained in a list, accessible via a text box or the like. In some embodiments, an entity may be able to see or otherwise have access to the one or more users, and the one or more user groups, that have set their interest to match a tag of the entity, or matching the entity type. For example, a user who has set an interest in Mexican dining will be viewable to entities identified by, for example, with an entity tag for Mexican cuisine. In some embodiments, additionally or alternatively, a user may set a more detailed interest for Mexican restaurants, and karaoke. The “finder page” news feed function may now display this user at the top of such news feed as highly relevant for entities identified by, for example, as Mexican restaurants that have used the calendar function to or have otherwise set a focus for karaoke on this particular date. The end result here, in some examples, is that entities that have one or more particular tags (e.g., Mexican restaurant, Karaoke), can see in real time or near real time, users and user groups that have a highly relevant interest in their entity.

Alternatively or additionally and in some example embodiments, the interest management system 112 may be further configured to enable the one or more users 102a-102n, the one or more entities 104a-104n and/or the one or more user groups 106a-106n to follow the social activity of one or more entities. In some examples, the one or more users 102a-102n, the one or more entities 104a-104n and/or the one or more user groups 106a-106n may receive updates, receive state changes, view information, communicate with and/or the like from those of the one or more users 102a-102n, the one or more entities 104a-104n and/or the one or more user groups 106a-106n that they are following, they are interested in, that match preferences or the like. For example, in an instance in which a restaurant sets its state, or posts to its “followers” for “brunch,” a user may see this state change/post on a news feed, information feed or the like. Alternatively, the recommendation engine may display entities and advertisements to a user that match the user's current social state and interest based on the matching entity and advertisement tags. In other examples, a communication interface (e.g., instant message, email, messaging, phone or other communication medium) may be established between the one or more users 102a-102n, the one or more entities 104a-104n and/or the one or more user groups 106a-106n that match a location, interest, focus and/or the like.

Alternatively or additionally, the entity may be provided, via the user interface 510, a destination page or the like, the users or groups of users that are interested in the entity. For example, a sports bar may be able to see all of the users that are interested in attending a sports bar that particular evening. As such, the entity may provide offers, advertisements, specials or otherwise try to interact with users. In some embodiments, the entity may be able to provide real time deals and/or ads. In some embodiments, an entity (e.g., a sports bar) may use a calendar information feed to identify groups and/or single users and subsequently provide future deals and ads. For example, providing future deals may include selecting one or more users or groups of users and providing a deal prior to (e.g., at a current time) that is good for use at a future time.

As is shown in certain operations, an apparatus, such as computing system 500, may include means, such as the status management system 110, the interest management system 112, the processor 503, or the like, for providing one or more entities with information about the event group of users. Generally, the event will be in the future, as such, an entity may be interested in soliciting the group based on size of the group and the date of the event, and, in some embodiments, a credibility score of the group or the users in the group. The entities, in some examples, may view information about the event group via a destination page or other calendaring “user finder” interface, and then may respond with targeted deals, specials and/or the like for the group.

Social media systems encompassed by this disclosure utilizes processes for generating offers and advertisements to, for example, different users or groups of users. A business entity system user (104) may utilize that entity's device and configure their social media membership to monitor, over a first time period, one or more individual users (102) to determine whether the one or more users match the entity's future status and location during at the at least one future time or future time period. The device may be configured to generate a first offer in an instance in which a match is determined. In some embodiments, the entity may continue to monitor users or groups of users that match the future status, and location during the at least one future time or future time period. As more users or groups of users match, in some embodiments, an offer may change. For example, in an instance in which them are more matching users, the entity may no longer have to provide an offer to attract users. Whereas, in some embodiments, as an event draws near, an additional offer may be provided to attract the users or groups of users in an instance in which there are not enough matching users or groups of users. Accordingly, the entity device may be configured to monitor, over a second time period, one or more users that match the future status and location at the at least one future time or future time period. The entity device may be configured to generate a second offer as a function of monitoring.

In one embodiment described herein, the social media system utilizes the above described status management system 110, interest management system 112, credibility management system 114, and planning management system 117 as an overall recommendations engine 121. The recommendations engine 121 described herein is designed to provide destinations (bars, clubs, restaurants, etc) the ability to make on the fly deals that reach the target consumers (users of the social media system). It is also designed to enable groups of users to find deals that relate to their interests. The engine also pushes deals directly to individuals via a notification of deal creation. One of the main goals of this is not only to provide users with a interesting deals, but to help the user find their ideal destinations and even enjoy those destinations with an appropriate group of other users of the system.

Currently, there are no online social network functions that provide the ability to make plans, gather users together (optionally), and generate deals that relate to the interests of the user(s), and their current state of mind. Additionally, a single user may be extended deals that are based on their selected interests, and activity on the social network. Through the use of a “Planning” feature, the Hopspot system presents various deals, destinations, and events that correspond to the plans that a group of users are making. A group of users may have the ability to select a “social state of mind”, such as “Looking to” or “Going to”, with a certain interest tags. The data science models learn from the behavior of the users and the information the user has provided. This system then presents these deals and advertisements based on the collective knowledge the system has of the group of individuals.

In addition to the Planning feature, users can be reached via their news feed by targeted deals and advertisements that the system directs to reach them. Essentially, a deal or advertisement is created based on various parameters, then the system, based on data science and related tags, displays the deal to the best matched users and groups of users. Additionally, the deal is saved into the system: (1) for display on the destination's profile page, and importantly. (2) for display when the Planning feature is selected by a user currently making a plan which the system recognizing as a match. A user does not have to invite others to this plan. A single person can make a plan, select no interests at all, and still be presented with deal via the Planning feature. Additionally, destinations may pay a small fee to boost these deals and advertisements, in which case the deals will appear on the Planning feature area, and or news feed of more users, especially all users that the system finds a match in interest.

The idea of the planning feature is to create a system that finds the right destination/deal for the right person, and encourages the user to be social with other people. Once a deal is selected by an individual through the planning feature, the deal can then be viewed by the group, on the group's plea page. In further installments of the method, e-commerce transactions will take place where groups and individuals can purchase: tickets to events/concerts/sports, cover fees, flight tickets, hotel rooms, 20$ for 10$ restaurant coupons, etc. These deals will be created in similar fashion (by use of a template with various target parameters), but will include a Cost S text box where destinations can name a price for the deal. By selecting the planning feature, the user is basically receiving deals that align with what they want to do.

This deal and advertisement engine is a useful improvement upon current deal systems that may exist online. Specifically in social networking, this Planning feature is the first time known of anybody giving online users the ability to organize their plans, and then easily find deals and be provided recommendations that relate to what they want to do, in real time, with the push of one button. The user (or group of users) may not know what they want to do, and the system can still accurately provide the plan members with deals through the data science, without being provided current interest information. The interests are certainly a driver of the engine, but the data science models are always present. This method also creates a revenue stream whereby businesses can pay for more placement using an auction bidding boosting method, thus reaching more people in their geographic areas that actually want the business they have. This is big leap from other online deal sites that simply put up a deal, and then rely on users to buy them. Through the data driven method, the system makes sure the right deals and destinations reach the right users. Not only does the method provide more value to the destination by targeting users that are more likely to accept a deal and come to their establishment (or make a purchase), the users are more likely to find the destination appealing, and want to be a return customer.

In one embodiment, the computerized system and software engine described herein utilizes empirical affinities, whether expressed or computed, content based search data and collaborative filtering techniques on stored data available to the software that recommends certain data content to proper users who would respond well to that content. In one embodiment, the recommendations engine 121 of the social media network 108 implements software to utilize a preferred technique of data processing via empirical affinity analysis, collaborative filtering analysis, or content searching based on which technique would yield the best data the fastest. New users, for example, would not have enough of a history on the social media system 108 for collaborative filtering to be effective, but their presences on the social network would involve certain text and demographic data available for searching on a content basis to determine proper recommendations. In this sense, the new user would benefit from the content based data searching being Weighted heavier than a collaborative filtering approach. In one embodiment, therefore, the system disclosed herein allows for the content based searching to be used to “learn” about a system user and direct content to that user until enough data exists to move toward Weighting the collaborative filtering more heavily.

In one embodiment, therefore, this system utilizes a computerized method of combining traditional empirical affinity information, inferred affinity information, globally averaged information, collaborative filtering (CF), and content-based data processing to create a hybrid recommendations software module that systematically Weights the importance of the content-based data as the basis of behavioral data for CF grows over time.

As discussed in more detail below, the social media system 108 of this disclosure provides two kinds of data processing mechanisms to deliver highly relevant content data to the correct system users on an expedited basis. First, the system 108 is configured via a server setup to distinguish the kind of data that is currently being collected and stored on the system at any given time. The different kinds of data are divided into work queue pipelines so that the servers can prioritize the kinds of data and update the users' respective experience more efficiently. Second, the social media system implements both incremental data processing update algorithms as well as batch algorithms to further prioritize the kinds of data that are updated expeditiously and those that can wait. The system is further configured to Weight the algorithms used for prioritization of data processing as discussed below.

The social media system 108 is particularly adept at directing content data, such as any content from the recommendations engine 119, to the system users so that the system users' layered access pages are updated quickly and efficiently. The updating techniques are most efficient for users that have been active members of the social media system for quite some time with a long and recorded history of preferences stored in the system memory. For new users with little to no system history, or for users who need a new kind of content due to changes in status, the social media system 108 must address what is called the “cold start” problem.

The cold start problem refers to a user condition in which the system's automated software has little information about the user in general or no information at all about a user for a particular topic. One approach to the cold start problem is to figure out whether the respective user can be identified according to empirical affinities (not likely) or inferred affinities (more likely). The system described herein can process the main kinds of data for each user in a systematic way so that the user's social media experience includes the most up to date and relevant content data possible.

The social networking system 108 particularly combines content-based data with users' affinities for items into a single hybrid content-based/CF recommendation engine. Existing approaches to creating such hybrid models fix the importance the model assigns to each of its components. This is undesirable, because it does not allow the model to account for variation in the quantity of behavioral evidence supporting the CF model. Ideally a hybrid model would give more Weight to such evidence, as the quantity of evidence increased.

In the system of this disclosure for determining the appropriate recommendations to a system user, the similarity between items a and b may be akin to a cosine-like function combining content-based (keyword) similarity and affinity-based similarity, with values on the interval [−1, 1], where higher values indicate greater similarity. Content-based similarity between items a and b with keyword sets Kₐ and K_{b} is defined as

sim_{c}(a,b)=|Kₐ∩K_{b}/√(|Kₐ|·|K_{b}|)

where the vertical bars represent the set-size operation. If either destination lacks keywords, set sim_{c}(a, b) to zero. Note that this function's value is bounded above by one and below by zero.

In practice, the computerized recommendations engine is programmed to denote user i's affinity for item j as aff(i, j). If an affinity is unknown, set it to zero. Denote by Vⱼ the vector of aff(i, j) values for all i in the set U indexing all users, and fixed j. Finally, let w_{c} be a tunable non-negative Weight. The overall similarity between destinations a and b is

(w_{c}·sim_{c}(a,b)+Vₐ·V_{b})/(√(w_{c}+Σ_{ieU}aff(i,a)²)·√(w_{c}+Σ_{ieU}aff(i,b)²))

where Vₐ·V_{b} is the usual vector dot product.

The denominator of the above expression is merely a scaling factor; it has the same (scaling) effect on both w_{c}·simᵣ(a, b) and Vₐ·V_{b}. The contribution of content-based similarity (the first expression) to the numerator is fixed, and has a maximum value of w_{c} and a minimum value of zero. In contrast, the contribution of affinity-based similarity (the vector dot) product is unbounded, and grows as the number of known (typically non-zero) affinities grows. Thus the contribution of content-based similarity decreases as affinity evidence accrues. The Weight we can be tuned to adjust the rate at which affinity-based similarity dominates content-based similarity.

The overall similarity above can be used to extend user- or item-based CF to account for content-based data as well as affinity data. Such an extended-CF algorithm would use the similarity function to compute user or item similarities.

The recommendations for directing data content to particular users are essentially a single mathematical expression that is computed for every pair of items in the set of available items. The pseudocode would be,

for i in I indexing the set of items, loop

for j in I indexing the set of items, loop

if i = j, then

set the similarity to one

else

compute the similarity

end if

end loop

end loop

There is no single old way of defining item similarity. However, the common difference is that other similarity functions incorporating content-based variables give constant relative Weight to those variables' contribution and to the contribution of affinities. The approach described herein weighs affinity contribution according to the quantity of known affinities, so that more affinity evidence gets more Weight.

The advantage is that estimates based on more evidence tend to be more accurate than estimates based on less evidence. The similarity function combines two estimates (content-based similarity and affinity-based similarity), weighing each according to the quantity of evidence supporting it.

This disclosure illustrates and explains a method of solving the cold-start problem for collaborative filtering (CF) recommendation engines. The cold-start problem occurs when the CF engine is required to produce a recommendation for a given end user, and either lacks sufficient data describing that end user's preferences, or lacks sufficient data describing other end users' preferences, to compute the recommendation. A cold-start problem similarly occurs when a new item is added.

There are many approaches to the cold-start problem. Some involve combining content-based recommendation and CF in a single (hybrid) model. Others involve combining user- and item-based CF in a single (hybrid) model.

The disclosure of the embodiments of the system herein generally encompasses the following:

(i) Elicit where possible an expressed affinity, such as a “social state of mind” data point.

(ii) Absent an expressed affinity, gather behavioral evidence of a user's preference for an item; and compute affinity from the behavioral evidence.

(iii) Use available empirical affinities as the basis for item-based CF to infer affinities for items lacking empirical affinities, where sufficient empirical affinities exist.

(iii) Otherwise, use available empirical affinities as the basis for user-based CF to infer affinities for items lacking empirical affinities, where sufficient empirical affinities exist.

(iv) Otherwise, use global averages.

(v) If a user sets a “social state of mind” value, then use that value to advance the user to a known set of recommendations according to the social state of mind.

The implementation of these steps in a real computerized network generally follows the following algorithm implemented via a recommendations software module hosted on a computer running a social network:
1. Before run time,
   a. Collect all available expressed affinities.
   b. Compute affinities from behavioral data, where expressed affinities do not exist and sufficient behavioral data is available.
   c. Compute the item-based CF model, extending it to account for content variables.
   d. Compute the user-based CF model, extending it to account for sociodemographic variables.
   e. Compute global averages.
   f. Merge the results into a single set of (user, affinity) ordered pairs, where the affinity in the ordered pair is computed according to the rules in 7.a above.
2. At run time, when a recommendation request arrives, use the ordered pairs to induce an overall recommendation ranking for items matching the request's criteria (possibly, for example, text-search terms).

One implementation does the following:
1. Before run time, a nightly batch process implemented in Java does the following:
   a. Load all available expressed affinities, behavioral data, firmographic variables, and sociodemographic variables into a set of PostgreSQL database tables.
   b. Compute affinities from behavioral data, where expressed affinities do not exist and sufficient behavioral data is available.
   c. Load the resulting empirical affinities, as well as the firmographic and sociodenographic data, and a list of known Users, into Mahout item-based and user-based CF model objects.
   d. Compute the item-based CF model, extending it to account for content variables.
   e. Compute the user-based CF model, extending it to account for sociodemographic variables.
   f. Compute global averages.
   g. Merge the results into a single set of (user affinity) ordered pairs. Global averages have a user ID of −1; real users have positive user IDs.

In addition to doing large, infrequent batches, some approaches may also include incremental updates which bring new users or new items closer towards the thresholds of CF in a shorter amount of time. This gives an advantage towards the cold start problem which is part of the innovation of using multiple recommenders, and further benefits from the hybrid approach to these CF models, and the configuration which specifies which segment of users and items are most accurately predicted by each of the different recommender engines.

The general approach for these incremental updates may be as follows:

1. The batches are run as described above.
2. In addition to the batches, for each predictor in the system a pipeline may be defined. The pipeline is responsible for handling incremental updates of its predicted models. The calculation of incremental updates are analogous or identical to the calculations used during batches, except that the number of users and items flagged between incremental updates will be much less than between batches. The system can't change its recommendations until its predictions are updated (incrementally or by batch) which means incremental updates make the global averages more dynamic to short-term information, helping new users and items move out of the global average recommendations and into the personalized domain of CF recommendation as soon as possible. This benefit would be most apparent when a large number of new users or new items is added at the same time—such as when new cities of users are added, or new markets of destinations are added within an existing city.
3. The pipelines which execute incremental updates are responsible for one or more predictive models. In one example, a pipeline may exist for each of the ways a kind of user can be related to a kind of item (e.g. a pipeline for “recommending advertisements to individual users” may be separated from a pipeline for “recommending destinations to individual users” which may be separate from another pipeline for “recommending destinations to groups of users”.)
4. Pipelines may be broken up into stages, an example being the three stages for a CF pipeline: update computed affinity, then similarity, then predicted affinity. (Affinity is a user's tendency to choose an item over other items—the click-rates described for advertisements are the affinity of users for advertisements; the rate of deals claimed by a user gives the affinity of that user for those deals.)
5. Each stage in a pipeline may be implemented as a work queue, which accepts the results of previous stages as well as work enqueued by requests from the application layer. For example, the user similarity stage in a user-destination pipeline may enqueue work from the application-layer whenever a user changes their profile—but this same stage also enqueues work as it is completed when the previous stage in the same pipeline finishes updating the computed affinity.
6. The work queues within a pipeline can be configured in a way which prioritizes time-sensitive item types (advertisements, deals) relative other, less time-sensitive item types (destinations). This configuration is described below.
7. The length of each stage's work queue may be configured using a set of triggers, which are thrown if certain conditions become true regarding the amount of unprocessed work accumulated by the stage's queue. One example trigger may be a minimum amount of queued work before the stage executes; another example may be a minimum duration of time the stage waits between consecutive updates. The affinity stage, being a fast calculation and early in most example pipelines, may be implemented without a trigger (meaning work is processed immediately as requested, and the queue acts as a buffer while work is in progress.) Each trigger condition may be considered a sufficient condition to execute a stage, meaning the stage executes as soon as the condition is reached (regardless of the other conditions) The progress towards other triggers may be reset when the stage begins a new run. Different stages in a pipeline would have different triggers, which attempt to guide the expected queue length into whatever ratio is most stable (relative the expected service times) according to whichever queuing theory model is appropriate to the particular we case.
8. The affinity calculation is inherently parallelizable—one user-item pair's affinity does not affect how any other pair is calculated. The incremental update for similarity may use a less expensive model than what is used during batch updates—this would be done to keep the pipeline as distributable as possible. The degree of distribution and paralletization between pipelines is aligned with the claimed business objective—to engage and impress new users with more dynamic suggestions when they're getting their first impression of the system; and to minimize the consequences of the cold start problem for inherently short-lived items (like advertisements and deals.)
9. The incremental updates may only enqueue work which is related to a “new” user or item—meaning users and items which are modeled by global average recommendation, because they don't match the N affinities or K neighbors necessary to use CF rather than the global averages. If this is the case, the pipeline triggers would be based on whether a user or item is likely to have exceeded these thresholds. The goal is to run the pipeline in order to find users/items who have “deviated from the pack” as soon as possible, so that new users and items spend the least amount of time using global averages before the system starts personalizing the recommendations.
10. A user (as described here) includes “anything which can request recommended items” while an item includes “anything which can be recommended to users.” For example:
11. The approach described above applies regardless what kind of item is being recommended to which kind of user—the approach is generalizable and independent of the internal details of the component models (e.g. user similarity) and how these calculations might vary depending on the different analogous kinds of user (e.g. individual users, versus groups of users) or different kinds of analogous item (e.g. destinations, advertisements, deals, or events.)
12. All kinds of users and all kinds of items (as described above) can extend the innovative recommender aspects described elsewhere in this invention: (the combination of three recommender engines in a way which innovates existing approaches to the cold start problem, the configurable Weighting of keyword searching versus the models known by CF recommendation, the increasing Weight of behavioral data over time, the interpretation and synthesis of social media behaviors as indicators of affinity/similarity in the context of a CF engine, etc.)

At run time, a recommendation request arrives from a user to the application layer, which requests the recommendations from an API used to expose appropriate endpoints (for each use case, different embodiments of the same invention can be built separately and exposed through the same API by different endpoints). These different use cases impose different assumptions—e.g. one endpoint may be able to ignore content-based similarities, while another may be able to ignore the possibility of keywords—which facilitates diverse use cases by specializing different systems to what they do best (e.g. text search would have superior performance when backed by a document store, but document stores are less ideal for endpoints that require complex relational queries—the result of the RE models don't care how they're queried, which means these values can be partitioned/indexed based on the use case, and stored in different datastores based on the different assumptions inherent to different recommendation request endpoints.)

One example may do the following:
1. Receive a network ID and a set of search terms from the web site's application code.
2. If the input network ID is new, query the database for items matching the search terms, sorting the matching items according to a combination of the affinities for user ID−1 and the strength of text match
3. Otherwise, query the database similarly for the input user ID.

In another embodiment of the Weighted data process selection for a recommendations engine includes a method of combining text search and peer recommendation (collaborative filtering, or “CF”) in a single recommendation engine. The computer implemented algorithm of this disclosure includes four possibilities:
1. If the end user provides no search teams, use (item- or user-based) CF only.
2. Otherwise, goodness of text match (for example, the fraction of search terms matched by a given item) and strength of peer recommendations (as computed by CF) are each normalized onto the same numerical scale. The method combines these normalized values according to the value of an input Weight having a value between zero and one.
   a. If the Weight is zero, the items are ranked by strength of text match, using strength of peer recommendation only as a tie breaker. (That is, the ordering is lexicographic, with strength of text match first.)
   b. If the Weight is one, the items are ranked by strength of peer recommendation, using strength of text match only as a tie breaker. (That is, the ordering is lexicographic, with strength of peer recommendation first.)
   c. Otherwise, the two normalized values are combined in a Weighted sum, with the input Weight Weighting the peer recommendation, and one minus the input Weight Weighting the text match; and the items are ranked according to the value of the Weighted sum. In symbols, if the Weight is w, the strength of text match is t, and the strength of peer recommendation is p, the Weighted sum is wp+(1−w)t.

In principle, the end user of a search application or web site could choose the value of the Weight in a way that reflects the end user's preferences for a particular search (perhaps by employing a slider control such as an HTML5 range input). For example, a particular user in a particular instance might submit the search terms ‘Chinese fast food’. That user might care much more about finding a Chinese fast-food restaurant (regardless of how popular it is) than finding a popular Chinese laundry. Such a user in such an instance could set the Weight's value to zero. Another user submitting the same search terms might want to see popular Chinese restaurants first, at the risk of including some that are not fast-food restaurants, and so might submit a Weight of one-half.

Current peer-recommendation systems that support text search (such as the Amazon.com web sites text-search feature) do not give the end user a way to indicate how much to emphasize goodness of text match vs. how much to emphasize strength of peer recommendation. The present invention does so, and in a way that is agnostic regarding the type of CF and text-search algorithms employed.

The current state of technology is simply to combine text search and collaborative filtering with no flexibility in the way the search algorithm Weights goodness of text search and strength of peer recommendation. In the system described herein, a more flexible approach to data processing is possible. For example, the system of this disclosure may implement the following:

### DEFINITIONS

S a set of search terms
Tᵢ the set of terms describing item i
m(S, Tᵢ) a normalized measure of the strength of match between terms in S and Tᵢ
cf(Tᵢ) a similarly normalized measure of the strength of peer recommendation of item i
w aWeight in [0, 1]

### Rules:

1. If S is empty, use the order induced by cf(Tᵢ).
2. Otherwise, limit results to items for which m(S, Tᵢ)>0; and
   a. if w=0, use lexicographic ordering on (m(S, Tᵢ), cf(T)).
   b. if w=1, use lexicographic ordering on (cf(Tᵢ), m(S, Tᵢ)).
   c. if 0<w<1, use the order induced by w·cf(Tᵢ)+(1−w)·m(S, Tᵢ).
1. The algorithm computes cf(Tᵢ) for each item.
2. The end user inputs a (possibly empty) set of search terms and selects a value for the input Weight.
3. The algorithm applies the rules outlined in section 7.A above. In particular, if S is non-empty, the algorithm computes m(S, Tᵢ) for all items, before applying the appropriate rule.

The implementation does the following:
1. Employ a hybrid user- and item-based CF model implemented in Mahout to compute cf(Tᵢ) for each item nightly.
2. Provide a PL/pgSQL function that receives S and w inputs in real time, and that returns an open cursor for an SQL query satisfying the rules in section 7.a above.
3. Employ the PostgreSQL database's text-search functionality to compute m(S, Tᵢ) in real time, while executing the query.
4. Implement the rules in section 7.a above as order-by constraints in the SQL query.

The function m(S,T) is generally any relevance function which is efficiently computable in whatever datastore is being used to index items subject to keyword search, including document stores, columnar stores, and relational databases. The more relevant an item's recorded keywords are to the keywords a user actually searches in their query, the higher the match. The example Postgres implementation given above would be appropriate for a use case where keywords are chosen from a pre-defined list of options.

In other example use cases, users may eater arbitrary keywords freely without a predefined list of search terms. The arbitrary nature of free-text search terms raises issues ill-suited to a relational store like Postgres, so this use case would be best handled by a document store specialized for free-text search (e.g. Solr, Lucene, Elasticsearch.). In one embodiment, extending the system by indexing these items by items per city (or per neighborhood of user) allows a user to access both the associated keywords and also the predicted affinities at the time of search. The document stores mentioned here have features for stemming, tokenization, and the “match” function can be based on semantic keyword comparison while the user-specific affinity can be used as an additive or multiplicative boosting factor.

The arbitrary nature of free-text keyword terms makes it a riskier approach to search than a constrained list of search terms—but it's generally more natural for users than a catalog of keywords and requires less curation by administrators, as long as the system can handle the interpretation quickly and scalably. The least obvious issue is interpretation, which is a non-trivial risk due to two complementary, non-trivial risk factors: polysemy and synonymy.

If one searches for “Italian food”, how relevant are these three items: one tagged “Italian cuisine”, another tagged “Italian movie”, and a third tagged “Mexican food?” All three items match 50% of my search terms, but obviously the one wanted is “Italian cuisine”.

The problem with the words “cuisine” and “food” is synonymy; the problem with the word Italian is polysemy.

Polysemy—how do Users point a single keyword “Italian” to different Items (based on the different meanings of the word Italian?)

The terms which appear around the word “Italian” change the user's intended meaning of the term “Italian.” The match needs to account for this. One approach is to include metadata alongside ambiguous keywords like “Italian”—a categorical label such as: Italian:restaurant, Italian:food. This metadata gives the information needed to solve for polysemy due to the term “Italian”, because the match can account for matches by category, not just by tag.

Users can do even better than this, if Users also add a way to handle the synonymy between “cuisine” and “food” (which shouldn't be counted as different meanings, even though they're different words.)

Synonymy—how do Users match a dance studio tagged “dancing” if the user searches for “dance”?

Using the document store's inherent advantages, such as stemming & fuzzy matching (e.g. “dances” looks like a verb, and the stem “dance” matches “dance” exactly. Fuzzy matching may be used to planning stemming: “dancing” looks like the gerundive of stem “danc**” which fuzzily matches the word “dance”.)

Using synonym files (matches words based on an inexpensive thesaurus lookup, based on an assembled corpus of commonly-observed search terms.)

Contextual comparison (do “dance” and “dancing” co-occur along with similar, unusual words—like “studio”—in a reference corpus of search terms?)

Semantic scoring functions (e.g. compression distance.)

Again, the word “item” means “anything which can be recommended to a user”—but in terms of search, an “item” also means anything associated with keywords for the purposes of user search.

Overall, text search provides a way for a user to search for an item satisfying a short-term preference. (For example, a user might want Chinese fast food tonight, but not every night.) Peer recommendation (CF) provides a user a way to search for an item satisfying long-term preferences. (For example, a user might prefer inexpensive Chinese fast-food restaurants over expensive sit-down Chinese restaurants.) The present invention gives an end user a way to indicate, case by case, the relative importance of their short- and long-term preferences.

The following Appendices to this disclosure illustrate the programming and technical specifications for an example social network that utilizes the Weighting of data processing techniques described above. The system is characterized in part by the use of Weights, often represented by the variable “w”, that are used to determine which kind of data processing recommendations engine predominates among various recommender engines (RE). The value for “w” may be pre-programmed into the ongoing software for calculation purposes; the value for “w” may me input by a user to control the kinds of data manipulation and the relative importance of the techniques in determining recommendations that a user receives, or the value for “w” may be programmed to change at data availability changes. For example, once an item, a user, a business or other entity reaches a threshold level of data quantity, the value of “w” may be varied automatically by the software to move the scale so that one kind of search, such as content searching, predominates over the other (e.g., collaborative filtering).

For example, in an advertisement recommender model, the system generates user-specific rankings of ads to be shown to user users based on known click rates on similar advertisements and/or predicted click rates based on dick rates of similar user users. When the system requests a ranking of candidate ads for a given location on the site for a specified user user, the model returns a sorting based on the overall ad ranking for that user.

The model is in reality three independent recommender models. The model used to predict unknown click rates for a given user depends on the amount of known user click data that is available and how recently the user registered on the site:
The primary model is the item-base collaborative filtering model described above. This model is used when a user has recorded clicks on at least N different advertisements (N is a configurable parameter).
The secondary model is the user-based collaborative filtering model described above. For a User with recorded clicks on less than N advertisements, the user-based recommender is used to predict unknown click rates. This addresses system and user-specific “cold starts” in which new users do not have enough recorded impressions and clicks to generate meaningful commendations using the primary model.
A third global average model, described in Section 4, is used only in the case of new users that have registered on the site since the last batch collaborative filtering run and therefore will not receive user-specific predictions until the next batch run of the algorithm.
A fourth parameter is a “social state of mind” value that allows a user to expressly state a desire to receive specialized advertisement content.
   Note that parameter N is distinct from the identically named parameter in the Destination recommender.
   The final section of this document describes how predicted/known click rates are used to determine recommendations in real time.
   One key difference to note between the Advertisement and Destination recommenders is in how User city is used. For the Destination recommeder, each User city is treated effectively as an independent model. This is feasible since the large majority of User-Destination interactions are anticipated to occur between Users and Destinations in the same social city. In contrast, Advertisements need not be geographically limited. Thus the Advertisement model does not explicitly partition the model. However, the computational demands of the user-based recommender described above may require such a partitioning to be implemented when the site-wide number of users becomes large enough.

### 1.1 Use Cases

The key use case for the Ad recommender is as follows:
1. User logs in and visits page on s Site provides list of feasible ad vendors for specified location on page. Recommender model ranks feasible ads by known/predicted click rate.

### 1.2 Model Objectives

1. Maximize click rates on site ads.

### 2. Item-based Recommender

### 2.1 Model Overview

The primary recommender model is a hybrid item-based collaborative filtering model. Unknown ad click rates for a given User are predicted based on known click rates for similar ads. In a pure hybrid collaborative filtering implementation, the pairwise item (Advertisement) similarity would be computed based on the similarity of known click rates between two ads across all Users. The hybrid model described in this section augments this similarity with an indicator of whether the ads have been placed by the same advertiser—ads from the same advertiser are given a higher similarity than those from different advertisers. The relative importance of click rate similarity versus common advertiser can be adjusted through a configurable parameter.

The item-based recommender requires a certain density of recorded clicks for a User in order to be effective. Thus the item-based recommender model is only used when the User has known positive click rates for at least N advertisements, where N is a configurable model parameter.

Advertisements will have a start and end date and are considered active between those two dates. The item-based recommender model will generate predicted click rates for active advertisements for each User that has not been shown the ad. Unknown click rates for inactive ads do not need to be predicted; however, known click rates inactive ads can be used to predict click rates for active ads. For each User, the predicted and known click rates are used to generate a user-specific ranking of active ads.

### 2.2 Model Description

The item-based recommender model generates predicted click rates for all active advertisements for each User with recorded clicks on at least N ads (active or inactive). An advertisement is active if the current date is between the ad's start and end date, inclusive. Click rates are normalized based on ad location, so a common ranking can be used for each location on the site.

The model assumes Users have the following data for each site advertisement:
Advertisement ID (AID)
Start/end dates: used to determine whether ad is active or inactive.
Overall budget for the Advertisement and Maximum bid for price per impression or click.
Location ID (LID): site location that this particular ad. A single ad may be associated with multiple location IDs (e.g., if multiple locations of the same size exist on the site then a single ad may be eligible for multiple locations).
Advertising Business ID (BID): this allows the model to link multiple ads from the same advertiser either across a campaign offering ads on multiple locations in the site or across historical campaigns (or both).
History of ad impressions for each User of each (AID,LID) pair. An impression occurs when ad AID has been displayed in location LID while User is on the Hopspot site.
History of clicks for each User of each (AID,LID) pair.

The item-based recommender is composed of three sub-models:
1. The click rate model computes known click rates for each user. A click rate is computed for each advertisement for which the user has at least one impression. The click rates are normalized across advertisement location based on overall location click rates, which allows for a single click rate for advertisements that may appear in multiple locations and a single ranking of advertisements for the USER independent of location.
2. The Advertisement similarity model computes a similarity metric as a function of known click rates and whether the advertising business is the same for two different advertisements.
3. The collaborative filtering model proper uses the Advertisement similarities to generate predicted click rates for each USER-Advertisement pair in which the USER has not had an impression of the Advertisement.

The collaborative filtering model will be run as a batch job with the frequency of the batch update set as a parameter (likely 1-4 times daily in production). The outputs from the models flow downward—the similarity model uses the computed click rates, and the collaborative filtering model uses the click rates and similarities. Inactive Advertisements will not be recording new impressions or clicks. Thus click rates only need to be updated between batch runs for active Advertisements, and similarities only need to be computed for Advertisement pairs in which at least one Advertisement is active.

Click rates are only recomputed for User and Advertisement pairs in which there has been an impression since the last batch update. There may be an opportunity to update click rates more frequently between batch updates in order to reduce processing time of the batch updates. In theory, similarities could also be computed more frequently between collaborative filtering batches. However, new impressions for at least one User are likely to be recorded with high frequency for any active Advertisement, and thus there may be little benefit to such an approach. It will likely be more efficient to run all three models sequentially with each batch.

### Implementation Note

Some Advertisements may specifically target users by sociodemographic, geographic, or other variables with the explicit direction that the Advertisement not be shown to users outside of the defined target group. In a future phase, Users may be able to read in those constraints and compute predicted click rates only for those Advertisements for which a given user is eligible. This is outside the scope of the initial implementation, however. Users will assume that any such filtering is done by the system during the call to the recommender.

### 2.2.1 Component Model Specifications

### 2.2.1.1 Click Rates

The click rate for a given advertisement is the key metric that is being estimated. Click rate is typically computed as simply the ratio of clicks to impressions for a given ad. The Advertisement recommender instead uses a normalized click rate that is scaled based on the overall click rate for a given ad location. This allows impressions and clicks on a single ad across multiple locations to be aggregated into a single click rate, and it allows comparison of click rates across ads regardless of location.

Most click rates will not change between consecutive batch runs. Thus known click rates can be stored between batches and updated only as required. Click rates for inactive ads (Advertisements for which the current date falls outside of the start and end date) do not need to be updated. For active ads, a user-ad pair should be flagged for update if either of the following events occurs:

An impression of ad is recorded for user

User clicks on ad.

Click rates must be updated before each collaborative filtering batch run. There may be efficiency gains to updating click rates at a higher frequency between batch runs.

### Model Formulation

Define configurable parameter nₘᵢₙ as the minimum number of impressions that must be recorded for a given (user, ad) pair in order for the click rate to be computed (rather than inferred). For a User, advertisement, location triple (user (denoted ST), ad identifier (denoted AID), location identifier (denoted LID)), define the following impression and click variables:
I_{ST,AID,LID}=count of Impressions for ST of AID at LID
C_{ST,AID,LID}=count of clicks by ST of AID at LID

The overall click rate for a Location LID is then computed as:

$${rate}_{loc} ( LID ) = \frac{{Σ}_{ST , AID} {C}_{ST , AID , LID}}{{Σ}_{ST , AID} {I}_{ST , AID , LID}} .$$

The absolute and normalized click rates for a given ad AID by User at location LID are, respectively

$$rate ( ST , AID , LID ) = \frac{{C}_{ST , AID , LID}}{{I}_{ST , AID , LID}}$$

$$\overline{rate} ( ST , AID , LID ) = \frac{rate ( ST , AID , LID )}{{rate}_{loc} ( LID )} .$$

If there have been no impressions for a given (ST,AID,LID) triple then both values are set to 0. The normalized click rate scales the absolute click rate by the overall location click rate to enable comparisons to be made across different locations.

If a ST has recorded zero clicks on ad AID and has had fewer than nₘᵢₙ impressions of AID then the normalized click rate for that (ST,AID) is set to null to indicate that it needs to be predicted by the collaborative filtering model. Otherwise, the normalized rate is set equal to a Weighted sum of the adjusted click rates across locations with the number of impressions as the Weighting factor:

$$\overline{rate} ( ST , AID ) = \frac{{Σ}_{LID} ( {I}_{ST , AID , LID} * \overline{rate} ( ST , AID , LID ) )}{{Σ}_{LID} {I}_{ST , AID , LID}} .$$

### 2.2.1.2 Advertisement Similarity Model

The Advertisement similarity model is a modified cosine similarity metric across the normalized (ST,AID) click rates that includes a component that increases similarity when the advertising business matches between two advertisements. The Weight placed on this parameter is configurable.

Similarities are required for all pairs of Advertisements in which at least one Advertisement is active (ad start date≦current date≦ad end date). Similarities must be updated for each (AID1,AID2) pair in which an impression or click has been recorded for either ad. The rate of impressions is likely to be high enough that all active advertisements receive impressions between batch runs. Therefore, it is likely that similarities need to be recomputed for every ad pair with an active ad prior to every batch run. However, the number of active Advertisements is likely to be low enough that this does not present a significant computing challenge.

### Model Formulation

Define configurable parameter:
W_{BID}: Weight in interval [0,1] assigned to a business ID match in computing similarities. Implies a (1−W_{BID}) Weight on click rate similarity.
   For each advertisement AID, define rating vector R_{AID} as the vector of adjusted click rates r̅a̅t̅e̅(ST, AID) for each User with null values set to zero. Also define vector dot-product

$${R}_{{AID}_{1}} \cdot {R}_{{AID}_{2}} = {\sum }_{ST}^{ } ( \overline{rate} ( ST , {AID}_{1} ) * \overline{rate} ( ST , {AID}_{2} ) )$$

and vector magnitude

$$‖ {R}_{AID} ‖ = \sqrt{{\sum }_{ST} ( {\overline{rate} ( ST , AID )}^{2} )} .$$

Indicator function x_{BID}(AID₁,AID₂) is equal to 1 if AID1 and AID2 have the same advertising business and zero otherwise. Then the similarity of AID1 and AID2 is defined as:

$$sim ( {AID}_{1} , {AID}_{2} ) = {W}_{BID} {x}_{BID} ( {AID}_{1} , {AID}_{2} ) + ( 1 - {W}_{BID} ) \frac{{R}_{{AID}_{1}} \cdot {R}_{{AID}_{2}}}{‖ {R}_{{AID}_{1}} ‖ ‖ {R}_{{AID}_{2}} ‖} .$$

### Implementation Notes

Similarities need only be recomputed for (AID1,AID2) pairs in which at least one of the advertisements has new normalized click rates for at least one user since the last batch update. It is not necessary to compute similarities for (AID1,AID2) pairs for which both ads are no longer active (i.e., current date is outside of the ad start date and end date, inclusive).

Similarities are computed independently for each pair. Thus the computation can be distributed.

Similarities are symmetric—that is, sim(AID₁, AID₂)=sim(AID₂, AID₁). There is therefore no need to compute the similarities for both (AID₁,AID₂) and (AID₂,AID₁) as long as both similarities are updated when one is computed.

### 2.2.1.3 Item-Based Filtering Model

The item-based filtering model nm as a batch job—frequency will likely be 1-4 runs daily. The model applies a simple k-nearest neighbor model (with configurable parameter k) to the Advertisement similarities and known (ST,AID) click rates to predict all unknown (ST,AID) click rates. Because similarities are likely to change between each batch run, all unknown click rates for active Advertisements will need to be recomputed during each batch,

Model Formulation

For each (ST,AID) pair with unknown click rate and where AID is active, define the set n_{ST}(AID) to be the k Advertisements AID′ (active or inactive) with highest similarity to AID for which r̅a̅t̅e̅(ST, AID′) is known. Then the unknown (ST,AID) click rate is computed as: (000223)

$$\overline{rate} ( ST , AID ) = \frac{{Σ}_{{AID}^{′} ε {n}_{ST} ( AID )} ( {sim ( AID , {AID}^{′} )}^{m} \cdot aff ( ST , {AID}^{′} ) )}{{Σ}_{{AID}^{′} ε {n}_{ST} ( AID )} ( {sim ( AID , {AID}^{′} )}^{m} )} .$$

Known click rates for Advertisements most similar to AID are given the greatest Weight in the prediction. Configurable parameter m changes the relative Weighting—higher values of m lead to a greater difference in relative Weighting for the same difference in similarity.

Implementation Notes

Click rates need only be predicted for active Advertisements.

The batch job can be parallelized by distributing the unknown (ST,AID) affinities across machines for independent computation.

The output of the collaborative filtering submodel is a list of known or predicted click rates for every (ST,AID) pair where AID is active.

User-Based Recommender (User Cold Start)

Model Overview

The primary item-based model requires a sufficient number of known (user, ad) click rates for a given User in order to predict click rates for that User on other Advertisements. For a newly registered User or a User with limited recorded activity, the model will not perform well. This is known as the user cold start problem.

When a User has recorded clicks on fewer than N Advertisements, the User's unknown click rates will be predicted using a hybrid user-based collaborative filtering model. User-based collaborative filtering transposes item-based filtering. Instead of predicting click rates based on a User's known click rates on similar Advertisements, user-based filtering predicts click rates based on observed click rates of similar Users for the same Advertisement. Hybrid user-based collaborative filtering uses both sociodemogphic variables and known click rates to compute similarity.

The user-based model is complementary to the item-based model. Both generate predicted click rates for (user, ad) pairs with no known impressions, but they do so for two different sets of Users.

Implementation Note

Some Advertisements may specifically target users (denoted STs) by sociodemographic, geographic, or other variables with the explicit direction that the Advertisement not be shown to users outside of the defined target group. In a future phase, developers may be able to read in those constraints and compute predicted click rates only for those Advertisements for which a given user is eligible.

Model Description

The user-based recommender model predicts click rates for every (ST,AID) pair in which ad AID is active, ST has not yet had an impression of AID, and the total number of Advertisements that ST has clicked on is less than N.

The model is a hybrid user-based collaborative filtering model. It is composed of 3 sub-models:

The click rate model computes known click rates for each user. This model is the same as the click rate model for the item-based recommender.

The User similarity model computes a similarity metric as a function of sociodemographic and user preference variables and known (ST,AID) click rates.

The collaborative filtering model proper uses the User similarities to generate predicted click rates for each (ST,AID) pair in which the ST has not had an impression of the Advertisement.

The required input data for the user-based recommender includes all inputs for the item-based model except the advertising business. In addition, ST sociodemographic and preference variables are required. These variables are specified in the user similarity model description.

The model flow is the same as for the item-based recommender. The key difference between the models is that the user-based recommender uses User similarity instead of Advertiser similarity. As in the case of the item-based recommender, the user-based model is updated in batches approximately 1-4 times per day. The click rate and user similarity component models can be updated more frequently between batches to reduce the peak loads during batch processing.

One key difference between the item-based and user-based recommenders is that, whereas the Advertisements similarity model in the item-based recommender computes similarities for a relative small number of active Advertisements, the number of user pairs that must be evaluated in the user-based User similarity model is significant.

Component Model Specifications

Click Rates

The click rate model for the user-based recommender is identical to the click rate model for the item-based recommender. The two models can in fact be run as a single model, and the computed click rates do not need to be segregated until they are input into the appropriate similarity and filtering sub-models. Refer to Section 2.2.1.1 for a complete description of the click rate model.

Model Formulation

User Similarity Model

The User similarity model generates pairwise similarities between Users. Similarity is computed as a modified cosine similarity between the extended sociodemographic and click rate vectors of the Users. The model is constructed in such a way that as the number of known click rates increases for a User, the relative Weight of click rate similarity naturally increases compared to sociodemographic similarity in the overall similarity computation.

The model is very similar to the User similarity model for the Destination recommender. The primary difference is in the use of click rates in place of ST-Destination affinities.

The user-based filtering model requires that similarities be computed for all (ST1,ST2) pairs in which at least one of ST1 or ST2 does not meet the threshold requirement for the item-based recommender. Many user similarities are likely to remain unchanged between consecutive batch runs of the filtering model. Therefore, the similarities can be stored between batch runs and be computed/recomputed only as required. A user should be flagged as needing to have its similarities updated if any of the following occur:

The user is new to the social media system (i.e., does not have any similarities).

The relevant user profile information has been updated either by the user or the system.

The user has recorded at least one new impression or click for any Advertisement.

When a user is flagged, the similarities between that user, ST, and all other STs must be recomputed (see implementation note below for discussion). Similarities are symmetric, meaning that sim(ST₁, ST₂)=sim(ST₂, ST₁). Thus it is important that recomputed similarities be updated for both pair orderings if they are stored separately.

There may be an opportunity to make more efficient use of computing resources by updating similarities for flagged users in more frequent batches than the frequency of the user-based collaborative filtering sub-model. The update frequency should be no more frequent than the click rate update frequency and no less frequent than the collaborative filtering batch frequency.

The logic below describes the algorithm for computing similarity for a single pair of users.

Model Formulation

The similarity between two Users, ST1 and ST2, is computed as a cosine-like similarity function over a set of pure cosine similarity sub-functions. The similarity is a real number on the interval [−1,1] with a higher value indicating greater similarity.

The model first computes a sociodemographic similarity between ST1 and ST2. The input sociodemographic dimensions are:

Demographics:

Age (normalized onto [−1,1] interval; unknown age set to median)

Gender (1=M, −1=F, 0=unknown)

Interests: A user can select multiple “interest tags” such as Live Music, Craft Beer, Electronic Dance Music, Chill Nights Out, Local Art.

Favorite Destinations

The interest dimensions are concatenated into a single list for each ST. The sociodemographic similarity between ST1 and ST2 is then computed as:

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} \cdot \sqrt{{W}_{a} + {W}_{g} + \vert {ST}_{2} interests \vert}} .$$

where a_{ST} and g_{ST} are the age (normalized) and gender, respectively, of User. Wₐ and W_{g} are configurable Weights controlling the relative contribution of the age and gender dimensions, respectively, to the overall User similarity.

The final User similarity measure is a function of the sociodemographic similarities defined above and the known click rates of each User. Define V_{ST} to be the vector of (ST,AID) click rates across all Advertisements AID. If the click rate for a given (ST,AID) pair is null (i.e., unknown) then the corresponding element of the vector is set to zero. Then the User similarity between ST1 and ST2 is defined as:

$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\begin{matrix}\sqrt{{W}_{sd} + {\sum }_{AID} ( {\overline{rate} ( {ST}_{1} , AID )}^{2} )} * \\ \sqrt{{W}_{sd} + {\sum }_{AID} ( {\overline{rate} ( {ST}_{2} , AID )}^{2} )}\end{matrix}} .$$

The User similarity model naturally adjusts Weight toward the click rate component of the similarity as more click rates become known for either ST1 or ST2. Non-negative Weight W_{sd} is a configurable parameter that can adjust the rate at which the click rate similarity gains influence over the sociodemographic similarity. Higher values of W_{sd} put greater Weight on the sociodemographic similarity components, which means that a higher number of known click rates is required to reach a similar balance between sociodemographic and click-based similarity as for a lower value of W_{sd}.

Implementation Notes

For a flagged user, the similarity to each other user must be updated. Each pairwise similarity is computed independently. Whether similarity updates are performed continuously or in batches, computation for these pairwise similarities can be distributed (e.g., on a Hadoop infrastructure).

The similarities can be updated between collaborative filtering batch runs in order to reduce peak processing loads. Some user pair (ST1,ST2) similarities may be overwritten in that case if one of the users is again flagged before the next full-model batch update, and thus the tradeoff must be analyzed to determine whether more frequent updates truly improve computational performance.

Because many advertising campaigns are likely to be national or regional, user similarities should ideally be computed for all (ST1,ST2) user pairs, regardless of social city, in which at least one ST does not meet the threshold for the item-based recommender. The large number of Users across the site may make this impractical. One potential solution to this issue is to partition the user-based recommender by social city. The accuracy of the model is likely to decrease only marginally relative to the reduction in computational requirements. Alternative partitioning rules that cluster dynamically based on number of active users may also be worth investigating—for example, newly launched cities could be combined with one or more geographically or demographically similar cities until the number of users in the new city reaches a specified threshold.

User-Based Filtering Model

The user-based filtering model runs as a batch job. The frequency will likely be the same as for the item-based model. The user-based model is a transposition of the item-based model. It applies a simple k-nearest neighbor model to the User similarities and known (ST,AID) click rates to predict all unknown (ST,AID) click rates for Users that do not meet the click threshold for the item-based recommender. Many predicted click rates are likely to remain constant between consecutive batch runs; however efficiently identifying the predicted click rates that will remain constant is non-trivial. Thus each batch will update all unknown click rates.

Model Formulation

Define configurable parameter k (default value 50) as the neighborhood size. For each (ST,AID) pair with unknown click rate, define the set n_{AID}(ST) to be the k Users ST′ in with highest similarity to ST for which r̅a̅t̅e̅(ST′,AID) is known. If the number of known click rates for AID is less than k then n_{AID}(ST) will be the set of all Users ST for which r̅a̅t̅e̅(ST′, AID) is known. If no known click rates exist for AID then the predicted (STAID) click rate is set to zero. Otherwise, the cick rate is predicted as:

$$\overline{rate} ( ST , AID ) = \frac{{\sum }_{{ST}^{′} ∈ {n}_{AID} ( ST )} ( {sim ( ST , {ST}^{′} )}^{m} * \overline{rate} ( {ST}^{′} , AID ) )}{{\sum }_{{ST}^{′} ∈ {n}_{AID} ( ST )} ( {sim ( ST , {ST}^{′} )}^{m} )} .$$

Known click rates for Users most similar to ST are given the greatest Weight in the prediction. Configurable parameter m changes the relative Weighting—higher values of m lead to a greater difference in relative Weighting for the same difference in similarity.

Implementation Notes

The common parameters for user- and item-based models (k and m) may in fact have different values and should be initialized in the implementation as distinct parameters. Additionally, these parameters are distinct from the similar parameters in the Destination recommender.

This computationally expensive batch job can be parallelized by distributing the unknown (ST,AID) click rates across machines for independent computation.

Global Prediction (Unmodeled User)

When a new User registers for the site, no predicted click rates will be generated for that user until the next run of the collaborative filtering algorithms. The model still needs to be able to recommend advertisements for these users until user-specific recommendations become available. In this case, the model will use global normalized click rates across all users as a stand in.

The global click rates are computed similarly to the user-specific click rates described above. Define the total clicks and impressions for ad AID at location LID as, respectively:

$${C}_{AID , LID} = {\sum }_{ST} {C}_{ST , AID , LID}$$

$${I}_{AID , LID} = {\sum }_{ST} {I}_{ST , AID , LID}$$

The location click rate is defined as above:

$${rate}_{loc} ( LID ) = \frac{{\sum }_{ST , AID} {C}_{ST , AID , LID}}{{\sum }_{ST , AID} {I}_{ST , AID , LID}} = \frac{{\sum }_{AID} {C}_{AID , LID}}{{\sum }_{AID} {I}_{AID , LID}} .$$

The absolute and normalized click rates for a given ad AID at location LID are computed across all Users instead of individually for each User. They are, respectively:

$$rate ( AID , LID ) = \frac{{C}_{AID , LID}}{{I}_{AID , LID}}$$

$$\overline{rate} ( AID , LID ) = \frac{rate ( AID , LID )}{{rate}_{loc} ( LID )} .$$

The overall normalized click rate for AID is:

$$\overline{rate} ( AID ) = \frac{{\sum }_{LID} ( {I}_{AID , LID} * \overline{rate} ( AID , LID ) )}{{\sum }_{ST , LID} {I}_{AID , LID}} .$$

The predicted click rates r̅a̅t̅e̅(AID) are now independent of ST. Thus the predicted click rate need only be computed once for each AID during the overall recommender batch run and used to respond to system queries for which the User is unknown to the recommender.

This model is much less computationally intensive than the collaborative filtering models described above and could therefore be run with higher frequency update cycles than for the collaborative filtering models. However, given that global click rates are likely to change slowly over time, running once per day should be sufficient.

Implementation Note

In the similar case that an advertisement AID is unknown, the predicted click rate should be set to zero independent of user. No additional logic needs to be implemented for this case outside of the collaborative filtering model.

Real-Time Recommendations

The system will request recommendations from the model in real time by supplying a User, a location ID LID, and a list of feasible Advertisements (AID1, AID2, . . . ). The recommender will return the list of feasible Advertisements in sorted order based on the known/predicted click rates.

Because the click rate of the advertisement is normalized with respect to location, an overall ordering of active Advertisements can be maintained for each User, and new requests can use this sorted list. For each User, the active ads should be sorted in descending order by known/predicted click rate with ties broken by sorting in ascending order by number of impressions with further ties broken randomly. (Note that randomly is not equivalent to arbitrarily—the tie breaker must be random so that one advertisement is not consistently favored over another by an arbitrary rule). When the system calls for a recommendation based on a list of the feasible Advertisements, the recommender will use the overall stored ordering for the User to sort the list of feasible ads.

There may be business considerations for selecting advertisements that fall outside of the scope of the recommender. For example, new advertisements with no click data will not be ranked highly by the recommender until enough clicks have been recorded. There may therefore be a need to favor new advertisements in order to satisfy contractual requirements and build up click rate data that can be used by the recommender. This logic would need to be implemented outside of the recommender.

### Deal Recommendations

In another embodiment, a deal recommender model generates user-specific rankings of Deals to be shown to Users based on past acceptance of similar Deals and/or past acceptances of the Deals by similar users along known or inferred affinity for the Destination offering the deal based on the Destination recommender model outputs. When the system requests a ranking of candidate Deals for a specified User, the model returns a sorting based on the overall Deal ranking for that User.

The model is in reality three independent recommender models. The model used to predict acceptance likelihoods for a given User depends on the amount of known Deal acceptances by the User and how recently the User registered on the site:

The primary model is the item-based collaborative filtering model described above. This model is used when a User has previously accepted at least N different Deals (N is a configurable parameter used as a variable with a different meaning that the N used above for the advertisement recommendations engine).

The secondary model is the user-based collaborative filtering model described above. For a User with fewer than N accepted Deals, the user-based recommender is used to predict acceptance likelihoods. This addresses system ad user-specific “cold starts” in which new users do not have enough recorded Deal activity to generate meaningful recommendations using the primary model.

A third global average model, described in Section 4, is used only in the case of new users that have registered on the site since the last batch collaborative filtering run and therefore will not receive user-specific predictions until the next batch run of the algorithm.

Note that parameter N is distinct from the identically named parameter in the Destination and Advertisement recommenders.

### Appendix 2: The Deal Recommendation Engine

The Appendix 2 of this document describes how predicted acceptance likelihoods are combined with Destination affinities to compute Deal affinities and how these Deal affinities are used to determine recommendations in real time,

Use Cases

The uses cues for the Deal recommender align closely with those of the Destination recommender. The initial use case is as follows:

User searches for Deals using a set of keywords. Recommender model orders relevant search results based on a combination of keyword matching and known/inferred affinity. Top results are presented to user.

Future use cases may also be able to take advantage of the recommender model results:

User views newsfeed. Recommender model selects a Destination that User has not previously interacted with from among the Destinations with the highest predicted affinity. Selected Destination is advertised on User's newsfeed.

User views map. Recommender model selects Destinations with high known/predicted affinity within the viewed region.

Destination wants to target Users for a deal based on predicted affinities. Recommender model selects Users who have no recorded interactions with Destination but have a high predicted affinity for the Destination.

The model design allows for complete flexibility in how the predicted affinities are used within the site.

Model Objectives

Maximize acceptance of recommended Deals.

Maximize activations at offering Destinations after acceptance of recommended Deal.

Item-Based Recommender

Model Overview

The primary recommender model is a hybrid item-based collaborative filtering model. Deal acceptance likelihoods for a given User are predicted based on recorded acceptances among similar Deals. In a pure hybrid collaborative filtering implementation, the pairwise item (Deal) similarity would be computed based on the similarity of recorded acceptances between two Deals across all Users. The hybrid model described in this section augments this similarity with an indicator of whether the Deals are offered by the same Destination—Deals from the same Destination are given a higher similarity than those from different Destinations. The relative importance of acceptance similarity versus common offering Destination can be adjusted through a configurable parameter.

The item-based recommender requires a certain density of recorded Deal acceptances for a User in order to be effective. Thus the item-based recommender model is only used when the User has previously accepted at least N Deals, where N is a configurable model parameter.

Deals will have a start and end date and are considered active between those two dates. For a given User, the item-based recommender model will generate predicted relative acceptance likelihoods for each active Deal offered by a Destination in the User's social city. Acceptance likelihoods for inactive Deals do not need to be predicted; however, inactive Deals are used in the model to help predict acceptance likelihoods for active Deals.

Model Description

In each social city, the item-based recommender model generates relative likelihood of accepting each active Deal offered by a Destination in the city for each User in the city who has previously accepted N or more Deals (active or inactive). A Deal is active if the current date is between the ad's start and end date, inclusive.

The model assumes Users have the following data for each Deal:

Deal ID (D)

Start/end dates: used to determine whether Deal is active or inactive.

Offering Destination ID (DN): this allows the model to link multiple Deals from the same Destination in determining the relative acceptance likelihoods.

History of acceptances for each (user, deal) pair.

The item-based recommender is composed of three sub-models:

The Deal acceptance indicator uses past instances of Users accepting Deals to create a matrix of 0-1 indicators.

The Deal similarity model computes a similarity metric as a function of Deal acceptance indicators and whether the offering Destination is the same for two different Deals.

The collaborative filtering model proper uses the Deal similarities to generate relative acceptance likelihoods for each ST-Deal pair in a social city.

The collaborative filtering model will be ran as a batch job with the frequency of the batch update set as a parameter (likely 1-4 times daily in production). The outputs from the models flow downward—the similarity model uses the acceptance indicators, and the collaborative filtering model uses the acceptance indicators and similarities. Inactive Deals will not be recording new impressions or clicks. Thus similarities only need to be computed for Deal pairs in which at least one Deal is active.

Similarities can be computed with greater frequency than the collaborative filtering batch runs in order to reduce peak processing loads. The similarities only need to be recomputed when a new acceptance of a Deal has been recorded. The more frequent processing will mean that some computed similarities are overwritten before they are used by the collaborative filtering sub-model (i.e., if another acceptance occurs). This tradeoff between peak processing loads and unused computations will need to be evaluated to determine the most efficient frequency of similarity updates.

Implementation Note

Some Deals may specifically target STs by sociodemographic, geographic, or other variables with the explicit direction that the Deal not be offered to STs outside of the defined target group. In a future phase, Users may be able to read in those constraints and compute predicted acceptance likelihoods only for those Deals for which a given ST is eligible. This is outside the scope of the initial implementation, however.

Component Model Specifications

Deal Acceptance Indicator

Whereas the Destination and Advertiser models use computed affinities and click rates, respectively, the Deal recommender uses a simple indicator function. For User and Deal D offered by a Destination in the same social city, define:

$$I ( ST , D ) = \{ \begin{matrix}1 & if ST accepted D ; \\ 0 & otherwise\end{matrix} .$$

This indicator function is defined for both active and inactive Deals D. The inactive Deals are used to help predict acceptance likelihoods of active Deals. Inactive Deals “age out” of the process so that only more recent data is used in the prediction. Thus, I(ST, D) should be computed for each (ST,D) pair in the same social city where D is active or D is inactive with end date within the last T months for configurable parameter T (default value 18).

Deal Similarity Model

The Deal similarity model is a modified cosine similarity metric across the acceptance indicators that includes a component that increases similarity when the offering Destination matches between two Deals. The Weight placed on this parameter is configurable. This model is very similar to the Advertiser similarity model used in the Advertiser item-based recommender.

Similarities are required for all pain of Deals in which at least one Deal is active (Deal start date≦current date≦Deal end date). Similarities must be updated for each (D1,D2) pair in which a User has accepted one of the two deals. Similarities can be updated with greater frequency than the larger item-based recommender batch run in order to reduce peak processing loads.

### Model Formulation

Define configurable parameter

W_{DN}: Weight in interval [0,1] assigned to an offering Destination match in computing similarities. Implies a (1−W_{DN}) Weight on click rate similarity.

For each Deal D, define indicator vector R_{D} as the vector of Deal acceptances I(ST, D) for each User. Also define vector dot-product

R_{D}_{₁}·R_{D}_{₂}=Σ_{ST}(I(ST,D₁)·I(ST,D₂))

and vector magnitude

∥R_{D}∥={square root over (Σ_{ST}(I(ST,D)²))}.

Indicator function x_{DN}(D₁, D₂) is equal to 1 if D1 and D2 have the same offering. Destination and zero otherwise. Then the similarity of D1 and D2 is defined as:

$$sim ( {D}_{1} , {D}_{2} ) = {W}_{DN} {x}_{DN} ( {D}_{1} , {D}_{2} ) + ( 1 - {W}_{DN} ) \frac{{R}_{{D}_{1}} \cdot {R}_{{D}_{2}}}{‖ {R}_{{D}_{1}} ‖ ‖ {R}_{{D}_{2}} ‖} .$$

Implementation Notes

Similarities need only be recomputed for (D1,D2) pairs in which at least one of the advertisements has been accepted by at least one user since the last batch update. It is not necessary to compute similarities for (D1,D2) pairs for which both Deals are no longer active (i.e., current date is outside of the Deal start date and end date, inclusive).

Similarities are computed independently for each pair. Thus the computation can be distributed.

Similarities can be computed with greater frequency than the collaborative filtering batches in order to reduce peak processing loads. Some similarities will be written over if additional deal acceptances occur, and this tradeoff will need to be considered in deciding the frequency of recomputation.

Similarities are symmetric—that is, sim(D₁, D₂)=sim(D₂, D₁). There is therefore no need to compute the similarities for both (D1,D2) and (D2,D1) as long as both similarities are updated when one is computed.

Item-Based Filtering Model

The item-based filtering model runs as a batch job—frequency will likely be 1-4 runs daily. The model applies a simple k-nearest neighbor model (with configurable parameter k) to the Deal similarities and (ST,D) indicators to infer relative likelihoods of acceptance fbr active Deals. Because similarities are likely to change between each batch run, all unknown click rates for active Deals will need to be recomputed during each batch.

A key distinction between the Destination/Advertisement item-based filtering models and the Deal item-based model is that whereas the former models computed inferred affinities/click rates for only those cases where the known value was null, the Deal model computes relative likelihoods for all (ST,D) pain in which Deal D is active and has not already been accepted by the user.

Model Formulation

For each (User,Deal) pair where D is active and I(ST, D)=0, define the set n_{ST}(D) to be the k Deals D′ (active or inactive) with highest similarity to D (k a configurable parameter with default value 100). Note that unlike the Destination/Advertisement models, Users do not put any restriction on whether the Deals in the set n_{ST}(D) have a known acceptance by ST.

Then the neighborhood-based (ST,D) relative acceptance likelihood is computed as:

$$\hat{I} ( ST , D ) = \frac{{\sum }_{{D}^{′} ∈ {n}_{ST} ( D )} ( {sim ( D , {D}^{′} )}^{m} * I ( ST , {D}^{′} ) )}{{\sum }_{{D}^{′} ∈ {n}_{ST} ( D )} ( {sim ( D , {D}^{′} )}^{m} )} .$$

Acceptance indicators for Deals most similar to D are given the greatest Weight in the prediction. Configurable parameter m (default value 2) changes the relative Weighting—higher values of m lead to a greater difference in relative Weighting for the same difference in similarity.

Implementation Notes

Relative acceptance likelihoods need only be predicted for active Deals.

The batch job can be parallelized by distributing the (ST,D) pairs across machines for independent computation.

The output of the collaborative filtering submodel is a list of predicted acceptance rates for every (ST,D) pair where D is active.

Some Deals may target specific subsets of Users based on sociodemographic factors. The implementation will need to determine where this filtering is performed—within the recommender or outside of the recommender prior to the calls to the recommender.

User-Based Recommender (User Cold Start)

Model Overview

The primary item-based model requires a sufficient number of past Deal acceptances for a given User in order to predict acceptance likelihoods for other Deals for that User. For a newly registered User or a User with limited recorded activity, the model will not perform well. This is known as the user cold start problem.

When a User has accepted fewer than N Deals, the User's unknown click rates will be predicted using a hybrid user-based collaborative filtering model. User-based collaborative filtering transposes item-based filtering Instead of predicting acceptance likelihoods based on a User's acceptance indicator for similar Deals, user-based filtering predicts likelihoods based on acceptance indicators for similar Users for the same Deal. Hybrid user-based collaborative filtering uses both sociodemographic variables and acceptance indicators to compute similarity.

The user-based model is complementary to the item-based model. Both generate predicted acceptance likelihoods for (ST,D) pairs in a social city where D is active and ST has not already accepted D, but they do so for two different sets of Users.

Implementation Note

Some Deals may specifically target STs by sociodemographic, geographic, or other variables with the explicit direction that the Deal not be offered to STs outside of the defined target group. In a future phase. Users may be able to read in those constraints and compute predicted acceptance likelihoods only for those Deals for which a given ST is eligible. This is outside the scope of the initial implementation, however.

Model Description

The user-based recommender model predicts relative acceptance likelihoods for every (ST,D) pair in which ST and the offering Destination of D are in the same social city, D is active, ST has not previously accepted D, and the total number of Deals that ST has previously accepted is less than N.

The model is a hybrid user-based collaborative filtering model. It is composed of 3 sub-models:

The Deal acceptance indicator uses past instances of Users accepting Deals to create a matrix of 0-1 indicators.

The User similarity model computes a similarity metric as a function of sociodemographic and ST preference variables and recorded (ST,D) Deal acceptances.

The collaborative filtering model proper uses the User similarities to generate predicted relative acceptance likelihoods for each (ST,D) pair in which the ST has not previously accepted D.

The required input data for the user-based recommender includes all inputs for the item-based model. In addition, ST sociodemographic and preference variables are required. These variables are specified in the user similarity model description.

The model flow is the same as for the item-based recommender. The key difference between the models is that the user-based recommender uses User similarity instead of Deal similarity. As in the case of the item-based recommender, the user-based model is updated in batches approximately 1-4 times per day. The user similarity component model can be updated more frequently between batches to reduce the peak loads during batch processing.

Component Model Specifications

Deal Acceptance Indicator

Acceptance indicators are formulated for each (ST,D) pair as described in Section 6.2.1.1.

Model Formulation

User Similarity Model

The User similarity model generates pairwise similarities between Users. Similarity is computed as a modified cosine similarity between the extended sociodemographic and acceptance indicator vectors of the Users. The model is constructed in such a way that as the number of known accepted Deals increases for a User, the relative Weight of acceptance similarity naturally increases compared to sociodemographic similarity in the overall similarity computation.

The model is very similar to the User similarity models for both the Destination and Advertisement recommenders. The primary difference is in the use of acceptance indicators in place of Destination affinities or Advertisement click rates.

The user-based filtering model requires that similarities be computed for all (ST1,ST2) pairs in each social city in which at least one of ST1 or ST2 does not meet the threshold requirement for the item-based recommender. Many ST similarities are likely to remain unchanged between consecutive batch nuns of the filtering model. Therefore, the similarities can be stored between batch runs and be computed/recomputed only as required. A ST should be flagged as needing to have its similarities updated if any of the following occur:

The ST is new to the social media system (i.e., does not have any similarities).

The relevant ST profile information has been updated either by the user or the system.

The ST has recorded at least one new acceptance of a Deal.

When a ST is flagged, the similarities between that ST and all other STs in the social city must be recomputed (see implementation note below for discussion). Similarities are symmetric, meaning that sim(ST₁,ST₂)=sim(ST₂,ST₁). Thus it is important that recomputed similarities be updated for both pair orderings if they are stored separately.

There may be an opportunity to make more efficient use of computing resources by updating similarities for flagged STs in more frequent batches than the frequency of the user-based collaborative filtering sub-model. The update frequency should be no less frequent than the collaborative filtering batch frequency.

The logic below describes the algorithm for computing similarity for a single pair of users.

Model Formulation

The similarity between two Users ST1 and ST2 is computed as a cosine-like similarity function over a set of pure cosine similarity sub-functions. The similarity is a real number on the interval [−1,1] with a higher value indicating greater similarity.

The model first computes a sociodemographic similarity between ST1 and ST2. The input sociodemographic dimensions are;

Demographics:

Age (normalized onto [−1,1] interval; unknown age set to median)

Gender (1=M, −1=F, 0=unknown)

Interests: A user can select multiple “interest tags” such as Live Music, Craft Beer, Electronic Dance Music, Chill Nights Out, Local Art.

Favorite Destinations

The interest dimensions are concatenated into a single list for each ST. The sociodemographic similarity between ST1 and ST2 is then computed as:

$${sim}_{sd} ( {ST}_{1} , {ST}_{2} ) = \frac{{W}_{a} {a}_{{ST}_{1}} {a}_{{ST}_{2 }} + {W}_{g} {g}_{{ST}_{1}} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

where a_{ST} and g_{ST} are the age (normalized) and gender, respectively, of User. Wₐ and W_{g} are configurable Weights controlling the relative contribution of the age and gender dimensions, respectively, to the overall User similarity.

The final User similarity measure is a function of the sociodemographic similarities defined above and the Deal acceptance indicator vectors for each User. Define V_{ST} to be the vector of (ST,D) acceptance indicators across all Deals D. Then the User similarity between ST1 and ST2 is defined as:

$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {\sum }_{D} ( {I ( {ST}_{1} D )}^{2} )} * \sqrt{{W}_{sd} + {\sum }_{D} ( {I ( {ST}_{2} , D )}^{2} )}} .$$

The User similarity model naturally adjusts Weight toward the acceptance similarity component as more click rates become known for either ST1 or ST2. Non-negative Weight W_{sd} is a configurable parameter that can adjust the rate at which the click rate similarity gains influence over the sociodemographic similarity. Higher values of W_{sd} put greater Weight on the sociodemographic similarity components, which means that a higher number of known accepted Deals is required to reach a similar balance between sociodemographic and acceptance-based similarity as for a lower value of W_{sd}.

Implementation Notes

For a flagged ST, the similarity to each other ST in the same social city must be updated. Each pairwise similarity is computed independently. Computation for these pairwise similarities can be distributed (e.g., on a Hadoop infrastructure).

The similarities can be updated between collaborative filtering batch runs in order to reduce peak processing loads. Some (ST1,ST2) similarities may be overwritten in that case if one of the STs is again flagged before the next full-model batch update, and thus the tradeoff must be analyzed to determine whether more frequent updates truly improve computational performance.

User-Based Filtering Model

The user-based filtering model runs as a batch job. The frequency will likely be the same as for the item-based model. The user-based model is a transposition of the item-based model. It applies a simple k-nearest neighbor model to the User similarities and (ST,D) acceptance indicators to predict relative acceptance likelihoods for all (ST,D) pairs in a social city for which D is active, ST does not meet the threshold for the item-based model, and ST has not previously accepted D. Many predicted acceptance likelihoods will remain constant between consecutive batch runs; however efficiently identifying the predictions that will remain constant is non-trivial. Thus each batch will update all relevant likelihoods.

Model Formulation

Define configurable parameter k (default value 100) as the neighborhood size. For each (ST,D) pair in the same social city with D active and no recorded acceptance of D by ST, define the set n_{D}(ST) to be the k Users ST′ in with highest similarity to ST. Unlike in the Destination and Advertisement recommenders, Users do not require that the neighborhood contain only those Users with known acceptances of D. The relative acceptance likelihood is predicted as:

$$\hat{I} ( ST , D ) = \frac{{\sum }_{{ST}^{′} ∈ {n}_{D} ( ST )} ( {sim ( ST , {ST}^{′} )}^{m} * I ( {ST}^{′} , D ) )}{{\sum }_{{ST}^{′} ∈ {n}_{D} ( ST )} ( {sim ( ST , {ST}^{′} )}^{m} )} .$$

Acceptance indicators for Users most similar to ST are given the greatest Weight in the prediction. Configurable parameter m changes the relative Weighting—higher values of m lead to a greater difference in relative Weighting for the same difference in similarity.

Implementation Notes

As described in the implementation notes for the item-based recommender, some Deals may specifically target STs by sociodemographic, geographic, or other variables. The method for filtering recommendations based on these constraints will need to be determined in the implementation.

The common parameters for user- and item-based models (k and m) may in fact have different values and should be initialized in the implementation as distinct parameters. Additionally, these parameters are distinct from the similar parameters in the other recommender models (Destination and Advertisement).

This computationally expensive batch job can be parallelized by distributing the (ST,D) pairs across machines for independent computation.

Global Prediction (Unmodeled User)

When a new User registers for the site, no relative likelihoods will be generated for that user until the next run of the collaborative filtering algorithms. The model still needs to be able to recommend Deals for these users until user-specific recommendations become available. In this case, the model will use global acceptance rates of Deals.

The global acceptance rate for a Deal D is computed as the percent of

$${C}_{AID , LID} = {\sum }_{ST} {C}_{ST , AID , LID}$$

$${I}_{AID , LID} = {\sum }_{ST} {I}_{ST , AID , LID}$$

The location click rate is defined as in Section 2.2.1.1:

$${rate}_{loc} ( LID ) = \frac{{\sum }_{ST , AID} {C}_{ST , AID , LID}}{{\sum }_{ST , AID} {I}_{ST , AID , LID}} = \frac{{\sum }_{AID} {C}_{AID , LID}}{{\sum }_{AID} {I}_{AID , LID} } .$$

The absolute and normalized click rates for a given ad AID at location LID are computed across all Users instead of individually for each User. They are, respectively:

$$rate ( AID , LID ) = \frac{{C}_{AID , LID}}{{I}_{AID , LID}}$$

$$\overline{rate} ( AID , LID ) = \frac{rate ( AID , LID )}{{rate}_{loc} ( LID )} .$$

The overall normalized click rare for AID is:

$$\overline{rate} ( AID ) = \frac{{\sum }_{LID} ( {I}_{AID , LID} * \overline{rate} ( AID , LID ) )}{{\sum }_{ST , LID} {I}_{AID , LID}} .$$

The predicted click rates r̅a̅t̅e̅(AID) are now independent of ST. Thus the predicted click rate need only be computed once for each AID during the overall recommender batch run and used to respond to system queries for which the User is unknown to the recommender.

This model is much less computationally intensive than the collaborative filtering models described above and could therefore be run with higher frequency update cycles than for the collaborative filtering models. However, given that global click rates are likely to change slowly over time, running once per day should be sufficient.

Implementation Note

In the similar case that an advertisement AID is unknown, the predicted click rate should be set to zero independent of user. No additional logic needs to be implemented for this case outside of the collaborative filtering models.

Real-Time Recommendations

The system will request recommendations from the model in real time by supplying a User and a list K of keyword search terms. The recommender will return the list of recommended Deals in sorted order based on a combination of a Deal affinity metric, which combines the neighborhood-based relative acceptance likelihood computed by the collaborative filtering models with the Destination affinities from the Destination recommender, and keyword match.

Define DN_{D} to be the Destination offering deal D and aff_{dn}(ST,DN_{D}) to be the (ST, DN_{D}) affinity output from the Destination recommender. Also define Weighting parameter W_{deal}ε[0,1]. Then the Deal affinity for pair (ST,D) is computed as:

aff(ST,D)=W_{deal}Î(ST,D)+(1−W_{deal})aff_{dn}(ST,DN_{D}).

The level of keyword match is measured as the ratio of keywords matched by the Destination offering a given Deal. For example, a search for keywords “bar,” “country,” and “dancing” will have a match value of ⅔ with a Destination with keywords “bar” and “dancing” but not “country,” Formally, let K_{DN} be the keywords associated with Destination DN. For a search over keyword set K,

$$match ( DN , K ) = \frac{\vert K ⋂ {K}_{DN} \vert}{\vert K \vert} .$$

The score is computed as a Weighted average between affinity and keywork match. Define Weighting parameter W_{key}ε[0,1]. A higher value of the Weighting parameter places more emphasis on the keyword match. For a Deal search over keywords K by User, the basic match score list is computed as follows

Select all Deals D with offering destination DN_{D} such |K∩K_{DN}_{_{D}}|>0.

Compute an overall score for each selected Destination DN as:

score(ST,D,K)=W_{key}*match(DN_{D},K)+(1−W_{key})*aff(ST,D).

Sort Destinations by score in descending order and return the first n list elements (maintaining order) where n is the number of recommendations requested.

If W_{key}=0 then order first by affinity and use keyword match as a tiebreaker.

If W_{key}=1 then order first by keyword match and use affinity as a tiebreaker.

Break any remaining ties randomly.

This document specifies the interface, functionality, and implementation of the recommendation engine (RE) that recommends deals to Users. The RE has two parts. First, the RE has a single Java function (shared with other REs) that invokes the RE's nightly batch update processes. Second, the RE has a PL/PGSQL function the produces recommendations at run time.

Assumptions

Affinities

Affinities have the same semantics as for destinations. See the destination RE's implementation specification for details.

Text Search

This specification assumes that the RE uses PostgreSQL's Full Text Search functionality to implement fuzzy matching of search terms to deal tags.

Collaborative Filtering

This specification assumes that the RE uses Mahout to compute inferred affinities using Mahout's item-based and user-based CF (CF) models. Necessary Mahout extensions are coded in Java, per the analytical model documented in the RE's design document. The RE extends Mahout in Java, Mahout's native language.

### Appendix 3: Destinations Recommendations Engine

This document specifies the interface, functionality, and implementation of the recommendation engine (RE) that recommends destinations to Users. The RE has two parts. First, the RE has a single Java function that invokes the RE's nightly batch update processes. Second, the RE has a PL/PGSQL function the produces recommendations at run time.

An affinity is an ordinal real number in the interval [−1, 1] reflecting a User's attitude towards a destination (with obvious semantics). This document distinguishes three types of affinity.

An expressed affinity is an affinity directly expressed by a User for a destination through the Hopspot user interface (UI). The Web site lets Users express affinities in the range [1, 10]; the RE must center and normalize these values into [−1, 1].

A computed affinity is an affinity computed indirectly, based on a User's favorites, follows, and activations (visits) through the UI. For a given User and destination, define I_{fav} and I_{fol} to be indicator (zero-one) variables indicating whether a User has (respectively) favorite and followed a destination. Let A be a nonnegative-integer variable counting how many activations the User has had at the destination in the most recent time period. Define further Weights W_{fav} and W_{fol}. Each of these Weights must be in [0, 1], as must be their sum. Finally, let Cₐ be a non-negative constant. Then the computed affinity is

W_{fav}*I_{fav}+W_{fol}*I_{fol}+(1−W_{fav}−W_{fol})*(A/(Cₐ+A).

Thus any favoriting, following or activation data will yield a computed affinity above the mean, that is, in the interval [0, 1], consistent with our intuition that all three types of data indicate a degree of positive affinity. Call the union of the sets of expressed and computed affinities, empirical affinities. Please consult the RE's design document for details.

An inferred affinity is an affinity estimated by the RE using item- or user-based CF, for users in the data set. For new users not yet in the data set, Users rely on global averages of empirical affinities.

Thus Users have six methods of arriving at a User's affinity for a destination:

expressed affinity,

computed affinity,

item-based CF,

user-based CF, and

global averages.

Social state of mind value.

The above list is in descending order of preference, except that a social state of mind is an express lane to receiving information about a particular destination. Thus the RE uses expressed affinities where they exist; otherwise computed affinities where likes, follows, or activations exist; otherwise uses item-based CF where sufficient data exists; otherwise user-based CF; and otherwise global averages.

Text Search

This specification assumes that the RE uses PostgreSQL's Full Text Search functionality to implement fuzzy matching of search terms to destination tags.

Collaborative Filtering

This specification assumes that the RE uses Mahout to compute inferred affinities using Mahout's item-based and user-based CF (CV) models. Necessary Mahout extensions are coded in Java, per the analytical model documented in the RE's design document. The RE extends Mahout in Java, Mahout's native language.

Upload the city's enqueued updates into Mahout.

Upsert the city's destination tags and status into the destination_attributes table. An upsert is a database operation that checks whether a record with a given primary-key value exists in a table. If so, the operation updates the record. If not, the operation inserts the record. In this case the primary key is User ID. Oracle SQL has a merge command that performs bulk upserts. Merge is the most frequently requested unimplemented PostgreSQL feature. See https://wiki.postgresq1.org/wiki/SQL_MERGE.

Insert the city's new Users into the User table.

Compute each user's computed affinities, and merge them with the user's expressed affinities to form the user's set of empirical affinities.

Compute the (unWeighted) global average of each item's empirical affinities. If an item has no empirical affinities, set its global average to zero. Associate these global averages with the User (user) ID−1. Do not include these in Mahout's datasets.

Invoke Mahout's item-based CF algorithm for the city to compute inferred affinities starting from empirical affinities. Use a maximum neighborhood size of 50 items.

Download all of the city's users' empirical and item-based inferred affinities into the temporary affinity table.

Invoke Mahout's user-based CF algorithm for the city. Use a maximum neighborhood size of 50 users. Where fewer than 20 users have an empirical affinity for an item, penalize the Weighted average for that item with the penalty function log₂(2+u)/log₂(20+b), where u is the number of users that have rated the item.

For each user having fewer than 20 empirical affinities.

delete the users' rows from the temporary affinity table, and

download their empirical affinities and user-based inferred affinities into the table.

Upset the global averages into the destination-affinities table (with a User ID of −1).

Finally, main ( ) should

Delete any existing destination_affinity_backup table (and its indexes).

Index destination_affinity_temp.

Rename destination_affinity to destination_affinity_backup and drop its index(es).

Rename destination_affinity_temp to destination_affinity.

main ( ) should distribute the per-city work across the nodes in the Mahout cluster.

The application code should call getDestinationRecommendations once with returnSponsoredResultsIn set true to get the list of sponsored destinations, and then a second time with returnSponsoradResultIn set false to get the list of (unsponsored) user-preference-based destination recommendations. When returnSponsoredResultsIn is true, the Weightings described in the above algorithm are adjusted by adding a boosting term to the affinity, or to the Weighted sum of affinity and text-match strength (as appropriate). The boosting term rewards destination status by improving the standing of high-status destinations in the search order. The term is defined as sponsoredStatusMultiplierIn*statuŝsponsoredStatusExponentIn. Also, a filter on status limits results to those having status at least minSponsoredStatusIn. See the RE's design document for details.

Invocating the API

The sample PL/pgSQL function below suggests how to invoke getDestinationRecommendations( ). Note the alternation (or) vertical-bar characters (‘|’) separating the keywords passed into keywordListIn. Consult the PL/pgSQL to_tsquery( ) documentation for details

Overview

The Hopspot Destination recommender model generates user-specific rankings of Destinations based on known and/or predicted preferences (“affinities”). Known affinities are computed as a function of known User interactions with a Destination within the Hopspot Website: rating a Destination, setting a Destination as a favorite, following a Destination, accepting/executing a deal offered by a Destination, activating at a Destination, etc.

The model is in reality three independent recommender models. The model used to predict unknown affinities for a given user depends on the amount of known affinity data available for that User and how recently the User registered on the site:

The primary model is the item-based collaborative filtering model described in Section 2. This model is used when a User has known interactions with at least N Destinations (N is a configurable parameter).

The secondary model is the user-based collaborative filtering model described in Section 3. For a User with less than N known Destination affinities, the user-based recommender is used to predict unknown affinities. This addresses system user-specific “cold starts” in which new users do not have enough known ratings to generate meaningful recommendations using the primary model. If the number of known affinities for a given Destination is small then the user-based model discounts the predicted affinity due to the high uncertainty in the prediction.

A third global average model, described in Section 4, is used only in the case of new users that have registered on the site since the last batch collaborative filtering run and therefore will not receive user-specific predictions until the next batch run of the algorithm.

The recommender model serves two end goals. One is to generate recommendations that are likely to have high appeal to a User based on a combination of known/predicted affinities and goodness-of-fit to keyword searches. The second is to identify sponsored/promoted results that combine high appeal with the objective of rewarding advertising businesses or frequent site users by incorporating Destination status as a boosting factor. These boosted results must be clearly identified on the Users site as being sponsored/promoted results and be easily distinguishable from the pure affinity-based recommendations in order to comply with FTC regulations. The final section of this document describes how predicted/known affinities are integrated with keyword search to achieve the first goal and with both keyword search and Destination status to achieve the second.

Use Cases

The initial use case for the Destination recommender is as follows:

User searches for Destinations using a set of keywords. Recommender model orders relevant search results based on a combination of keyword matching and known/inferred affinity. Top results are presented to user.

Future use cases may also be able to take advantage of the recommender model results:

User views newsfeed. Recommender model selects a Destination that User has not previously interacted with from among the Destinations with the highest predicted affinity. Selected Destination is advertised on User's newsfeed.

User views map. Recommender model selects Destinations with high known/predicted affinity within the viewed region.

Destination wants to target Users for a deal based on predicted affinities. Recommender model selects Users who have no recorded interactions with Destination but have a high predicted affinity for the Destination.

The model design allows for complete flexibility in how the predicted affinities are used within the site.

Model Objectives

Maximize click rates on top search results.

Maximize follows of recommended Destinations.

Maximize acceptance of deals at recommended Destinations.

Maximize activations at recommended Destinations.

Feature sponsored results that receive high click rates.

Item-based Recommender (primary)

Model Overview

The primary recommender model is a hybrid item-based collaborative filtering model. In a pure item-based collaborative filtering model, pairwise item (Destination) similarity is quantified based on how similarly users tend to rate the two items. Predicted affinities are then generated for User-Destination pairs with no known interactions based on the User's known affinities for similar items. Hybrid item-based collaborative filtering follows the same high-level logic but extends the similarity metric to account for firmographic data and other descriptive dimensions: Destination profile tags, Factual business categories, Factual neighborhood tags, total Destination status points, etc.

The item-based recommender requires a certain density of known preferences for a User in order to be effective. Thus the item-based recommender model is only used when the User has known affinities for at least N Destinations, where N is a configurable model parameter.

The item-based recommender model will generate predicted preferences for all User-Destination pairs in each Hopspot city with unknown preference where the User meets the minimum known affinity threshold. For each User, the predicted and known affinities are used to generate a user-specific preference ranking over all Destinations.

Model Description

The core recommender model generates affinities for every pair of User (ST) and Destination (DN) in each Hopspot city where the number of known affinities for the ST is at least N. The model is a hybrid item-based collaborative filtering model. This larger model is composed of 3 sub-models:

The affinity model defines ST-DN affinities. If the ST has given the DN a 1-10 rating then a normalized rating is used as the affinity. Otherwise, the model computes affinity as a function of ST site behaviors related to the DN: follows, favorites, activations at Destinations, acceptance of deals, etc.

The Destination similarity model computes a similarity metric as a function of firmographic/descriptive variables and known ST-DN affinities.

The collaborative filtering model proper uses the Destination similarities to generate predictions for unknown ST-DN affinities.

The collaborative filtering model will be run as a batch job with the frequency of the batch update set as a parameter (likely 1-4 times daily in production). The similarity model requires affinities as an input, and the collaborative filtering model requires both affinities and similarities as inputs. Many of the affinities/similarities are likely to persist between batch runs and do not need to be recomputed. Affinities/similarities that do change can be updated between batch runs either through continuous updating (monitor for triggering events and immediately recompute) or in more frequent batch updates between the collaborative filtering batch runs. This will reduce the peak processing load during full batch updates but will increase average processing loads due to some affinity/similarity updates being overwritten by additional updates prior to the next batch run. This tradeoff will need to be evaluated in the implementation of the model.

Component Model Specifications

Affinity Model

The affinity model assigns affinities between −1 and 1 for ST-DN pairs in which there are known site interactions. If the ST has reviewed the DN and given it an overall experience rating then the model assigns a normalized rating as the affinity. Otherwise, the model processes a range of logged ST-DN interactions into a computed affinity that attempts to infer how the ST would rate the DN based on other logged behaviors. ST-DN pairs with no recorded action are assigned a null affinity to indicate that these values will need to be predicted by the collaborative filtering sub-model.

Most affinities are likely to remain static between consecutive batch runs. Thus the known affinities can be stored between batches and updated as needed. A (ST,DN) pair should be flagged for update when one of the following interactions occurs between that ST and DN:

ST adds/updates rating for DN,

ST has not rated the DN and:

ST adds/removes DN as a favorite, or

ST follows/unfollows DN, or

ST activates at DN, or

ST accepts a deal from DN, or

ST activation at DN or acceptance of deal from DN “ages out” (becomes more than 15 months old).

Affinities for flagged (ST,DN) pairs can be updated continuously by triggering the affinity model immediately when a pair is flagged, or the flagged (ST,DN) pairs can be updated in batches. If updated in batches, the affinity batch updates must occur with at least as much frequency as the collaborative filtering sub-model batch updates.

Model Formulation

For a given (ST,DN) pair, the affinity aff(ST, DN) is computed as a function of the known interactions between the ST and DN. There are three possible cases:

If the ST has not rated, followed, favorited, activated at, or accepted a deal offered by the DN then set aff(ST, DN)=null to indicate that this affinity is unknown and must be predicted by the collaborative filtering model.

If the ST has given the DN an overall experience rating of 1-10 in a review then set the affinity to the normalized ST-DN rating. Formally, define if r(ST, DN) as the rating given by User to Destination DN and r̅_{ST} as the mean overall experience rating given by ST across all rated destinations. Then set:

$$aff ( ST , DN ) = \{ \begin{matrix}\frac{r ( ST , DN ) - {\overline{r}}_{ST}}{10 - {\overline{r}}_{ST}} & if r ( ST , DN ) > {\overline{r}}_{ST} ; \\ \frac{{\overline{r}}_{ST} - r ( ST , DN )}{{\overline{r}}_{ST} - 1} & if r ( ST , DN ) < {\overline{r}}_{ST} ; \\ 0 & if r ( ST , DN ) = {\overline{r}}_{ST}\end{matrix} .$$

This is referred

Note the last case must be explicitly defined to account for the cases where all known user rating are 10 or all known user ratings are 1.

Otherwise, compute the affinity as a function of the known ST-DN interactions. Define the following configurable parameters:

W_{fav}: Weight for favorites

W_{fol}: Weight for follows (likely that W_{fol}<W=_{fav})

Wₐ: Weight for activations

where 0<W_{fav}, W_{fol}, Wₐ<1 and W_{fav}+W_{fol}+Wₐ=1.

Define also the functions:

$${x}_{fav} ( ST , DN ) = \{ \begin{matrix}1 & if DN in ST favorites \\ 0 & otherwise\end{matrix} \\ {s}_{fol} ( ST , DN ) = \{ \begin{matrix}1 & if ST following DN \\ 0 & otherwise\end{matrix} \\ {x}_{a} ( ST , DN ) = ( \begin{matrix}\begin{matrix}count of ST activations at DN and \\ acceptance of deals from DN\end{matrix} \\ over preceding 15 months\end{matrix} )$$

Then compute the ST-DN affinity as:

$$aff ( ST , DN ) = {W}_{fav} {x}_{fav} ( ST , DN ) + {W}_{fol} {x}_{fol} ( ST , DN ) + {W}_{a} \frac{{x}_{a} ( ST , DN )}{c + {x}_{a} ( ST , DN )}$$

where C is a configurable constant with default value 1.5. Note that in this case the affinity will be in the interval [0,1].

Destination Similarity Model

The Destination similarity model computes pairwise similarities between Destinations. Similarity is computed as a modified cosine similarity between the extended firmographic and affinity vectors of the Destinations. The model is constructed in such a way that as the number of known affinities increases for a Destination, the relative Weight of affinity similarity naturally increases compared to firmographic similarity in the overall similarity computation.

The item-based filtering model requires that similarities be computed for all DN pairs. Many similarities are likely to remain unchanged between consecutive batch runs of the filtering model. Therefore, the similarities can be stored between batch runs and be computed/recomputed only as required. A DN should be flagged as needing to have its similarities updated if any of the following occur:

The DN is new to Hopspot (i.e., does not have any similarities).

The categories, tags, or neighborhoods in the DN profile have been updated.

One or more (ST,DN) affinities have been updated for this DN.

When a DN is flagged, the similarities between that DN and all other DNs in the same Hopspot city must be recomputed. Similarities are symmetric, meaning that sim(DN1,DN2)=sim(DN2/DN1). Thus it is important that recomputed similarities be updated for both pair orderings if they are stored separately.

As in the case of affinities, flagged DNs can be updated continuously by triggering the similarity model immediately when a DN is flagged, or the flagged DNs can be updated in batches. The update frequency should be no more frequent than the affinity update frequency and no less frequent than the collaborative filtering batch frequency.

The logic below describes the algorithm for computing similarity between a single pair of Destinations.

Model Formulation

The similarity between two destinations DN1 and DN2 is computed as a cosine-like similarity function over a set of pure cosine similarity sub-functions. The similarity is a real number on the interval [−1,1] with a higher value indicating greater similarity.

For the firmographic dimensions, the sub-functions are of similar form:

$${sim}_{tags} ( {DN}_{1} , {DN}_{2} ) = \frac{\vert {DN}_{1} profile tags ⋂ {DN}_{2} profile tags \vert}{\sqrt{\vert {DN}_{1} profile tags \vert * \vert {DN}_{2} profile tags \vert}}$$

$${sim}_{cat} ( {DN}_{1} , {DN}_{2} ) = \frac{\vert {DN}_{1} factual categories ⋂ {DN}_{2} factual categories \vert}{\sqrt{\vert {DN}_{1} factual categories \vert * \vert {DN}_{2} factual categories \vert}}$$

$${sim}_{nbd} ( {DN}_{1} , {DN}_{2} ) = \frac{\vert {DN}_{1} neighborhood tags ⋂ {DN}_{2} neighborhood tags \vert}{\sqrt{\vert {DN}_{1} neighborhood tags \vert * \vert {DN}_{2} neighborhood tags \vert}}$$

The vertical bars represent the set size function. Thus the sub-factions are computed as the number of common tags/categories between DN1 and DN2 divided by the square root of the product of the number of tags in each Destination's profile. If either DN does not have any profile tags, Factual categories, or neighborhood tags then the denominator will be zero in the corresponding similarity component, and the component ratio will be undefined. In this case, the similarity is set to zero.

The profile tags and neighborhood tags can be used directly for the above sub-functions. The Factual categories must be expanded. For example, the Factual category (Social,Restaurant,Italian) is expanded into three categories:

(Social),(Social,Restaurant),(Social,Restaurant,Italian).

For Destinations with multiple Factual categories, any duplicates resulting from the expansion of the categories are removed. For example, a restaurant with the two categories (Social,Restaurant,Italian) and (Social,Restaurant,Greek) would, after removing duplicates, have expanded categories:

(Social),(Social,Restaurant),(Social,Restaurant,Italian),(Social,Restaurant,Greek).

The expanded Factual categories are the basis for computing sim_{cat}( ).

The final similarity measure is a function of the firmographic similarities defined above and the known affinities across all Users for each Destination. Define V_{DN} to be the vector of (ST,DN) affinities across all Users ST in the city. If the affinity is null (i.e., unknown) then the corresponding element of the vector is set to zero. Then define the overall similarity function to be:

$$sim ( {DN}_{1} , {DN}_{2} ) = \frac{{W}_{f} ( \begin{matrix}{sim}_{tags} ( {DN}_{1} , {DN}_{2} ) + {sim}_{cat} ( {DN}_{1} , {DN}_{2} ) + \\ s ( {m}_{nbd} ( {DN}_{1} , {DN}_{2} ) )\end{matrix} ) + {V}_{{DN}_{1}} \cdot {V}_{{DN}_{2}}}{\sqrt{3 {W}_{f} + {\sum }_{ST} ( {aff ( ST , {DN}_{1} )}^{2} )} * \sqrt{3 {W}_{f} + {\sum }_{ST} ( {aff ( ST , {DN}_{2} )}^{2} )}}$$

where V_{DN}_{₁}·V_{DN}_{₂} is the dot-product of the rating vectors:

V_{DN}_{₁}·V_{DN}_{₂}=Σ_{ST}(aff(ST,DN₁)*aff(ST,DN₂))

The above similarity function is similar to a cosine similarity but has been modified to account differently or firmographic and affinity-based components of the similarity. As the number of known affinities grows for DN1 and/or DN2, the length of the affinity vectors—and thus the denominator of sim(DN₁, DN₂)—will increase. The contribution of the firmographic variables to the numerator has a fixed maximum (each sub-function is between zero and 1), and thus the influence of firmographic similarity will decrease as the length of the two vectors increases. This naturally shifts influence from firmographic similarity to affinity similarity as the number of known affinities for a Destination increases.

Non-negative Weight W_{f} is a configurable parameter that can adjust the rate at which the affinity similarity dominates firmographic similarity. Higher values of W_{f} put greater Weight on the firmographic similarity components, which means that a higher number of known affinities is required to reach a similar balance between firmographic and affinity-based similarity as for a lower value of W_{f}.

Implementation Note

As noted above, for a flagged DN the similarity to each other DN must be updated. Each pairwise similarity is computed independently. Whether similarity updates are performed continuously or in batches, computation for these pairwise similarities can be distributed (e.g., on a Hadoop infrastructure).

Item-Based Filtering Model

The item-based filtering model runs as a batch job-frequency will likely be 1-4 runs daily. The model applies a simple k-nearest neighbor model to the Destination similarities and known (ST,DN) affinities to predict all unknown (ST,DN) affinities. Many predicted affinities are likely to remain constant between consecutive batch runs; however efficiently identifying the predicted affinities that will remain constant is non-trivial. Thus each batch will update all unknown affinities.

Model Formulation

Define configurable parameter k≧N (default value 50) to be the neighborhood size. For each (ST,DN) pair in each Hopspot city with unknown affinity, define the set n_{ST}(DN) to be the k Destinations DN′ in the same city with highest similarity to DN for which of aff(ST, DN′) is known. If fewer than k such affinities are known then n_{ST}(DN) is the set of all destinations DN′ for which aff(ST, DN′) is known. Then the unknown (ST,DN) affinity is computed as:

$$aff ( ST , DN ) = \frac{{\sum }_{{DN}^{′} ∈ {n}_{ST} ( DN )} ( {sim ( DN , {DN}^{′} )}^{m} * aff ( ST , {DN}^{′} ) )}{{\sum }_{{DN}^{′} ∈ {n}_{ST} ( DN )} ( {sim ( DN , {DN}^{′} )}^{m} )} .$$

Known affinities for Destinations most similar to DN are given the greatest Weight in the prediction. Configurable parameter m changes the relative Weighting—higher values of m lead to a greater difference in relative Weighting for the same difference in similarity.

Implementation Notes

This computationally expensive batch job can be parallelized by distributing the unknown (ST,DN) affinities across machines for independent computation.

The output of the collaborative filtering submodel is a list of known or predicted (ST,DN) affinity for every (ST,DN) pair within each Hopspot city. However, this is likely too much data to be useful in translating into real-time recommendations. Thus the output will likely be post-processed to generate a fixed-length ranked list for each ST of the Destinations for which ST has the highest known or predicted affinities.

User-Based Recommender (User Cold Start)

Model Overview

The primary item-based model requires a sufficient amount of affinity data for a given User in order to predict their unknown preferences. For a newly registered User or a User with limited recorded activity, the model will not perform well. This is known as the user cold start problem. When the entire system has limited information—such as when a new city is launched—then this is known as the system cold start problem.

When a User has fewer than N known affinities, the User's unknown affinities will be predicted using a hybrid user-based collaborative filtering model. User-based collaborative filtering transposes item-based filtering. Instead of predicting affinity based on a User's known affinities for similar Destinations, user-based filtering predicts affinity based on known affinities of similar Users for the same Destination. Hybrid user-based collaborative filtering uses both sociodemographic variables and known affinities to compute similarity.

The user-based recommender model generates the same outputs as the item-based model: predicted preferences for User-Destination pairs in each Hopspot city with unknown preference. The predictions are generated only for those pairs where the User does not have enough known affinities to qualify for the item-based recommender. For each User, the predicted and known preferences are used to generate a user-specific preference ranking over all Destinations.

Model Description

The user-based recommender model generates affinities for every pair of User and Destination in each Hopspot city where the number of known affinities for the User is less than N.

The model is a hybrid user-based collaborative filtering model. This larger model is composed of 3 sub-models:

The affinity model computes ST-DN affinities as a function of ST site behaviors related to the DN: follows, favorites, activations at Destinations, acceptance of deals, etc.

The User similarity model computes a similarity metric as a function of sociodemographic and ST preference variables and known ST-DN affinities.

The collaborative filtering model proper uses the User similarities to generate predictions for unknown ST-DN affinities

The model flow is the same as for the item-based recommender. The key difference between the models is that the user-based recommender uses User similarity instead of Destination similarity. As in the case of the item-based recommender, the user-based model is updated in batches approximately 1-4 times per day. The affinity and similarity components can be updated more frequently between batches to reduce the peak loads during batch processing.

Component Model Specifications

Affinity Model

The affinity model for the user-based recommender is identical to the affinity model for the item-based recommender. The two affinity models can in fact be run as a single model, and the computed affinities do not need to be segregated until they are input into the appropriate similarity and filtering sub-models. Refer to Section 2.2.1.1 for a complete description of the affinity model.

Model Formulation

Reference Section 2.2.1.1.

User Similarity Model

The User similarity model generates pairwise similarities between Users. Similarity is computed as a modified cosine similarity between the extended sociodemographic and affinity vectors of the Users. The model is constructed in such a way that as the number of known affinities increases for a User, the relative Weight of affinity similarity naturally increases compared to sociodemographic similarity in the overall similarity computation.

The user-based filtering model requires that similarities be computed for all (ST1,ST2) pairs in which at least one of ST1 or ST2 does not meet the threshold requirement for the item-based recommender. The processing flow for the User similarity model is similar to that of the Destination similarity model described in Section 2.2.1.2. As is the case for the Destination model, many ST similarities are likely to remain unchanged between consecutive batch runs of the filtering model. Therefore, the similarities can be stored between batch runs and be computed/recomputed only as required. A ST should be flagged as needing to have its similarities updated if any of the following occur:

The ST is new to Hopspot (i.e., does not have any similarities).

The relevant ST profile information has been updated either by the user or the system.

One or more (ST,DN) affinities have been updated for this ST.

When a ST is flagged, the similarities between that ST and all other STs in the same Hopspot city must be recomputed. Similarities are symmetric, meaning that sim(ST₁, ST₂)=sim(ST₂, ST₁). Thus it is important that recomputed similarities be updated for both pair orderings if they are stored separately—although the computation need only be performed a single time.

As in the Destination similarity model, flagged STs can be updated continuously by triggering the similarity model immediately when a ST is flagged, or the flagged STs can be updated in batches. The update frequency should be no more frequent than the affinity update frequency and no less frequent than the collaborative filtering batch frequency.

The logic below describes the algorithm for computing similarity for a single pair of STs.

Model Formulation

The similarity between two Users ST1 and ST2 is computed as a cosine-like similarity function over a set of pure cosine similarity sub-functions. The similarity is a real number on the interval [−1,1] with a higher value indicating greater similarity.

The model first computes a sociodemographic similarity between ST1 and ST2. The input sociodemographic dimensions are:

Demographics:

Age (normalized onto [−1,1] interval; unknown age set to median)

Gender (1=M, −1=F, 0=unknown)

Interests: A user can select multiple “interest tags” such as Live Music, Craft Beer, Electronic Dance Music, Chill Nights Out, Local Art.

Favorite Destinations

The interest dimensions are concatenated into a single list for each ST. The sociodemographic similarity between ST1 and ST2 is then computed as:

$${sim}_{sd} ( {ST}_{1} , {ST}_{2} ) = \frac{{W}_{a} {a}_{{ST}_{1}} {a}_{{ST}_{2}} + {W}_{g} {g}_{{ST}_{2}} + \vert {ST}_{1} interests ⋂ {ST}_{2} interests \vert}{\sqrt{{W}_{a} + {W}_{g} + \vert {ST}_{1} interests \vert} * \sqrt{{W}_{a} + {W}_{g} + \vert {ST}_{2} interests \vert}}$$

where a_{ST} and g_{ST} are the age (normalized) and gender, respectively, of User. Wₐ and W_{g} are configurable Weights controlling the relative contribution of the age and gender dimensions, respectively, to the overall User similarity.

Similar to the Destination model, the final User similarity measure is a function of the sociodemographic similarities defined above and the known affinities of each User. Define V_{ST} to be the vector of (ST,DN) affinities across all Destinations DN in the city. If the affinity is null (i.e., unknown) then the corresponding element of the vector is set to zero. Then the User similarity between ST1 and ST2 is defined as:

$$sim ( {ST}_{1} , {ST}_{2} ) = \frac{{W}_{sd} {sim}_{sd} ( {ST}_{1} , {ST}_{2} ) + {V}_{{ST}_{1}} \cdot {V}_{{ST}_{2}}}{\sqrt{{W}_{sd} + {\sum }_{DN} ( {aff ( {ST}_{1} , DN )}^{2} )} * \sqrt{{W}_{sd} + {\sum }_{DN} ( {aff ( {ST}_{2} , DN )}^{2} )}}$$

As was the case for the Destination similarity model, the User similarity model naturally adjusts Weight toward the affinity component of the similarity as more affinities become known for either ST1 or ST2. Non-negative Weight W_{sd} is a configurable parameter that can adjust the rate at which the affinity similarity gains influence over the sociodemographic similarity. Higher values of W_{sd} put greater Weight on the sociodemographic similarity components, which means that a higher number of known affinities is required to reach a similar balance between sociodemographic and affinity-based similarity as for a lower value of W_{sd}.

Implementation Note

As is the case for the Destination similarity model, for a flagged ST the similarity to each other ST must be updated. Each pairwise similarity is computed independently. Whether similarity updates are performed continuously or in batches, computation for these pairwise similarities can be distributed (e.g., on a Hadoop infrastructure).

User-Based Filtering Model

The user-based filtering model runs as a batch job. The frequency will likely be the same as for the item-based model. The user-based model is a transposition of the item-based model. It applies a simple k-nearest neighbor model to the User similarities and known (ST,DN) affinities to predict all unknown (ST,DN) affinities for Users without enough known affinities to meet the item-base model threshold. Many predicted affinities are likely to remain constant between consecutive batch runs; however efficiently identifying the predicted affinities that will remain constant is non-trivial. Thus each batch will update all unknown affinities.

Model Formulation

Define configurable parameter k (default value 50) to be the neighborhood size. For each (ST,DN) pair in each Hopspot city with unknown affinity, define the set n_{DN}(ST) to be the k Users ST′ in the same city with highest similarity to ST for which aff(ST′, DN) is known. If fewer than k such affinities are known then n_{DN}(ST) will be the set of all Users ST′ for which aff(ST′,DN) is known. Define also configurable variable kₘᵢₙ≦k (default value 20). If no known exist for DN then set aff(ST, DN)=0. If |n_{DN}(ST)|≧kₘᵢₙ then the unknown (ST,DN) affinity is computed as:

$$aff ( ST , DN ) = \frac{{\sum }_{{ST}^{′} ∈ {n}_{DN} ( ST )} ( {sim ( ST , {ST}^{′} )}^{m} * aff ( {ST}^{′} , DN ) )}{{\sum }_{{ST}^{′} ∈ {n}_{DN} ( ST )} ( {sim ( ST , {ST}^{′} )}^{m} )} .$$

If instead 0<|n_{DN}(ST)|<kₘᵢₙ then the unknown affinity is computed as:

$$aff ( ST , DN ) = \frac{{\sum }_{{ST}^{′} ∈ {n}_{DN} ( ST )} ( {sim ( ST , {ST}^{′} )}^{m} * aff ( {ST}^{′} , DN ) )}{{\sum }_{{ST}^{′} ∈ {n}_{DN} ( ST )} ( {sim ( ST , {ST}^{′} )}^{m} )} * \frac{{log}_{b} ( 1 + \vert {n}_{DN} ( ST ) \vert )}{{log}_{b} ( 1 + {k}_{m i n} )} .$$

The second term scales the inferred rating based on the number of known affinities—a small number of known affinities means relatively less confidence in the validity of the mean affinity, and thus the mean affinity is scaled toward zero. b is a configurable parameter. As the number of known affinities approaches kₘᵢₙ, this ratio approaches 1, and the impact of the scaling factor disappears.

Known affinities for Users most similar to ST are given the greatest Weight in the prediction. Configurable parameter m changes the relative Weighting—higher values of m lead to a greater difference in relative Weighting for the same difference in similarity.

Implementation Notes

The common parameters for user- and item-based models (k and m) may in fact have different values and should be initialized in the implementation as distinct parameters.

This computationally expensive batch job can be parallelized by distributing the unknown (ST,DN) affinities across machines for independent computation.

The output of the collaborative filtering submodel is a list of known or predicted (ST,DN) affinity for every (ST,DN) pair within each Hopspot city. However, this is likely too much data to be useful in translating into real-time recommendations. Thus the output will likely be post-processed to generate a fixed-length ranked list for each ST of the Destinations for which ST has the highest known or predicted affinities.

Global Prediction (Unmodeled User)

When a new User registers for the site, no predicted affinities will be generated for that user until the next run of the collaborative filtering algorithms. The model still needs to be able to recommend Destinations for these users until user-specific recommendations become available. In this case, the model will use global average affinities across all users, adjusted for number of known affinities, as a stand in until the next collaborative filtering model run.

The global affinities are computed in a manner similar to the user-based filtering model described in Section 3.2.1.3. For Destination DN, define N_{DN} as the set of all Users ST in the current city with known (ST,DN) affinity. If no such ST exist (i.e., there are no known affinities for DN) then set the global affinity prediction aff(DN) to zero. If |N_{DN}|<kₘᵢₙ, where kₘᵢₙ is the same parameter as defined in Section 3.2.1.3, then set:

$$aff ( DN ) = \frac{{\sum }_{ST ∈ {N}_{DN}} aff ( ST , DN )}{\vert {N}_{DN} \vert} * \frac{{log}_{b} ( 1 + \vert {N}_{DN} ( ST ) \vert )}{{log}_{b} ( 1 + {k}_{m i n} )} .$$

The first term is the mean of all known affinities for DN. Note that because the known affinities include a normalized rating component, they can be either positive or negative. The second term scales the mean rating based on the number of known affinities—a small number of known affinities means relatively less confidence in the validity of the mean affinity, and thus the mean affinity is scaled toward zero.

If instead |N_{DN}|≧kₘᵢₙ then set:

$$aff ( DN ) = \frac{{\sum }_{ST ∈ {N}_{DN}} aff ( ST , DN )}{\vert {N}_{DN} \vert} .$$

This is simply an arithmetic mean overall known affinities for DN.

Note that this affinity computation is independent of ST. Thus the predicted affinity need only be computed once for each DN and used for any new User that was not included in the previous collaborative filtering model runs.

This model is much less computationally intensive than the collaborative filtering models described above and could therefore be run with higher frequency update cycles than for the collaborative filtering models. However, given that global affinities are likely to change slowly over time, running once per day should be sufficient.

In the initial implementation the system cold start model will also be applied when a new city is introduced. Once the site is live, however, new cities may be able to leverage information from existing User cities to improve recommendations immediately—e.g., via knowledge-based models trained on existing cities. This is a potential area of further development after the initial site launch.

Generating Keyword Search Results

The primary use case for the recommender models is to generate recommendations in response to a Users' keyword search. Two lists of results are generated by sorting on two different metrics:

The basic match score is computed as a function of the known/predicted User-Destination affinity and the level of keyword match.

The boosted match score also includes a “boost” component computed from Destination status. Destinations can be sorted separately by the boosted score in order to determine which promotional/sponsored recommendations will be displayed.

The level of keyword match will be measured as the ratio of keywords matched for a given Destination. For example, a search for keywords “bar,” “country,” and “dancing” will have a match value of ⅔ with a Destination with keywords “bar” and “dancing” but not “country.” Formally, let K_{DN} be the keywords associated with Destination DN. For a search over keyword set K,

$$match ( DN , K ) = \frac{\vert K ⋂ {K}_{DN} \vert}{\vert K \vert} .$$

For the basic score, the relative importance of keyword match versus affinity will be governed by a Weighting parameter W_{key}ε[0,1]. A higher value of the Weighting parameter places more emphasis on the keyword match. For a search over keywords K by User, the basic match score list is computed as follows:

Select Destinations DN with |K∩K_{DN}|>0.

Compute an overall score for each selected Destination DN as:

score(ST,DN,K)=W_{key}*match(DN,K)+(1−W_{key})*aff(ST,DN).

Sort Destinations by score in descending order and return the first n list elements (maintaining order), where n is the number of recommendations requested.

If W_{key}=0 then order first by affinity and use keyword match as a tiebreaker.

If W_{key}=1 then order first by keyword match and use affinity as a tiebreaker.

The boosted score also incorporates a boosting factor. The boosting factor is computed as:

boost(DN)=W_{b}*status(DN)^{p}

where status(DN) is the status of Destination DN and p is a configurable parameter with 0<p≦1 (default value 0.5) and W_{b}>0 is a configurable Weighting parameter.

Only destinations with status(DN)>S for configurable threshold S are eligible for inclusion on the list of promoted Destinations. The boosted match score list is computed as follows:

Select Destinations DN with |K∩K_{DN}|>0 and with status(DN)>S.

Compute a boosted score for each selected DN as:

score_{boost}(ST,DN,K)=score(ST,DN,K)+boost(DN).

Sort Destinations by score in descending order and return the first m elements (maintaining order), where m is the number of boosted recommendations requested.

If W_{B}=0 then order first by basic score and use boost as a tie-breaker.

Implementation Note

Because status is awarded in return for Destinations performing actions desired by the Hopspot business, featuring a Destination based on boosted match score can be interpreted as a promotional consideration. Thus in order to comply with FTC regulations, boosted results must be clearly identified as promotional anywhere they appear in response to a use.

In exemplary embodiments of the social media system, a memory on a server stores content affinity data received from the end user devices that are often associated with end user accounts (i.e., social media system members access their respective social media system accounts with an end user device). A memory on the server stores content affinity data received from the end users in work queue pipelines according to the affinity data type. The server may incorporate a data prioritization software program stored on the memory and configured to prioritize data processing routines implemented by the server's processor, wherein the data prioritization software program is configured to direct the processor to process the work queue pipelines in an order determined by the affinity data type in each work queue pipeline. The prioritization software program grants an empirical affinity data type a higher processing priority than an inferred affinity data type. An empirical affinity data type comprises either an expressed affinity data type or a calculated affinity data type, and the prioritization software program grants an expressed affinity data type a higher processing priority than a calculated affinity data type. an inferred affinity data type comprises one of a collaborative filtering affinity, a content based affinity, or a global user average affinity. A social media system according this disclosure, therefore, utilizes a collaborative filtering affinity for content data that is calculated by the processor using an item-based collaborative filtering or a user based collaborative filtering, and the software prioritization program grants a higher processing priority to an item-based collaborative filtering work queue. Due to the prioritization software program, the server transmits content data to an end user at a time determined by the priority assigned to a respective work queue pipeline as determined by the affinity data type received by the server.

In another related embodiment, a method implements a social media system on a network connecting system servers and end user devices exchanging data across the network by utilizing processors and memory on the server to store content affinity data received from the end user devices such that the content affinity data is stored in work queue pipelines according to affinity data type. A prioritization software program assigns the work queue pipelines a processing priority on the server according to a hierarchy assigned to the content affinity data types, wherein the content affinity data types comprise expressed affinity data, calculated affinity data, collaborative filtering affinity data, content-based affinity data, and global user average affinity data for content data available on the social media system. The hierarchy establishes a processing order for the content affinity types such that work queue pipelines in the memory are processed in the following numeric order:

(i) expressed affinity data is granted the highest processing priority, and then (ii) calculated affinity data, then (iii) collaborative filtering affinity data, (iv) content-based affinity data, and finally (v) global user average affinity data. Collaborative filtering affinity data comprises item based collaborative filtering data and user based collaborative filtering data with item based data being granted a higher processing priority on the server than user based data.

The processing priority at the server determines how quickly content data at an end user device can be updated accurately so that an end user accessing their social media account on the system receives the best content data for that end user in the most efficient time frame. The end user devices, accessed by a user with an account on the social network described herein, displays content data received from the server in accordance with processed affinity data received by the server. That processed affinity data has been updated by the server on the basis of a prioritization software program described herein. Content data for display is paired with an end user account on the social media system pursuant to processed affinity data from the work queue pipelines. The processed affinity data comprises global average affinity data as a default value for all end user accounts. The processed affinity data comprises expressed affinity data or calculated affinity data for the end user. In the absence of expressed affinity data or calculated affinity data paired with the user account, the content data for display is paired with the respective end user account on the basis of processed affinity data comprising, in order of preference, item based collaborative filtering data, user based collaborative filtering data, or content based collaborative filtering data. An expressed affinity data in the form of a social state of mind data input directs corresponding content data to the end user account immediately, and that content data will be directly related to the social state of mind content data correspondingly stored on the server, possibly by other users with the same “social state of mind.”

These embodiments of the social media system are further disclosed in the claims that follow.

1. A social media system implemented on a network connecting system servers and end user devices exchanging data across the network, the social media system comprising:
a memory on the server storing content affinity data received from the end user devices, wherein the memory stores the affinity data in work queue pipelines according to the affinity data type;
a processor on the server;
a data prioritization software program stored on the memory and configured to prioritize data processing routines implemented by the processor,
wherein the data prioritization software program is configured to direct the processor to process the work queue pipelines in an order determined by the affinity data type in each work queue pipeline.

2. A social media system according to claim 1, wherein the prioritization software program grants an empirical affinity data type a higher processing priority than an inferred affinity data type.

3. A social media system according to claim 1, wherein an empirical affinity data type comprises either an expressed affinity data type or a calculated affinity data type, and the prioritization software program grants an expressed affinity data type a higher processing priority than a calculated affinity data type.

4. A social media system according to claim 3, wherein an expressed affinity data type comprises a social state of mind data point entered into an end user device and transmitted to the server.

5. A social media system according to claim 1, wherein an inferred affinity data type comprises one of a collaborative filtering affinity, a content based affinity, or a global user average affinity.

6. A social media system according to claim 5, wherein a collaborative filtering affinity for content data is calculated by the processor using an item-based collaborative filtering or a user based collaborative filtering, and the software prioritization program grants a higher processing priority to an item-based collaborative filtering.

7. A social media system according to claim 1, wherein the server transmits content data to the end user device at a time determined by the priority assigned to a respective work queue pipeline as determined by the affinity data type received by the server.

8. A social media system according to claim 7, wherein the server processes the work queue pipelines on either an incremental basis or a batch basis as determined by the affinity data type in each work queue pipeline.

9. A social media system according to claim 1, wherein the processor receives a trigger from the prioritization software program to start processing a work queue pipeline, and the trigger is determined from a received end user device flag or an affinity data type flag.

10. A method of implementing a social media system on a network connecting system servers and end user devices exchanging data across the network, the method comprising:
utilizing processors and memory on the server to store content affinity data received from the end user devices such that the content affinity data is stored in work queue pipelines according to affinity data type;
assigning the work queue pipelines a processing priority on the server according to a hierarchy assigned to the content affinity data types, wherein the content affinity data types comprise expressed affinity data, calculated affinity data, collaborative filtering affinity data, content-based affinity data, and global user average affinity data for content data available on the social media system.

11. A method according to claim 10, wherein the hierarchy comprises a processing order for the content affinity types such that work queue pipelines in the memory are processed in the following numeric order:
(i) expressed affinity data, (ii) calculated affinity data, (iii) collaborative filtering affinity data, (iv) content-based affinity data, and (v) global user average affinity data.

12. A method according to claim 11, wherein the collaborative filtering affinity data comprises item based collaborative filtering data and user based collaborative filtering data with item based data being granted a higher processing priority on the server than user based data.

13. A method according to claim 11, wherein an end user device displays content data received from the server in accordance with processed affinity data received by the server.

14. A method according to claim 13, wherein content data for display is paired with an end user account on the social media system pursuant to processed affinity data from the work queue pipelines.

15. A method according to claim 14, wherein the processed affinity data comprises global average affinity data as a default value for all end user accounts.

16. A method according to claim 14, wherein the processed affinity data comprises expressed affinity data or calculated affinity data for the end user.

17. A method according to claim 16, wherein in the absence of expressed affinity data or calculated affinity data paired with the user account, the content data for display is paired with the respective end user account on the basis of processed affinity data comprising, in order of preference, item based collaborative filtering data, user based collaborative filtering data, or content based collaborative filtering data.

18. A method according to claim 16, wherein an expressed affinity data in the form of a social state of mind data input directs corresponding content data to the end user account.
